(19) United States
(12) Patent Application Publication
(10) Pub. No.: US 2025/0028051 A1
(43) Pub. Date: Jan. 23, 2025

(54) TIME-OF-FLIGHT SENSOR AND ELECTRONIC DEVICE

(71) Applicant: Sony Semiconductor Solutions Corporation, Atsugi-shi, Kanagawa (JP)

(72) Inventors: Michiel TIMMERMANS, Stuttgart (DE); Alper ERCAN, Stuttgart (DE); Victor BELOKONSKIY, Stuttgart (DE)

(73) Assignee: Sony Semiconductor Solutions Corporation, Atsugi-shi, Kanagawa (JP)

(21) Appl. No.: 18/714,102

(22) PCT Filed: Nov. 14, 2022
(86) PCT No.: PCT/EP2022/081835

§ 371 Date: May 29, 2024

(30) Foreign Application Priority Data
Dec. 9, 2021 (EP) 21213285.6

(51) Int. Cl. G01S 17/894; G01S 7/4863; G01S 17/36

(52) U.S. Cl. CPC G01S 17/894; G01S 7/4863; G01S 17/36

(57) ABSTRACT

An indirect Time-of-Flight sensor having a pixel array which includes a plurality of pixels, each pixel having three or more taps and a read-out circuit configured to read-out charges collected at the respective three or more taps.

### TECHNICAL FIELD

The present disclosure generally pertains to the field of Time-of-Flight imaging, and in particular to devices, sensors and methods for Time-of-Flight image capturing.

### TECHNICAL BACKGROUND

A Time-of-Flight (ToF) camera is a range imaging camera system that determines the distance of objects by measuring the time of flight of a light signal between the camera and the object for each point of the image. Generally, a ToF camera has an illumination unit (a LED or VCSEL, Vertical-Cavity Surface-Emitting Laser) that illuminates a scene with modulated light. A pixel array in the ToF camera collects the light reflected from the scene and measures phase-shift which provides information on the travelling time of the light, and hence information on distance.

Currently, acquisitions of the light signal at short distances is typically covered by indirect Time of Flight (iToF) systems and the acquisitions at mid-to-long distances is typically covered by direct Time of Flight (dToF) systems.

The pixels of a ToF camera typically comprise one or more photosensitive elements (e.g. photodiodes). A photosensitive element converts the incoming light into a current. Typically, in the field of Time-of-Flight, the pixels included in the ToF imaging sensors are for example, Current-Assisted Photonic Demodulator (CAPD) pixels, gated iToF etc. Switches (e.g. transfer gates) that are connected to the photo diode direct the current to one or more memory elements (e.g. capacitors) that act as accumulation elements that accumulate and/or store charge. All unit pixels in the ToF sensor are typically controlled by a modulation signal coming from one or more mixing drivers.

A typical ToF camera pixel develops a charge that represents a correlation between the illuminated light and the backscattered light. To enable the correlation between the illuminated light and the backscattered light, each pixel is controlled by the common modulation input coming from the one or more mixing drivers. The modulation input to the pixels is typically synchronous with an illumination block modulation.

Current iToF systems using a 2-tap sensor create a correlation with unambiguous range inversely proportional to the modulation frequency. When using a lower modulation frequency for longer distance measurement, the maximum phase shift remains the same (2π). This leads to lower depth resolution and high depth noise in the distance measurement.

Therefore, it is generally desirable to provide techniques which improve the determining of depths images with an iToF camera.

By increasing the number of taps in the sensor, greater phase shift can be measured for the given depth range, i.e. allowing high effective modulation frequency thus reducing depth noise. The maximum phase shift in an n-tap system with n>2 is (n−1)π, compared to 2π for a 2-tap system.

Though current 2-tap systems have some mismatches, actual measurement technique (with 4 measurement phases) has an intrinsic cancellation of the tap and read-out stage mismatches. Direct extension of existing pixel structure from 2 to N taps may lead to some measurement error since N-tap measurement technique does not have this cancellation. It requires to foresee some pixel features for less mismatches between taps.

### SUMMARY

According to a first aspect, the disclosure provides an indirect Time-of-Flight sensor comprising a pixel array including a plurality of pixels, each pixel having three or more taps, and a read-out circuit configured to read-out charges collected at the respective three or more taps.

According to a second aspect, the disclosure provides an electronic device comprising an indirect Time-of-Flight sensor, the indirect Time-of-Flight sensor comprising a pixel array including a plurality of pixels, each pixel having three or more taps, and a read-out circuit configured to read-out charges collected at the respective three or more taps.

Further aspects are set forth in the dependent claims, the following description, and the drawings.

### BRIEF DESCRIPTION OF THE DRAWINGS

Embodiments are explained byway of example with respect to the accompanying drawings, in which:

FIG. 1 schematically shows the basic operational principle of an indirect Time-of-Flight (iToF) imaging system which can be used for depth sensing;

FIG. 2 schematically shows an embodiment of the basic N-tap sensor included in an N-tap system;

FIG. 3 schematically shows, in a top view, an embodiment of a N-tap Current-Assisted Photonic Demodulator (CAPD)-based pixel;

FIG. 4 schematically shows an embodiment of a circuit schematics of an N-tap CAPD-based ToF pixel with more than two taps (N>2), here N=9 CAPD taps;

FIG. 5 shows a timing diagram during exposure concerning the control of mixing element GD1 to GD9 of the N-tap CAPD-based pixel;

FIG. 6 shows a timing diagram during exposure concerning the control of mixing gates GD1 to GD8 of the N-tap CAPD-based pixel and the control of GD9 performed as overflow collector OFC;

FIG. 7a schematically shows, in a top view, an embodiment of a CAPD-based pixel of a first type containing N-CAPD elements forming a CAPD-based pixel;

FIG. 7b schematically shows, in a cross-sectional view, an embodiment of the CAPD-based pixel of FIG. 7a;

FIG. 8a schematically shows, in a top view, an embodiment of a CAPD-based pixel of a second type containing N separated CAPD based unit cell elements forming a CAPD-based pixel;

FIG. 8b schematically shows, in a cross-sectional view, an embodiment of the CAPD-based pixel containing N separated CAPD based unit cell elements described with regard to FIG. 8a;

FIG. 9 schematically shows an embodiment of a CAPD-based pixel of a first or of a second type, wherein the N-tap CAPD based pixel operates as either one 16-tap pixel, or as four 4-tap pixels;

FIG. 10a shows a timing diagram during exposure concerning the control of the N-tap CAPD-based pixel of FIG. 9 operating as a 16-tap pixel;

FIG. 10b shows a timing diagram concerning the control of the N-tap CAPD-based pixel described in FIG. 9, wherein GD16 operates as overflow collector OFC;

FIG. 11a shows a timing diagram during exposure concerning the control of the N-tap CAPD-based pixel of FIG. 9 operating as a four 4-tap pixel;

FIG. 11b shows a timing diagram concerning the control of the N-tap CAPD-based pixel described in FIG. 9, wherein GD6, GD8, GD14 and GD16 are operating as overflow collector OFC;

FIG. 12 schematically shows an embodiment of a basic transfer gate (TG)-based N-tap pixel implementation layout, wherein the number of transfer gates is N=8;

FIG. 13 schematically shows an embodiment of a schematic of the TG-based N-tap pixel of FIG. 12;

FIG. 14 shows a timing diagram for the TG-based N-tap pixel 120 of FIG. 12 during integration;

FIG. 15 schematically shows in top view an embodiment of a TG-based N-tap pixel with memory nodes;

FIG. 16 schematically shows an embodiment of a schematic of the TG-based N-tap pixel with memory nodes of FIG. 15, wherein the number of transfer gates is N=8;

FIG. 17 shows a readout timing diagram of the TG-based N-tap pixel with memory nodes of FIG. 15, wherein the number of transfer gates is N=8 and the number of readout stages is R=4, with last transfer gate TG7 operating as overflow gate (OFG);

FIG. 18 shows in top view an embodiment of a cascaded TG-based N-tap pixel, wherein S=2, N₁=4, N₂=2, R=8;

FIG. 19 schematically shows an embodiment of a schematic of the cascaded TG-based N-tap pixel of FIG. 18;

FIG. 20 shows a timing diagram during integration of the cascaded TG-based N-tap pixel of FIG. 18, wherein transfer gate TG3B operates as overflow gate OFG;

FIG. 21 schematically shows in top view an embodiment of a cascaded TG-based N-tap pixel, wherein N=16, S=3, N₁=4, N₂=2, N₃=2, R=16;

FIG. 22 schematically shows an embodiment of a schematic of the cascaded TG-based N-tap pixel of FIG. 21;

FIG. 23 schematical shows in top view a cascaded TG-based NTAP pixel with memory nodes, wherein S=2, N₁=4, N₂=2, R=4;

FIG. 24 schematically shows an embodiment of a schematic of the cascaded TG-based N-tap pixel with memory nodes of FIG. 23;

FIG. 25 shows a timing diagram during integration of the cascaded TG-based N-tap pixel with memory nodes of FIG. 23, wherein transfer gate TX3B operates as overflow gate OFG;

FIG. 26 shows a readout timing diagram of the cascaded TG-based N-tap pixel with memory nodes of FIG. 23, wherein second transfer gate TX3B operating as overflow gate OFG;

FIG. 27 schematically shows in top view an embodiment of a TG-based NTAP pixel with cycling memory nodes;

FIG. 28 schematically shows an embodiment of a schematic of the cascaded TG-based N-tap pixel with cycling memory nodes of FIG. 27;

FIG. 29 shows a timing diagram for memory cycle operation of the TG-based N-tap pixel with cycling memory nodes of FIG. 27, wherein transfer gate TG7 operates as overflow gate OFG;

FIG. 30 schematically shows an embodiment of a conceptual representation for rotating charges in the TG-based N-tap pixel with cycling memory nodes of FIG. 27;

FIG. 31 schematically shows in top view an embodiment of a cascaded TG-based NTAP pixel with cycling memory nodes;

FIG. 32 schematically shows an embodiment of a schematic of the cascaded TG-based N-tap pixel with cycling memory nodes of FIG. 31;

FIG. 33 shows a timing diagram during integration of the cascaded TG-based N-tap pixel with memory nodes of FIG. 31, wherein transfer gate TX3B operates as overflow gate OFG;

FIG. 34 shows a timing timing diagram for memory cycle operation of the cascaded TG-based N-tap pixel with cycling memory nodes of FIG. 31, wherein transfer gate TX3B operates as overflow gate OFG;

FIG. 35 schematically shows in top view an embodiment of a cascaded TG-based N-tap pixel with cycling memory nodes and without central photocollecting region, wherein S=2, N₁=4, N₂=2, R=4;

FIG. 36 schematically shows an embodiment of a schematic 360 of the TG-based N-tap pixel with cycling memory nodes and without central photocollecting region of FIG. 35;

FIG. 37 shows a timing diagram during integration of the cascaded TG-based N-tap pixel with cycling memory nodes and without central photocollecting region of FIG. 35, wherein transfer gate TX3B operates as overflow gate OFG;

FIG. 38 shows a timing diagram for memory cycle operation of the cascaded TG-based N-tap pixel with cycling memory nodes and without central photocollecting region of FIG. 35, wherein transfer gate TX3B operates as overflow gate OFG;

FIG. 39 schematically shows in top view an embodiment of a cascaded TG-based N-tap pixel with cycling memory nodes and with first-stage CAPD modulators, wherein S=2, N₁=4, N₂=2, R=4;

FIG. 40 schematically shows an embodiment of a schematic 400 of the TG-based N-tap pixel with cycling memory nodes and with first-stage CAPD modulators of FIG. 39;

FIG. 41 shows a timing diagram during integration of the cascaded TG-based N-tap pixel with cycling memory nodes and with first-stage CAPD modulators of FIG. 39, wherein transfer gate TX3B operates as overflow gate OFG;

FIG. 42 shows a timing diagram for memory cycle operation of the cascaded TG-based N-tap pixel with cycling memory nodes and with first-stage CAPD modulators of FIG. 39, wherein transfer gate TX3B operates as overflow gate OFG;

FIG. 43 schematically shows in top view an embodiment of a cascaded TG-based N-tap pixel with cycling memory nodes and with first-stage CAPD modulators and second-stage photogates, wherein S=2, N₁=4, N₂=2, R=4;

FIG. 44 schematically shows an embodiment of a schematic of the TG-based N-tap pixel with cycling memory nodes and with first-stage CAPD modulators and photogates of FIG. 43;

FIG. 45 shows a timing diagram during integration of the cascaded TG-based N-tap pixel with cycling memory nodes and with first-stage CAPD modulators and photogates of FIG. 43, wherein transfer gate TX3B operates as overflow gate OFG;

FIG. 46 shows a timing diagram for memory cycle operation of the cascaded TG-based N-tap pixel with cycling memory nodes and with first-stage CAPD modulators and photogates of FIG. 43, wherein transfer gate TX3B operates as overflow gate OFG; and

FIG. 47 schematically describes an embodiment of an iToF device that can implement the processes performing depth measurement with an N-tap pixel.

### DETAILED DESCRIPTION OF EMBODIMENTS

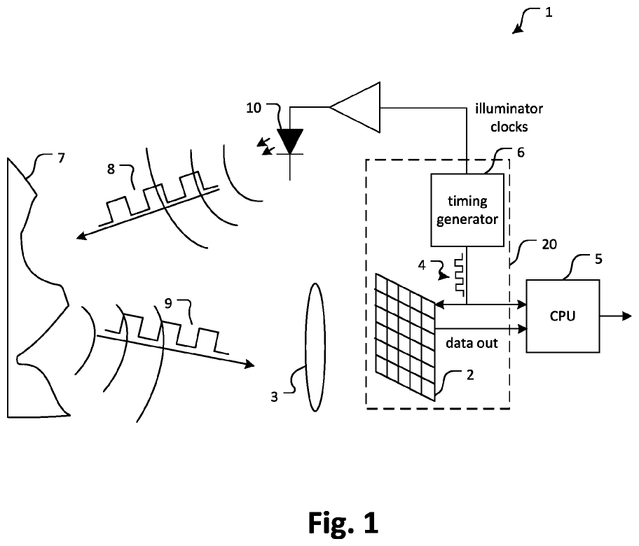

Before a detailed description of the embodiments under reference of FIG. 1 to 47, general explanations are made.

As mentioned in the outset, an indirect time-of-flight (iToF) camera has an illumination unit that illuminates a region of interest with modulated light, and a pixel array which comprises multiple pixel units that collect light reflected from the same region of interest. The pixel units are typically based on the semiconductor technology. In a semiconductor, free charge carriers, such as electron-hole pairs are created by excitation of an electron from the valence band to the conduction band. This excitation left a hole in the valence band which behaves as positive charge and an electron-hole pair is created.

It is known that current iToF systems comprise image sensors with pixels of the so called “2-tap” type, which may introduce mismatching between the taps and mismatching due to readout stage that result to depth measurements with low accuracy and low signal-to-noise ratio (SNR). While there are operating modes to overcome this, they limit possible frame rate, introduce motion artifacts and require heavy post-processing. As such, in some cases, it has been recognized that “N-tap” operation modes may be more suitable. A “2-tap” iToF sensor may not be suitable, since the current “2-tap” iToF sensors may not support N-tap operation modes. N-tap operation may refer to using a plurality of taps (e.g. seven, eight, nine or more, or less) instead of 2-taps, as it is known for iToF, such that an iToF sensor may be comparable to a dToF sensor in terms of SNR under high ambient light. However, N-tap is not limited to the iToF case since the principles of the present disclosure may also be applied to dToF sensors or dToF readout circuitry, e.g. by detecting pulsed light is detected based on modulation signals or taps. Moreover, it has been recognized that it is desirable to reduce dark current, to reduce tap mismatch, to reduce mismatch related to read-out portion, to reduce the pixel size, to reduce photocollecting region, to provide charge transfer optimization and the like.

Consequently, some embodiments pertain to an indirect Time-of-Flight sensor comprising a pixel array including a plurality of pixels, each pixel having three or more taps, and a read-out circuit configured to read-out charges collected at the respective three or more taps.

The indirect Time-of-Flight sensor, iToF, may be an imaging sensor with N-tap pixels, where N denotes the number of taps provided in a pixel of the iToF sensor. The iToF sensor may also comprise additional circuitry. For example, circuitry of the iToF sensor may include electronic components such as switching elements (gates, transistors, etc.), resistors, memory elements (capacitors, RAM, ROM or the like), pixel circuitry, a storage, and the like.

A tap may be any structure or configuration a camera sensor, respectively a pixel of a camera sensor uses to output data. For example, a tap may be a node where the photo-charges are collected. A pixel may be any single cell of an iToF sensor. When light is captured by an iToF sensor, a photo sensor (e.g. a photodiode) in each pixel produces an electrical charge. The signal corresponding to the electrical charges accumulated in the pixels of an iToF sensor are transferred by read-out electronics from the pixels to a processer for post-processing of an image.

A read-out circuit may include a vertical scanner that provides the clocks for the regular pixel operation, such as reset, select etc. for the reset and read-out phases. The read-out circuit may further include a guide driver that provides the special clocks needed for the N-tap operation. The read-out circuit may further include an analog front end and ADC for digitization and subsequent read-out. The read-out circuit may further include a control unit that ensures synchronization across the vertical scanner, the guide driver, and the analog front end and ADC, including an illumination device. The illumination device may be a laser, a vertical-cavity surface-emitting laser (VCSEL), a light-emitting diode (LED), and the like.

In some embodiments, the taps of a respective pixel may be configured to collect the charges generated by a photocollecting region. The photocollecting region may be a pinned photodiode (PPD), partially pinned photodiode, a photogate (PG), and the like.

In some embodiments, each pixel may comprise mixing elements, each mixing element corresponding to one of the taps. The mixing elements may be implemented as e.g. mixing gates.

In some embodiments, each pixel is a current assisted photonic demodulator, CAPD, based pixel. The CAPD based pixel may include N-CAPD taps, reset transistors, shutter transistors, amplifiers and select transistors. For example, the CAPD based pixel may include nine taps, without limiting the present disclosure in that regard. Alternatively, the CAPD based pixel may include more than nine taps, or less.

In some embodiments, one of the mixing elements may operate as an overflow collector having a pulse duration larger than a pulse duration of remaining mixing elements of the mixing elements, which may result to less ambient light to be collected while keeping the same amount of collected active light and thus an improved SNR. A first purpose of the overflow collector, OFC, may be to protect the collected charges from ambient light corruption outside of the integration period, e.g. during read-out and the like. A second purpose of the OFC may be to discard part of the incoming reflected light corresponding to the unwanted range (range gating).

In some embodiments, each pixel may be formed by CAPD elements. The CAPD elements may include a plurality of mixing elements that correspond to a plurality of taps.

In some embodiments, each pixel may be formed by separated CAPD elements, the separated CAPD elements being separated by isolation elements, e.g. an implant, which may result to high resolution.

A separated CAPD element may be configured to operate as either a 16-tap pixel or as four 4-tap pixels, without limiting the present disclosure in that regard. Alternatively, different, not necessarily symmetric configurations may be also possible. The separated CAPD element may be configured to operate as a single N-tap pixel, or as K (i.e. multiple) M-tap pixels, with K×M=N, or other configurations not necessarily symmetric. Such CAPD based pixels may be easily adapted.

In some embodiments, the photocollecting region may be a central photocollecting region.

In some embodiments, each pixel may comprise transfer gates, each transfer gate corresponding to a respective tap.

In some embodiments, each pixel may be a transfer gate (TG)-based pixel.

In some embodiments, each pixel may be a cascaded TG-based pixel.

In some embodiments, the read-out circuit may be configured to open (high conductance state) the transfer gates of the respective taps of the pixel one after the other for a predetermine period to obtain depth measurements.

In some embodiments, one of the transfer gates may operate as an overflow gate having a pulse duration larger than a pulse duration of remaining transfer gates of the transfer gates to drain the ambient light.

In some embodiments, each of the transfer gates of the TG-based pixel may connect the central photocollecting region to a respective floating diffusion (FD) region.

In some embodiments, the TG-based pixel may further comprise a memory node for intermediate charge storage. The TG-based pixel may comprise a plurality of a memory nodes for intermediate charge storage. By performing intermediate charge storage of the charges, dark current (DC) may be reduced, since a memory node typically generates less DC than FD, generated noise may be reduced, some read-out stages may be shared, such that relaxing the routing requirements is performed, and the ADC count and the pixel area may be reduced. Therefore, intermediate storage may save space on read-out stages, output line routing, and the like.

The TG-based pixel may further comprise a floating diffusion region, multiple memory nodes connected with, and respective multiple second transfer gates, the multiple memory nodes being connected through the multiple second transfer gates to the floating diffusion region. The TG-based pixel may comprise at least one floating diffusion region. The multiple memory nodes may be two or more multiple memory nodes and the respective multiple second transfer gates may be two or more second transfer gates.

In some embodiments, the transfer gates are first transfer gates and the TG-based pixel further comprises a floating diffusion region, two or more memory nodes, and two or more respective second transfer gates, the two or more memory nodes being connected through the two or more second transfer gates to the floating diffusion region. For example, the TG-based pixel may comprise at least one floating diffusion region, two or more respective memory nodes, and two or more respective second transfer gates, wherein each floating diffusion region may be connected through the two respective second transfer gates to the two respective memory nodes. In an exemplifying configuration, the TG-based pixel may comprise four floating diffusion regions, wherein each floating diffusion region may be connected through two respective second transfer gates to two respective memory nodes.

In some embodiments, the TG-based pixel may further comprise a memory shift gate configured to transfer the charges from one memory node of the memory nodes to another memory node of the memory nodes, the two memory nodes being adjacent to each other. Such a transfer of charges from one memory node to the next one serves as a cycling memory function which may result to a reduced mismatch between taps by making part of each signal's exposure on each tap, and to a reduced read-out area since only one read-out structure/FD is required, depending on implementation. In addition, read-out related tap mismatch may be reduced by utilizing only one read-out structure, depending on implementation, trade-off between mismatch and speed (fps) may be improved.

It should be noted that other implementations for realizing the memory cycling are also possible, such as CCD-like MEM (1.5 phase/2phase/ . . . ), and the like. For example, CCD-like MEM structures may allow to utilize all taps as signal integrators, but due to larger area requirements for CCD-memory compared to MS gate, the saturation charge (QSAT) of each tap may decrease i.e. less space available for each MEM node.

In some embodiments, the memory shift gate may be located between the two memory nodes to perform cycling memory function.

In some embodiments, the cascaded TG-based pixel may further comprise a common gate representing a first modulation stage. In such a cascaded TG-based pixel the demodulation of the incoming light to N taps may be split into multiple steps or modulation stages, such as into a first modulation stage, a second modulation stage, a third modulation stage, and the like. By implementing multiple stages, the number of taps/modulators connecting directly to the central collecting region may be reduced. Hence, smaller area may be required for central collecting region, resulting in faster charge transfer from the central collecting region to the mixing elements.

In some embodiments, the common gate may connect the central photocollecting region to a respective floating diffusion region through a respective transfer gate, the respective transfer gate representing a second modulation stage. This may result to small collector region and thus to higher modulation electric fields (E-fields) for the same applied potentials e.g. higher modulation frequency FMOD, better demodulation contrast CMOD, and the built-in E-fields may be better directed, depending on configuration, resulting in further FMOD/CMOD improvement. For example, a case where modulation electric fields are reduced due to the larger distance from far-ends of the modulation area/charge collection area, may be addressed by reducing the number of modulators connecting directly to the first modulation area/charge collection region and by implementing multiple modulation stages, as described herein.

In some embodiments, the cascaded TG-based pixel may further comprise a first common gate representing a first modulation stage.

In some embodiments, the cascaded TG-based pixel may further comprise a second common gate representing a second modulation stage, the second common gate connecting the first common gate to multiple respective transfer gates. For example, the second common gate may connect the first common gate to two respective transfer gates, without limiting the present disclosure in that regard. Alternatively, the second common gate may connect the first common gate to more than two respective transfer gates.

In some embodiments, the cascaded TG-based pixel may further comprise a memory node for intermediate charge storage.

The TG-based pixel may further comprise a floating diffusion region, multiple memory nodes, and multiple respective second transfer gates, the multiple memory nodes being connected through the respective multiple second transfer gates to the floating diffusion region. The TG-based pixel may comprise at least one floating diffusion region. The multiple memory nodes may be two or more multiple memory nodes and the respective multiple second transfer gates may be two or more second transfer gates.

In some embodiments, the transfer gates may be first transfer gates and the TG-based pixel may further comprise a floating diffusion region, two or more memory nodes, and two or more respective second transfer gates, the two or more memory nodes being connected through the two or more second transfer gates to the floating diffusion region, without limiting the present disclosure in that regard. For example, the TG-based pixel may comprise one or more floating diffusion regions, two or more memory nodes, and two or more respective second transfer gates, wherein each floating diffusion region may be connected through two or more respective second transfer gates to two or more respective memory nodes. The memory nodes may operate as memory nodes which may result to dark current reduction, to noise reduction, to relaxing the routing requirements, ADC count, pixel area due to shared read-out stages.

In some embodiments, the cascaded TG-based pixel may further comprise a memory shift gate configured to transfer the charges from one memory node of the two memory nodes to another memory node of the two memory nodes, the two memory nodes being adjacent to each other. The memory nodes may operate as cycling memory nodes which may result to reduced mismatch between taps by making part of each signal's exposure on each tap, reduced read-out area since one read-out structure/FD is required, depending on implementation, reduced read-out related tap mismatch by utilizing only one read-out structure, depending on implementation, and improved trade-off between mismatch and speed (fps), that is, low-mismatch and flexible read-out

It should be noted that other implementations for realizing the memory cycling are also possible, such as CCD-like MEM (1.5 phase/2phase/ . . . ), and the like. For example, CCD-like MEM structures may allow to utilize all taps as signal integrators, but due to larger area requirements for CCD-memory compared to MS gate, the QSAT of each tap may decrease i.e. less space available for each MEM node.

In some embodiments, the photocollecting region may be an intermediate collecting region including a plurality of central photocollecting regions, each of the central photocollecting regions being connected to a respective CAPD modulator. That is, the first modulation stage is implemented as CAPD by including the CAPD modulator to the photocollecting region, and this may result to low FPN for the first modulation stage, re-configurability, depending on configuration, e.g. no cycling, and thus complex subsequent gate transfer may be avoided.

In some embodiments, each pixel is a cascaded TG-based pixel which may comprise common gates (CG0-3) configured to generate charges and direct the charges directly to first transfer gates (TG0A-3B).

In some embodiments, each pixel may be a cascaded TG-based pixel (350) without a central photocollecting region. By excluding the central photocollector region and direct the charges directly to first modulation step via auxiliary electrodes, such as the common gates, reduced pixel area may be achieved, charge transfer optimization may be performed, since all parts are now controlled by electronically applied potential and faster modulation may be performed due to reduced total electron path length and due to elimination of the central area with difficult to control electrical fields.

In some embodiments, each pixel may be a cascaded TG-based pixel comprising a CAPD modulator and two respective photogates representing a first modulation stage. The CAPD modulator may not require central collector to operate and the photogates may function as photodiodes and transfer gates together. This may result to speed up the second modulation stage, allowing for higher fmod/cmod.

Such a ToF sensor may obtain more accurate depth information, due to charge transfer speed improvements, to reduced mismatch between taps, to reduced noise, improved SNR and high-speed read-out, as described herein.

The embodiments also disclose an electronic device comprising an indirect Time-of-Flight sensor in accordance with claim 1. The electronic device may for example be an imaging sensor of an imaging camera, in particular a sensor of a ToF camera. For example, the electronic device may be an imaging sensor with N-tap pixels, where N denotes the number of taps provided in a pixel of the imaging sensor. The electronic device may also comprise additional circuitry. For example, circuitry of the electronic device may include electronic components such as switching elements (gates, transistors, etc.), resistors, memory elements (capacitors, RAM, ROM or the like), pixel circuitry, a storage, input means (mouse, keyboard, camera, etc.), output means (display (e.g. liquid crystal, (organic) light emitting diode, etc.), loudspeakers, etc., a (wireless) interface, etc., as it is generally known for electronic devices (computers, smartphones, etc.). Moreover, it may include sensors for sensing still image or video image data (image sensor, camera sensor, video sensor, etc.), for sensing a fingerprint, for sensing environmental parameters (e.g. radar, humidity, light, temperature), etc.

Operational Principle of an Indirect Time-of-Flight Imaging System (iToF)

FIG. 1 schematically shows the basic operational principle of an indirect Time-of-Flight (iToF) imaging system which can be used for depth sensing. The iToF imaging system 1 includes an iToF camera with an imaging sensor 2 having a matrix of pixels and a processor (CPU) 5. A scene 7 is actively illuminated with amplitude-modulated infrared light 8 at a predetermined wavelength using an illumination device 10, for instance with some light pulses of at least one predetermined modulation frequency 4 generated by a timing generator 6. The amplitude-modulated infrared light 8 is reflected from objects within the scene 7. A lens 3 collects the reflected light 9 and forms an image of the objects within the scene 7 onto the imaging sensor 2. In indirect Time-of-Flight (iToF) the CPU 5 determines for each pixel a phase delay between the modulated signal 8 and the reflected light 9.

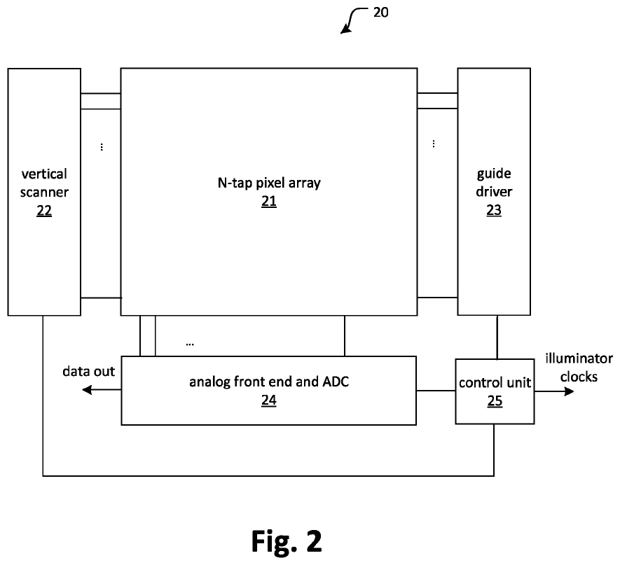

In the embodiment of FIG. 1, the timing generator 6 and the imaging sensor 2 of the iToF system 1 are drawn separately, however, in a case of an N-tap system, these two functions are implemented on the same block (dashed lined rectangle) forming an N-tap three-dimension (3D) sensor, such as the N-tap sensor 20 of FIG. 2 below.

### N-Tap Sensor

FIG. 2 schematically shows an embodiment of the basic N-tap sensor included in an N-tap system.

The N-tap system comprises an N-tap sensor 20 having an N-tap pixel array 21 and its main connections, namely a vertical scanner 22, a guide driver 23, an analog front end and ADC 24 and a control unit 25. The vertical scanner 22 provides the clocks for the regular pixel operation, such as reset, select etc. for the reset and read-out phases. The guide driver 23 provides the special clocks needed for the N-tap operation. Pixel outputs are connected to the analog front end and ADC 24 for digitization and subsequent read-out. The control unit 25 ensures synchronization across the vertical scanner 22, the guide driver 23, and the analog front end and ADC 24, including the illumination device (see 10 in FIG. 1).

In the embodiment of FIG. 2, the N-tap system is similar to regular iToF system (see 1 in FIG. 1), however, utilizes different pixel array, control units and timing diagrams. The emitter, such as the illumination device 10 of FIG. 1, may be laser, vertical-cavity surface-emitting laser (VCSEL), light-emitting diode (LED), etc. The vertical scanner 22 and the guide driver 23 are drawn separately, however, it is possible to combine these two functions on the same block. The N-tap sensor 20 is an N-tap three-dimension (3D) sensor and implements the functions of the timing generator 6 and the imaging sensor 2 of the iToF system 1 of FIG. 1.

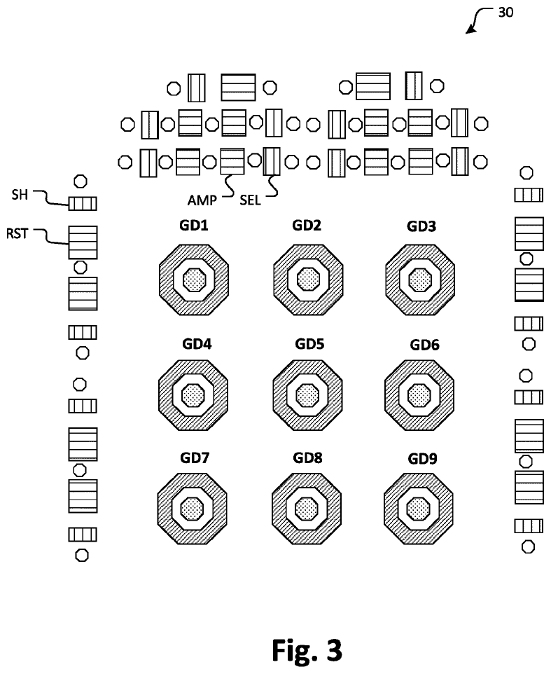

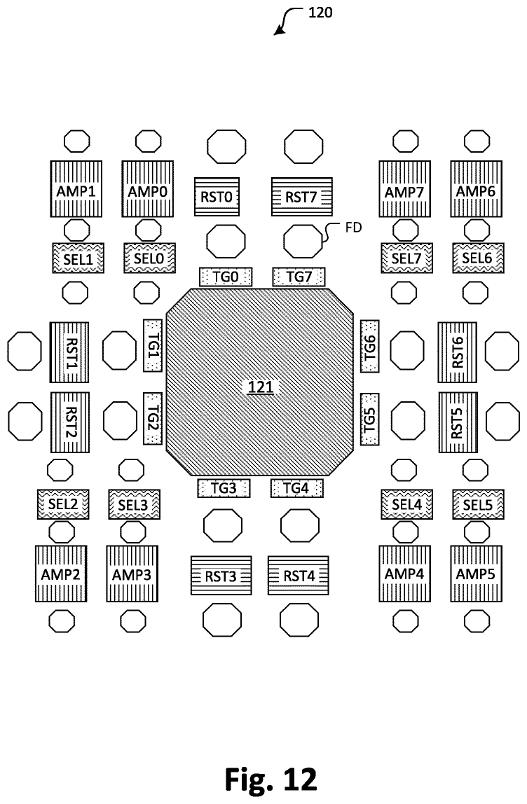

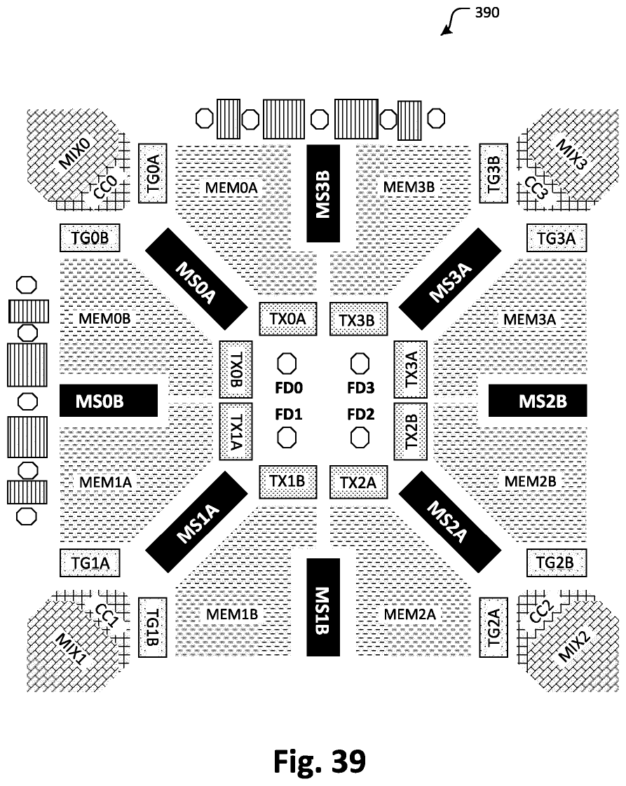

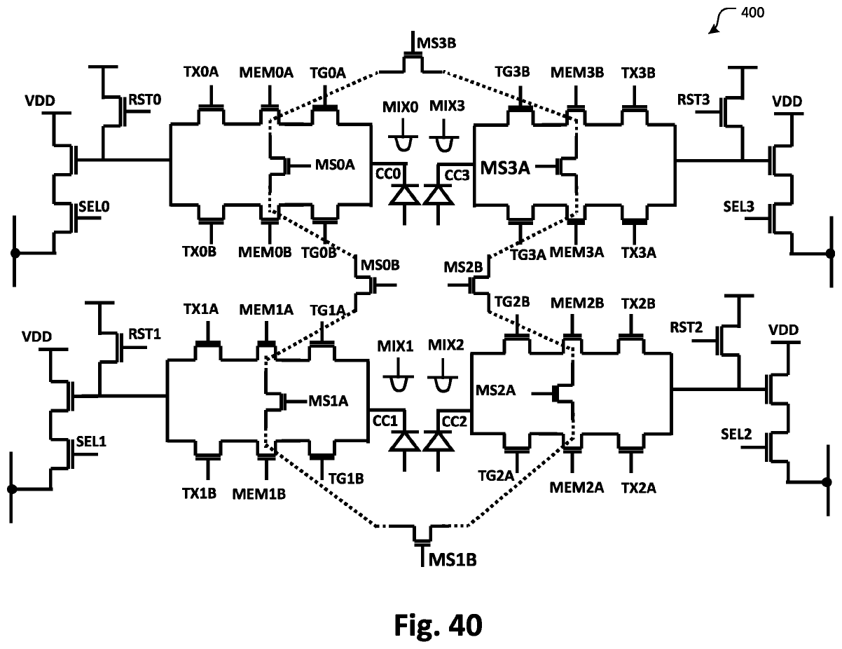

In the embodiment of FIG. 2, the N-tap system 20 comprises an N-tap sensor, which for example has the N-tap pixel array 21 implemented as a CAPD-modulator based N-tap pixel array as shown in FIGS. 3 to 11b below, as a Gate-modulator based N-tap pixel array as shown in FIGS. 12 to 38 below, or as a Cascaded CAPD-gated pixel array as shown in FIGS. 39 to 46 below. The N-tap pixel array 21 of the N-tap system 20 comprises a plurality of N-tap pixels. LSR signal is used to represent illuminator optical output signal.

### CAPD-Based Pixel

FIG. 3 schematically shows, in a top view, an embodiment of an N-tap Current-Assisted Photonic Demodulator (CAPD)-based pixel.

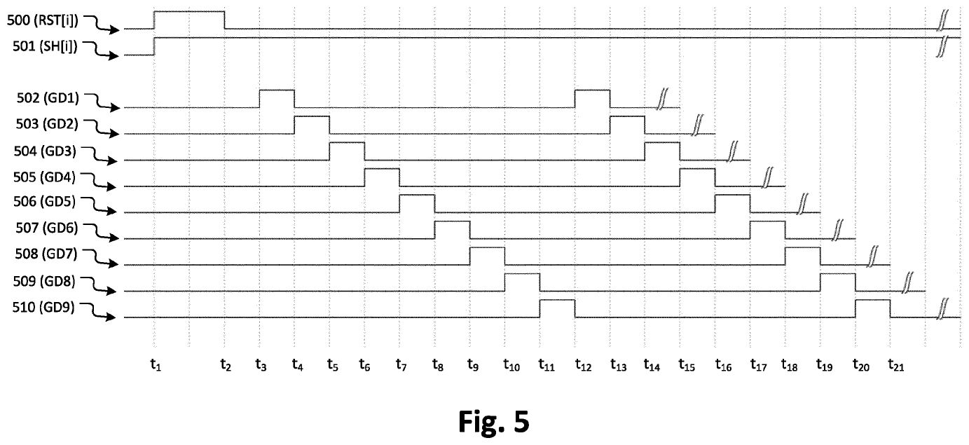

The N-tap pixel 30 comprises a plurality of CAPD taps, namely N=9 CAPD taps, a plurality of reset transistors RST, a plurality of amplifiers AMP, a plurality of select transistors SEL and a plurality of shutters SH. Each one of the 9 CAPD taps GD1 to GD9 are formed by a p+ region represented by a dotted octagonal and an n+ region represented by a diagonally filling pattern octagonal, as shown in GD1 of FIG. 3. The plurality of transistors is represented by rectangles having vertical and horizontal stripes pattern, while the nodes between the plurality of transistors are represented by white octagonals. During exposure, each CAPD tap GD1 to GD9 is clocked sequentially as shown on FIG. 5. After exposure, the shutter transistors SH connected to a respective CAPD tap, are closed (low conductive state). The storage nodes connected to the shutter transistors SH are read-out line-by-line by toggling the corresponding select transistor SEL clocks and the relevant analog stages, wherein the readout timing is same as regular iToF sensors, thereby not shown in FIG. 5.

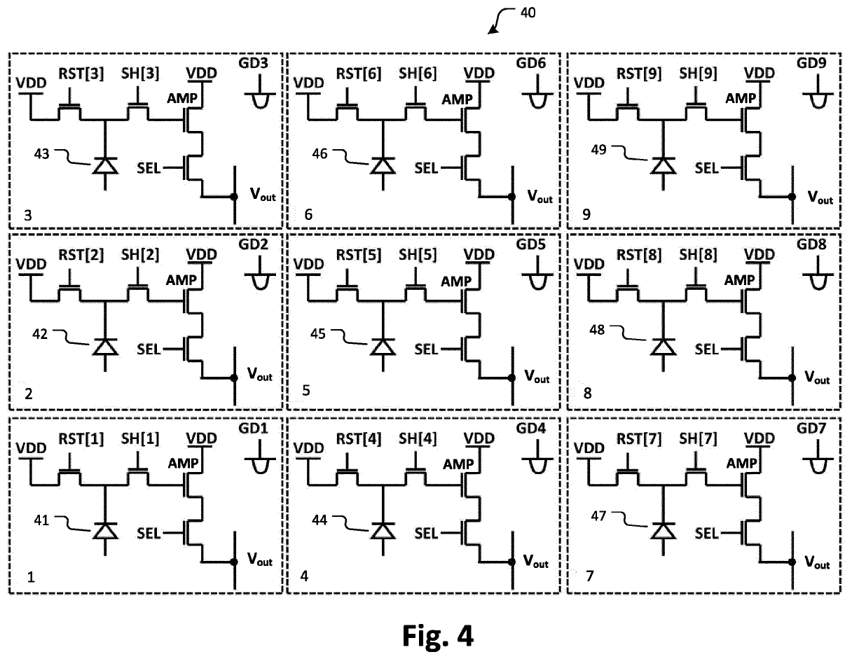

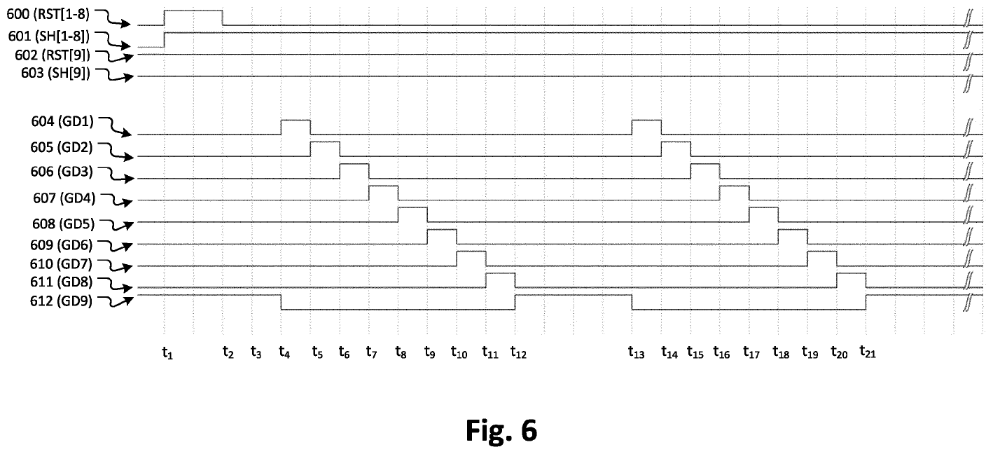

In the embodiment of FIG. 3, the N-tap pixel 30 has size of approximately 15 μm×15 μm, with N=9, without limiting the present embodiment in the regard. Alternatively, other pixel sizes, geometries and N implementations are possible. Each CAPD tap GD1 to GD9 of FIG. 3 is connected to a respective reset transistor RST, a respective amplifier AMP, a respective select transistor SEL and a respective shutter SH, as shown in FIG. 4 below. In the embodiment of FIG. 3, the GD1 to GD9 are used as CAPD mixing elements (e.g. mixing gates), each mixing element GD1 to GD9 being related to a respective tap of the pixel. Alternatively, one of the CAPD mixing element GD1 to GD9 may be used as overflow collector OFC using a different timing. Such a timing example is shown on FIG. 6, wherein GD9 is operating as overflow collector OFC. In the embodiment of FIG. 3, the mixing elements are implemented as mixing gates.

FIG. 4 schematically shows an embodiment of a circuit schematics of an N-tap CAPD-based ToF pixel with more than two taps (N>2), here N=9 CAPD taps. The circuit schematics 40 of the 9-tap CAPD-based ToF pixel comprises a plurality of photodiodes, namely nine photodiodes 41 to 49, which collect incident photons and generate a photocurrent. Each one of the plurality of photodiodes is connected to a respective mixing gate GD1 to GD9, each mixing gate GD1 to GD9 being related to a respective tap of the pixel. Each of the nine photodiodes 41 to 49 includes a capacitor and each photodiode 41 to 49 is connected to a respective reset transistors RST[1] to RST[9] and a respective shutter SH[1] to SH[9], where the shutter is used as a switch to allow or not the charge produced by the respective photodiode to be stored. The collected charge is transferred to the source follower consisting of the amplifier AMP and select transistor SEL to read out the amplified signal on a read-out line Vₒᵤₜ. The mixing gates GD1 to GD9 are controlled according to the timing diagram as shown in FIG. 5. A respective reset transistor RST[1] to RST[9] is provided to reset the pixel.

In the embodiment of FIG. 4, the GD1 to GD9 are used as CAPD mixing elements, without limiting the present embodiment in that regard. Alternatively, in case where one of the CAPD mixing elements GD1 to GD9, for example GD9, is used as overflow collector OFC for collecting all unwanted charges. The photodiode 49 is connected to the overflow collector OFC, wherein the CAPD mixing gates GD1 to GD8 and the overflow collector OFC, here GD9, are controlled according to the timing diagram as shown in FIG. 6.

It should be noted that despite the embodiment of FIG. 4 shows a 9-tap (N=9) CAPD-based ToF pixel, in alternative embodiments, other numbers of taps may be foreseen in an N-tap pixel. For example, there may be CAPD-based pixels with N=3, 4, 5, 6, 7, 8, 10, 11, 12 or more taps.

FIG. 5 shows a timing diagram during exposure concerning the control of mixing element GD1 to GD9 of the N-tap CAPD-based pixel described in FIG. 3. A laser pulse for illuminating a scene is activated for a predefined illumination period. As shown the signal 500 of RST[i], where i=1 . . . 9, is activated for a predefined period Δt, here Δt=t₂−t₁. The signal 501 of SH[i], where i=1 . . . 9, is activated at the same activation time t₁ with the RST[i] signal 500 and remains active until deactivation is needed. By activating the SH[i] signal 501 the charge produced by the respective photodiode 41 to 49 can be stored. CAPD-based mixing elements GD1 to GD9 of the 9-tap CAPD-based pixel are controlled by respective control signals, also called “demodulation signals” or “mix signals”. According to this specific timing diagram of FIG. 5, each of mixing element GD1 to GD9 of the pixel is activated one after the other for a predetermined activation period Δt′. The control signals 502 to 510 are applied to the mixing gates GD1 to GD9 respectively to activate the respective mixing element GD1 to GD9 for a predetermined activation period Δt′, as described above. At time t₁₂ at which the activation period Δt′ of mixing gate GD9 ends, the activation period Δt′ of mixing gate GD1 starts again, and the above described process is performed again.

The LSR signal shows an example of the optical output from the illumination device (see 10 in FIG. 1). The pulse widths, amplitudes, phases, frequencies, wave-shapes which are shown in the embodiment of FIG. 5 are not limiting. Alternatively, different pulse widths, amplitudes, phases, frequencies, wave-shapes may be used.

It should be noted that for the timing diagram of FIG. 5 and all following timing diagrams, they show relative location only of the pulses.

FIG. 6 shows a timing diagram concerning the control of mixing element GD1 to GD8 of the N-tap CAPD-based pixel described in FIG. 3 and the control of GD9 as overflow collector OFC. As shown the signal 600 of the RST[1 to 8] is activated for a predefined period Δt, here Δt=t₂−t₁. The signal 601 of the SH[1 to 8] is activated at the same activation time t₁ with the signal 600 and remains active until deactivation is needed. The signal 602 of the RST[9] and the signal 603 of the SH[9] are constantly active. As shown the control signal 604 of GD1 is activated at time t₄ for a predefined period Δt′, here Δt′=t₅−t₄. The control signals 604 to 611 are applied to the mixing gates GD1 to GD8 respectively to activate the respective mixing gate GD1 to GD8 for a predetermined activation period Δt′, as described above. At time t₄ at which the activation period of GD1 starts, control signal 612 of GD9 being used as overflow collector OFC is deactivated until time t₁₂ at which control signal 612 of GD9 is activated again, wherein time t₁₂ is the time at which the activation period of GD8 ends. As shown in the embodiment of FIG. 6, control signal 612 remains active for a predefined period Δt″. At time t₁₃ at which the activation period Δt″ of GD9 ends, the activation period Δt′ of mixing element GD1 starts again, and the above described process is performed again. The described process also called “sub-integration cycle” is repeated multiple times to achieve measurements over a predefined integration cycle.

In the embodiment of FIG. 6, the OFC pulse duration, namely the activation period of control signal 612 is larger than that of other GD's, thereby the LSR pulses are further apart in time, which may allow for higher optical peak power while maintaining eye-safe operation. Due to the higher peak power, less integration time may be required on the CAPD-based taps GD1-8 to reach same signal level, thereby, less ambient light may be collected, and thus, Signal-to-Noise Ratio (SNR) may be improved.

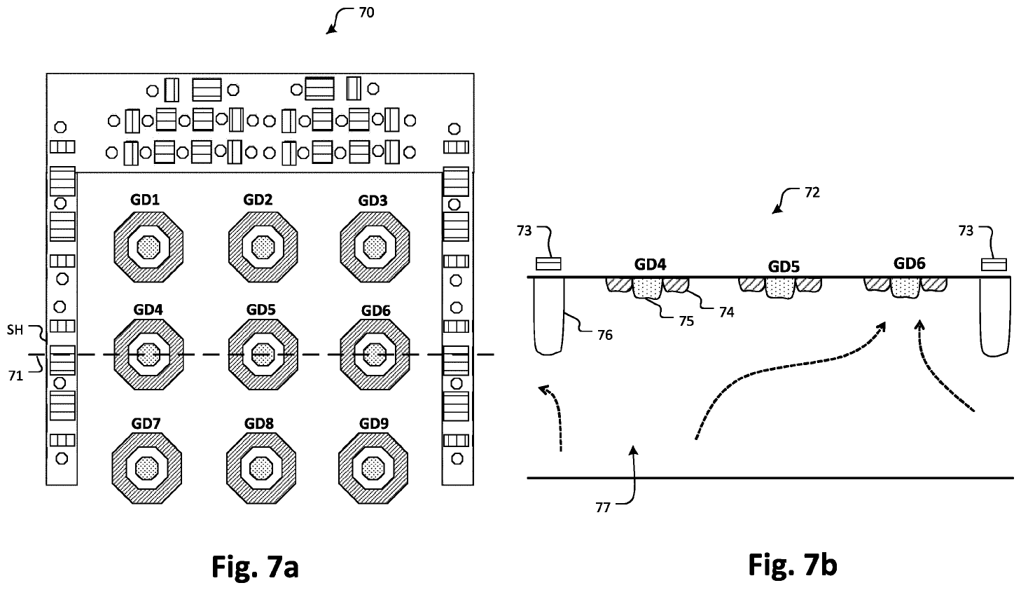

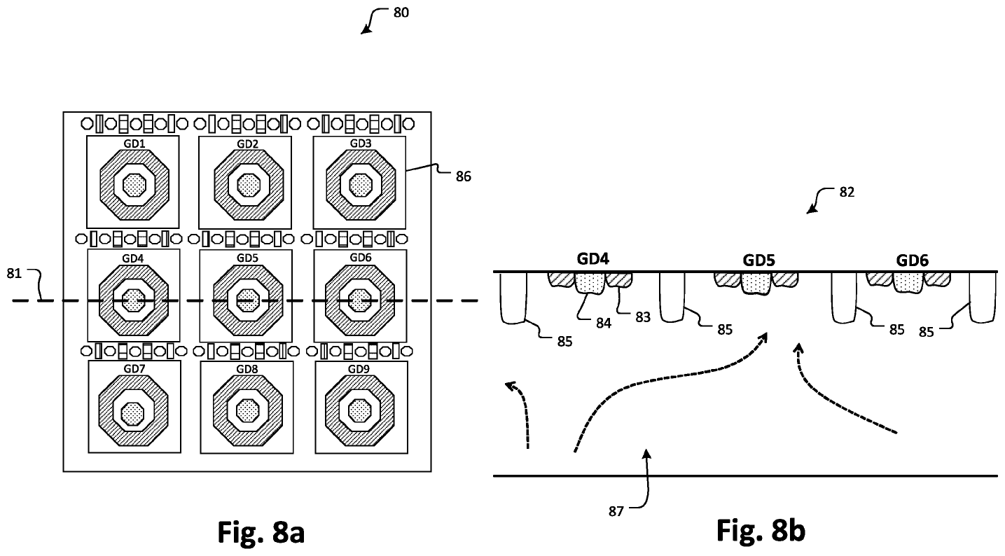

Two different types of CAPD-based pixel 30 described in FIG. 3 are shown in FIGS. 7a to 8b. For example, a first type contains N-CAPD elements forming the pixel, as shown in FIGS. 7a and 7b and the second type contains N separate CAPD based unit cells elements forming the pixel, as shown in FIGS. 8a and 8b.

FIG. 7a schematically shows, in a top view, an embodiment of a CAPD-based pixel of a first type containing N-CAPD elements forming a CAPD-based pixel 70. The N-tap pixel 70 comprises a photocollecting region 77, a plurality of CAPD elements, namely N=9 nine CAPD elements, a plurality of reset transistors RST, a plurality of amplifiers AMP, a plurality of select transistors SEL 1s and a plurality of shutters SH. The plurality of transistors RST, AMP, SEL and SH are located around the CAPD elements GD1 to GD9 and they are located on an isolation region that isolates the CAPD elements GD1 to GD9. Each CAPD element is related to a respective tap of the CAPD-based pixel 70 and is formed by a p+ region represented by a dotted octagonal and an n+ region represented by a diagonally filling pattern octagonal, as shown in GD1 of FIG. 7a. The plurality of transistors is represented by rectangles having vertical and horizontal stripes pattern, while the nodes between the plurality of transistors are represented by white octagonals. In the top view of the CAPD-based pixel 70, a horizontal dashed line 71 is depicted, which indicates a cut line that starts from one side of the pixel, where CAPD tap GD4 is located and ends on the opposite side of the pixel, where CAPD tap GD6 is located, and that cuts the pixel and the CAPD taps GD4 to GD6 in the middle. The cross-sectional view of the CAPD-based pixel 70 is described with regard to FIG. 7b.

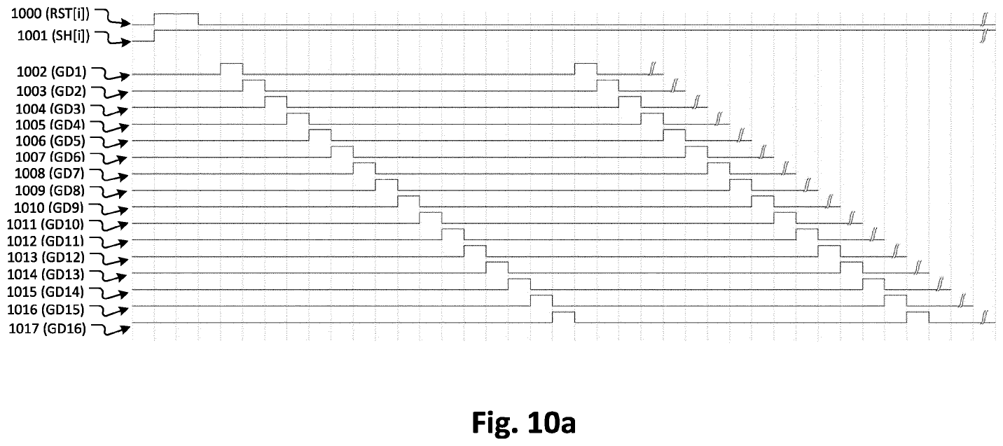

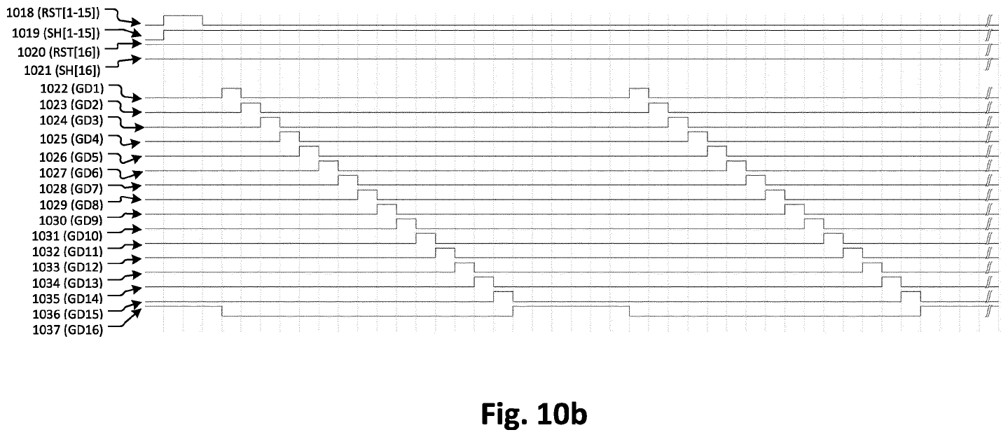

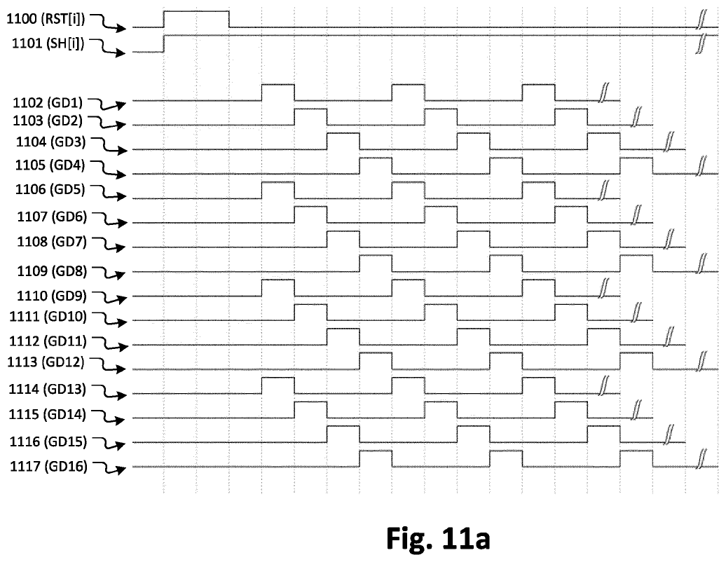

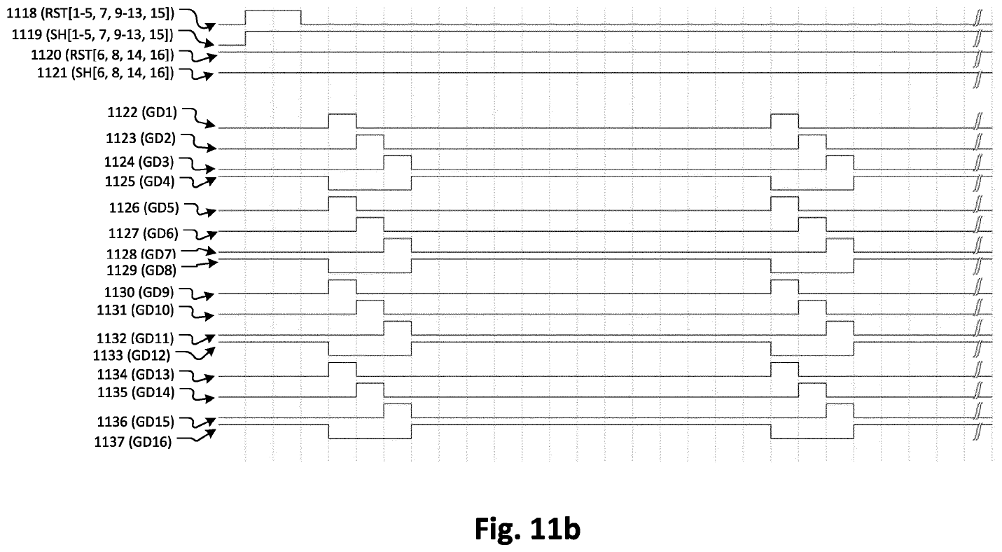

In the embodiment of FIG. 7a, the CAPD-based pixel 70 has size of approximately 15 μm×15 μm, with N=9, without limiting the present embodiment in the regard. Alternatively, other pixel sizes, geometries and N implementations are possible. In the embodiment of FIG. 7a, the GD1 to GD9 are used as CAPD mixing gates, each mixing gate GD1 to GD9 being related to a respective tap of the pixel. Alternatively, one of the CAPD mixing gates GD1 to GD9 may operate as overflow collector OFC by adjusting timing for one GD in each of the pixels, as shown in FIGS. 10b and 11b. The CAPD-based pixel 70 of FIG. 7a may achieve improved bandwidth devices but may require more complex layout.

FIG. 7b schematically shows, in a cross-sectional view, an embodiment of the CAPD-based pixel 70 described with regard to FIG. 7a. In the cross-sectional view 72 of the CAPD-based pixel 70 of FIG. 7a, the CAPD-based pixel 70 of first type has n+ regions 74 and p+ regions 75 inside a low doped substrate, two transistors 73 and two isolation implants 76. The n+ regions 74 (diagonally filling pattern) and the p+ regions 75 (dotted pattern) are located on the same side of the CAPD-based pixel 70, e.g. on the top of the pixel. The n+ region 74 and the p+ regions 75 form a mixing element, here mixing elements taps GD4 to GD6, wherein each mixing gate GD4 to GD6 is related to a respective tap of the CAPD-based pixel 70. The two transistors 73 are the shutters SH located on the isolation region formed around the CAPD mixing gates GD1 to GD9, and the two isolation implants 76 are part of the isolation region formed around the CAPD mixing elements GD1 to GD9. The isolation region formed around the CAPD mixing elements GD1 to GD9 may be adapted to fully isolate each pixel from its neighbours both optically and electrically. This can be realized by deep P-wells, trenched regions, and the like.

Typically, an electrical field is setup to move the electrons to collector taps, which consist of reverse biased diodes. Modulation is achieved by alternately changing the direction of the voltage applied between the mix taps. Due to this modulating field applied within the substrate, electrons that are generated deep in the substrate can be collected on the desired tap. The voltage used for demodulation controls the electric field intensity and thus the drift velocity of the generated electrons.

FIG. 8a schematically shows, in a top view, an embodiment of a CAPD-based pixel of a second type containing N separated CAPD based unit cell elements forming a CAPD-based pixel 80. The N-tap pixel 80 comprises a plurality of CAPD unit cell elements 86, namely N=9 nine CAPD unit cell elements 86, a plurality of reset transistors RST, a plurality of amplifiers AMP, a plurality of select transistors SEL and a plurality of shutters SH. The plurality of transistors RST, AMP, SEL and SH are located on one side of each separated CAPD unit cell element GD1 to GD9. The plurality of transistors RST, AMP, SEL and SH are located on the p-well implants forming a simple pixel transistor layout. Each separated CAPD unit cell element GD1 to GD9 is related to a respective tap of the CAPD-based pixel 80 and is formed by a p+ region represented by a dotted octagonal and an n+ region represented by a diagonally filling pattern octagonal, as shown in GD1 of FIG. 7a. The plurality of transistors is represented by rectangles having vertical and horizontal stripes pattern, while the nodes between the plurality of transistors are represented by white octagonals. In the top view of the CAPD-based pixel 80, a horizontal dashed line 81 is depicted, which indicates a cut line that starts from one side of the pixel, where CAPD unit cell element GD4 is located and ends on the opposite side of the pixel, where CAPD unit cell element GD6 is located, and that cuts the pixel and the CAPD unit cell elements GD4 to GD6 in the middle. The cross-sectional view of the CAPD-based pixel 80 is described with regard to FIG. 8b.

In the embodiment of FIG. 8a, the CAPD-based pixel 80 of a second type containing N separated CAPD based unit cell elements has size of approximately 15 μm×15 μm, with N=9, without limiting the present embodiment in the regard. Alternatively, other pixel sizes, geometries and N implementations are possible. In the embodiment of FIG. 8a, the GD1 to GD9 are used as CAPD mixing elements, each mixing element GD1 to GD9 being related to a respective tap of the pixel. Alternatively, one of the CAPD mixing element GD1 to GD9 may operate as overflow collector OFC by adjusting timing for one GD in each of the pixels, as shown in FIGS. 10b and 11b.

FIG. 8b schematically shows, in a cross-sectional view, an embodiment of the CAPD-based pixel 80 containing N separated CAPD based unit cell elements described with regard to FIG. 8a. In the cross-sectional view 82 of the CAPD-based pixel 80 of FIG. 8a, the CAPD-based pixel 80 of second type has n+ regions 83 and p+ regions 84 inside a low doped substrate, namely a photocollecting region 87, and p-well implants 85 formed between the N separated CAPD based unit cell elements, GD4 to GD6. The n+ regions 83 (diagonally filling pattern) and the p+ regions 84 (dotted pattern) are located on the same side of the CAPD-based pixel 80, e.g. on the top of the pixel. The n+ region 83 and the p+ regions 84 form a mixing element, here mixing elements taps GD4 to GD6, wherein each mixing element GD4 to GD6 is related to a respective tap of the CAPD-based pixel 80.

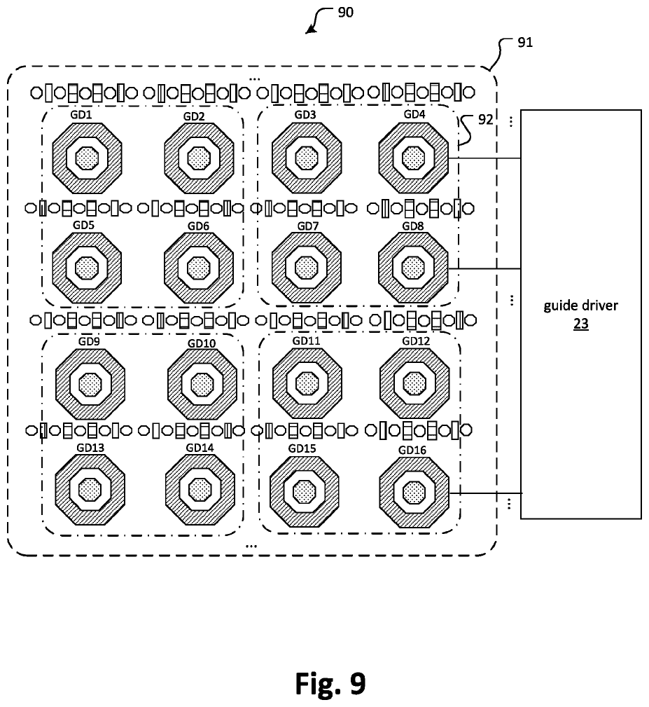

FIG. 9 schematically shows an embodiment of a CAPD-based pixel of a first or of a second type, wherein the N-tap CAPD based pixel 90 operates as either one 16-tap pixel, or as four 4-tap pixels. The N-tap CAPD-based pixel 90 is a CAPD-based pixel having N=16 mixing elements and thus, 16 taps. In the embodiment of FIG. 9, the N-tap CAPD based pixel 90 has the configuration of the CAPD-based pixel 80 containing N separated CAPD based unit cell elements described with regard to FIG. 8a. Each of the N separated CAPD elements operates as either one 16-tap pixel, or as four 4-tap pixels depending on the configuration of the guide driver 23. The N-tap CAPD based pixel 90 operated as a 16-tap CAPD-based pixel is represented by a dashed line 91 and the N-tap CAPD based pixel 90 operated as four 4-tap (4×4) CAPD-based pixels is represented by a dash-dotted line 92. The guide driver 23 provides the special clocks needed for the N-tap operation and based on the configuration of these clocks the N-tap CAPD based pixel 90 operated as a 16-tap CAPD-based pixel or as a 4×4-tap CAPD-based pixel. Configurations with different N are also possible.

In the embodiment of FIG. 9, the N-tap CAPD based pixel 90 operates as either one 16-tap pixel, or as four 4-tap pixels, without limiting the present embodiment in that regard. Alternatively, different, not necessarily symmetric configurations may be also possible. The separated CAPD element may be configured to operate as a single N-tap pixel, or as K (i.e. multiple) M-tap pixels, with K×M=N, or other configurations not necessarily symmetric. Such CAPD based pixels may be easily adapted. Based on the configuration of the guide driver 23 higher resolution but smaller N formats can be supported.

FIG. 10a shows a timing diagram during exposure concerning the control of the N-tap CAPD-based pixel of FIG. 9 operating as a 16-tap pixel. The N-tap CAPD-based pixel 90 is a CAPD-based pixel having N=16 mixing element and thus, 16 taps. A laser pulse for illuminating a scene is activated for a predefined illumination period. As shown the signal 1000 of RST[i], where i=1 . . . 16, is activated for a predefined period Δt. The signal 1001 of SH[i], where i=1 . . . 16, is activated at the same activation time with the RST[i] signal 1000 and remains active until deactivation is needed. According to this specific timing diagram of FIG. 10a, each of mixing elements GD1 to GD16 of the pixel is activated one after the other for a predetermined activation period Δt′. The control signals 1002 to 1017 are applied to the mixing elements GD1 to GD16 respectively to activate the respective mixing element GD1 to GD16 for a predetermined activation period Δt′, as described above. At the time at which the activation period Δt′ of mixing element GD16 ends, the activation period Δt′ of mixing element GD1 starts again, and the above described process is performed once more. The described process also called “sub-integration cycle” is repeated multiple times to achieve measurements over a predefined integration cycle. The pulse widths, amplitudes, phases, frequencies, wave-shapes which are shown in the embodiment of FIG. 10a are not limiting. Alternatively, different pulse widths, amplitudes, phases, frequencies, wave-shapes may be used.

FIG. 10b shows a timing diagram concerning the control of the N-tap CAPD-based pixel described in FIG. 9, wherein GD16 operates as overflow collector OFC. As shown the signal 1018 of the RST[1 to 15], the RST[1 to 15] is activated for a predefined period Δt. The signal 1019 of the SH[1 to 15] is activated at the same activation time with the signal 1018 and remains active until deactivation is needed. The signal 1020 of the RST[16] and the signal 1021 of the SH[16] are constantly active. As shown the control signal 1022 of GD1 is activated for a predefined period Δt′. The control signals 1022 to 1036 are applied to the mixing gates GD1 to GD15 respectively, to activate the respective mixing element GD1 to GD15 for a predetermined activation period Δt′, as described above. At the time at which the activation period of GD1 starts, control signal 1037 of GD16 being used as overflow collector OFC is deactivated until the time at which the activation period of GD15 ends. As shown in the embodiment of FIG. 10b, control signal 1037 remains active for a predefined period Δt″. At the time at which the activation period Δt″ of GD16 ends, the activation period Δt′ of mixing element GD1 starts again, and the above described process is performed once more. The described process also called “sub-integration cycle” is repeated multiple times to achieve measurements over a predefined integration cycle.

FIG. 11a shows a timing diagram during exposure concerning the control of the N-tap CAPD-based pixel of FIG. 9 operating as a four 4-tap pixels. The N-tap CAPD-based pixel 90 is a CAPD-based pixel having N=16 mixing gates and thus, 16 taps. A laser pulse for illuminating a scene is activated for a predefined illumination period. As shown the signal 1100 of RST[i], where i=1 . . . 16, each RST[i] is activated for a predefined period Δt. The signal 1101 of SH[i], where i=1 . . . 16, each SH[i] is activated at the same activation time with the RST[i] signal 1000 and remains active until deactivation is needed. According to this specific timing diagram of FIG. 11a, the mixing element GD1 to GD16 of the pixel are controlled as four groups of four, here first group includes mixing elements GD1, GD2, GD5 and GD6, second group includes mixing elements GD3, GD4, GD7 and GD8, third group includes mixing elements GD9, GD10, GD13 and GD14 and fourth group includes GD11, GD12, GD15 and GD16. The first mixing element of each group, here GD1, GD3, GD9 and GD11, is activated at the same time and in each group, each mixing element is activated one after the other for a predetermined activation period Δt′. The control signals 1102 to 1105 are applied respectively to the mixing elements GD1, GD2, GD5 and GD6 to activate them for a predetermined activation period Δt′, as described above. The control signals 1106 to 1109 are applied respectively to the mixing elements GD3, GD4, GD7 and GD8 to activate them for a predetermined activation period Δt′, as described above. The control signals 1110 to 1113 are applied respectively to the mixing elements GD9, GD10, GD13 and GD14 to activate them for a predetermined activation period Δt′, as described above. The control signals 1114 to 1117 are applied respectively to the mixing elements GD11, GD12, GD15 and GD16 to activate them for a predetermined activation period Δt′, as described above. At the time at which the activation period Δt′ of the fourth mixing element of each group ends, here GD6, GD8, GD14 and GD16, the activation period Δt′ of the first mixing gate of each group, here GD1, GD3, GD9 and GD11, starts again, and the above described process is performed once more. The pulse widths, amplitudes, phases, frequencies, wave-shapes which are shown in the embodiment of FIG. 11a are not limiting. Alternatively, different pulse widths, amplitudes, phases, frequencies, wave-shapes may be used.

FIG. 11b shows a timing diagram concerning the control of the N-tap CAPD-based pixel described in FIG. 9, wherein GD6, GD8, GD14 and GD16 are operating as overflow collector OFC. As shown the signal 1118 of the RST[1-5, 7, 9-13, 15] is activated for a predefined period Δt. The signal 1119 of the SH[1-5, 7, 9-13, 15] is activated at the same activation time with the signal 1118 and remains active until deactivation is needed. The signal 1120 of the RST[6, 8, 14, 16] and the signal 1121 of the SH[6, 8, 14, 16] are constantly active until they need to be deactivated. As shown the control signals 1122, 1126, 1129, and 1133 of GD1, GD3, GD9 and GD11 respectively, the GD1, GD3, GD9 and GD11 are activated for a predefined period Δt′. The control signals 1122 to 1124 are applied respectively to the mixing elements GD1, GD2, GD5 to activate them for a predetermined activation period Δt′, as described above. The control signals 1126 to 1128 are applied respectively to the mixing elements GD3, GD4, GD7 to activate them for a predetermined activation period Δt′, as described above. The control signals 1130 to 1132 are applied respectively to the mixing elements GD9, GD10, GD13 to activate them for a predetermined activation period Δt′, as described above. The control signals 1134 to 1136 are applied respectively to the mixing elements GD11, GD12, GD15 to activate them for a predetermined activation period Δt′, as described above.

At the time at which the activation periods of GD1, GD3, GD9 and GD11 start, control signals 1125, 1129, 1133 and 1137 of GD6, GD8, GD14 and GD16 respectively are deactivated until the time at which the activation period of GD5, GD7, GD13 and GD15 respectively, ends. As shown in the embodiment of FIG. 11b, control signals 1125, 1129, 1133 and 1137 remain active for a predefined period Δt″. At the time at which the activation periods Δt″ of GD6, GD8, GD14 and GD16 end, the activation periods Δt′ of mixing gate GD1, GD3, GD9 and GD11 start again, and the above described process is performed once more. The described process also called “sub-integration cycle” is repeated multiple times to achieve measurements over a predefined integration cycle.

In the embodiments of FIGS. 3, 4, 7a, 7b, 8a, 8b and 9 capacitor and transistor for full well capacity improvement are not included, without limiting these embodiments in that regard. Alternatively, the implementations of FIGS. 3, 4, 7a, 7b, 8a, 8b and 9 may comprise capacitor and transistor for full well capacity improvement.

### Basic Transfer Gate (TG)-Based N-Tap Pixel

FIG. 12 schematically shows an embodiment of a basic transfer gate (TG)-based N-tap pixel implementation layout, wherein the number of transfer gates is N=8.

The TG-based N-tap pixel 120 has a central photocollecting region 121, N transfer gates, here N=8, that connects the central photocollecting region 121 to N floating diffusions FD, N=8. Each of the floating diffusions FD is connected to a reset transistor RST, here RST0 to RST7. For each floating diffusion FD, there is a relevant read-out stage, namely an amplifier AMP and a select transistor SEL. A plurality of n+ regions represented by white octagonal connect the plurality of amplifiers AMP0 to AMP7 to the plurality of select transistors SEL1 to SEL8 and to the plurality of reset transistors RST0 to RST7. The floating diffusion FD connecting the TG to the RST transistor stores modulated charges. The photocollecting region 121 is a pinned photodiode PPD.

In the embodiment of FIG. 12 the photocollecting region 121 is a pinned photodiode PPD, without limiting the present embodiment in that regard. Alternatively, the photocollecting region 121 may be a photogate or partially pinned photodiode, or the like. By sequentially opening each transfer gate TG0 to TG7, depth information from incoming modulated light can be extracted. One or more transfer gates among the transfer gates TG0 to TG7 may operate as overflow gate OFG to drain the ambient light. In a case where one or more transfer gates among the transfer gates TG0 to TG7 operate as overflow gate OFG, the number of RST transistors and read-out stages AMP and SEL may be reduced by 1 for each transfer gate TG that operates permanently as overflow gate OFG.

In the embodiment of FIG. 12, the TG-based N-tap pixel is an 8-tap pixel (N=8), without limiting the present embodiment in that regard. Alternatively, the TG-based N-tap pixel may be a pixel with any number N, e.g. N=3, 4, 5, 6, 8, 9, 10, 11, 12 or more.

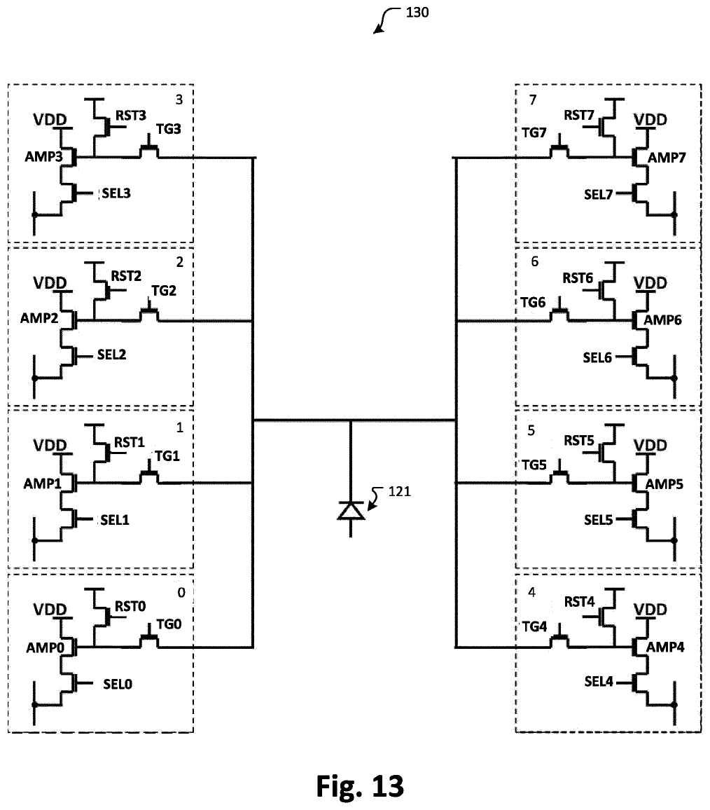

FIG. 13 schematically shows an embodiment of a schematic of the TG-based N-tap pixel of FIG. 12, wherein the number of transfer gates is N=8. The central photocollecting region 121, which is a pinned photodiode PPD, which collects the generated photo-carriers and generates a photocurrent. The photocollecting region 121 is a central photodiode that is connected to the transfer gates TG0 to TG7, each transfer gate TG0 to TG7 being related to a respective tap of the TG-based N-tap pixel and is connected to a respective reset transistor RST0 to RST7, to a respective amplifier AMP0 to AMP7 and to a respective select transistor SEL0 to SEL7. By opening one of the transfer gates TG0 to TG7, the charge produced by photocollecting region 121 is transferred to floating diffusions and to a respective amplifier AMP0 to AMP7. A signal representing this charge is transferred to respective select transistor SEL0 to SEL7 to read out the amplified signal on a read out line. After integration, the floating diffusion signals are read-out line-by-line by toggling the corresponding SEL clocks and the relevant analog stages. The reset transistors RST0 to RST7 are provided to reset the pixel. The floating diffusion level is reset through reset transistors RST0 to RST7, preparing the pixel for the next integration period.

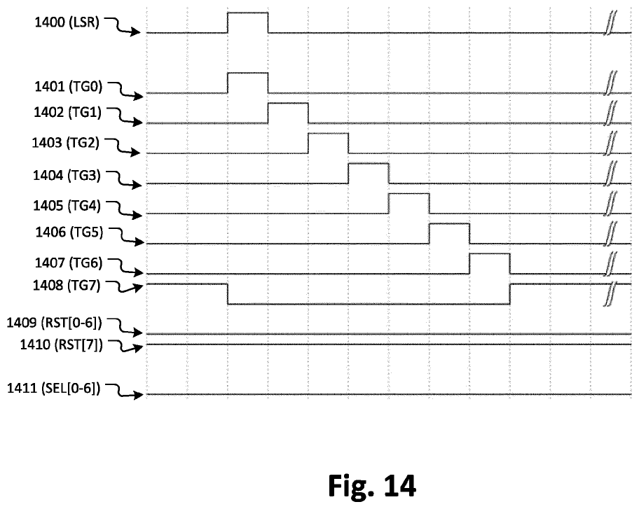

In a case where one or more of the transfer gates TG0 to TG7 operate as overflow gate OFG, the photocollecting region 121 is also connected to the overflow gate OFG. The transfer gates TG0 to TG7 including the overflow gate OFG are controlled according to the timing diagram as shown in FIG. 14, wherein readout timing is not shown as it is similar to regular gate-iToF sensors. As in 2-tap iToF, the received signal will include both the phase shift as configured by the control unit and an additional phase shift induced by the time of flight.

FIG. 14 shows a timing diagram for the TG-based N-tap pixel 120 of FIG. 12 during integration. A laser pulse, having an LSR signal 1400, for illuminating a scene is activated for a predefined illumination period. Transfer gates TG0 to TG7 of an N-tap pixel with seven taps (N=8) are controlled by respective control signals 1401 to 1408. According to this specific timing diagram of FIG. 14, each of the transfer gates TG0 to TG7 of the TG-based N-tap pixel 120 of FIG. 12 is activated one after the other for a predetermined activation time window. In the embodiment of FIG. 14, transfer gate TG7 operates as an overflow gate OFG, therefore, the control signal 1408 of the transfer gate TG7 deactivates the transfer gate TG7 for a predetermined period equal to the period during which the rest of the transfer gates TG0 to TG6 are active. The overflow gate OFG, here TG7, is activated again after the last transfer gate TG6 has been closed. The described process also called “sub-integration cycle” is repeated multiple times to achieve measurements over a predefined integration cycle.

In the embodiment of FIG. 14, the pulse duration of the overflow gate OFG, here TG7, is larger than that of rest of the transfer gates TG0 to TG6, thereby spacing the LSR pulses further apart in time. The LSR signal 1400 of the LSR pulse shows an example of the optical output from the illumination device (see 10 in FIG. 1). A spacing of the pulse duration of the overflow gate OFG in time may allow high optical peak power while maintaining eye-safe operation, which may result to less integration time on the taps to reach same signal level, and thus, less ambient light may be collected thereby an improved Signal-to-Noise Ratio (SNR) may be achieved.

TG-Based NTAP Pixel with Memory Nodes

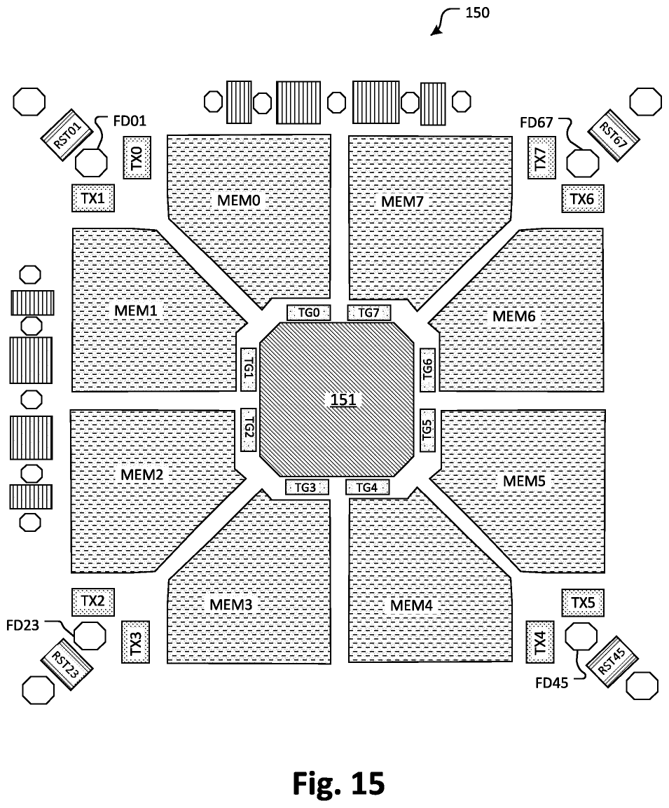

FIG. 15 schematically shows in top view an embodiment of a TG-based N-tap pixel with memory nodes. The TG-based N-tap pixel 150 is the basic TG-based N-tap pixel 120 of FIG. 12 which also comprises additional memory nodes MEM, which can be implemented via gate-elements or PPDs, etc. The additional memory nodes MEM are used for intermediate charge storage.

The TG-based N-tap pixel 150 has a central photocollecting region 151, N=8 first transfer gates TG0 to TG7 that connect the central photocollecting region 151 to a plurality of MEM nodes. Each of the first transfer gates TG0 to TG7 connects the photocollecting region 151, which is a pinned photodiode PPD, to a respective memory node MEM0 to MEM7. Each memory node MEM0 to MEM7 is implemented as intermediate storage node. In turn, each memory node MEM0 to MEM7 is connected, through a respective second transfer gate TX0 to TX7, to a floating diffusion region FD (white octagonal). Therefore, multiple MEM nodes are connected to the same floating diffusion region FD.

In the embodiment of FIG. 15, two memory nodes MEM are connected to the same floating diffusion region FD, namely memory nodes MEM0 and MEM1 are connect to the floating diffusion region FD01, memory nodes MEM2 and MEM3 are connect to the floating diffusion region FD23, memory nodes MEM4 and MEM5 are connect to the floating diffusion region FD45, and memory nodes MEM6 and MEM7 are connect to the floating diffusion region FD67. The floating diffusion region FD01 is connected on one side with two second transfer gates TX0 and TX1 and on another side with a reset transistor RST01. The floating diffusion region FD23 is connected on one side with two second transfer gates TX2 and TX3 and on another side with a reset transistor RST23. The floating diffusion region FD45 is connected on one side with two second transfer gates TX4 and TX5 and on another side with a reset transistor RST45. The floating diffusion region FD67 is connected on one side with two second transfer gates TX6 and TX7 and on another side with a reset transistor RST67. Similarly, each of the floating diffusion regions FD01, FD23, FD45, FD67 is connected to a relevant read-out stage, namely an amplifier AMP and a select transistor SEL. As described above, every two MEM nodes are connected to a shared read-out stage, resulting in N/2=4 read-out stages, R=4.

In the embodiment of FIG. 15, the photocollecting region 151 is a pinned photodiode PPD, without limiting the present embodiment in that regard. Alternatively, the photocollecting region 151 may be a photogate or partially pinned photodiode, or the like. In the embodiment of FIG. 15, the TG-based N-tap pixel with memory nodes is an 8-tap pixel (N=8), without limiting the present embodiment in that regard. Alternatively, the TG-based N-tap pixel may be a pixel with any number N, e.g. N=3, 4, 5, 6, 8, 9, 10, 11, 12 or more. One or more transfer gates among the transfer gates TG0 to TG7 may operate as overflow gate OFG to drain the ambient light. In a case where one or more transfer gates among the transfer gates TG0 to TG7 operate as overflow gate OFG, the number of RST transistors and read-out stages AMP and SEL may be reduced by 1 for each transfer gate TG that operates permanently as overflow gate OFG. The transfer gates TG0 to TG7 including the overflow gate OFG are controlled according to the timing diagram as shown in FIG. 17 during read-out period, wherein integration period timing is not shown as it is similar to FIG. 14.

In the embodiment of FIG. 15, the first transfer gates TG0 to TG7, the second transfer gates TX0 to TX7 and the overflow gate OFG may be implemented e.g. as transistors, and the memories MEM0 to MEM7 may for example be implemented as capacitors. By operating the transfer gates TG0 to TG7, depth information from incoming modulated light can be extracted.

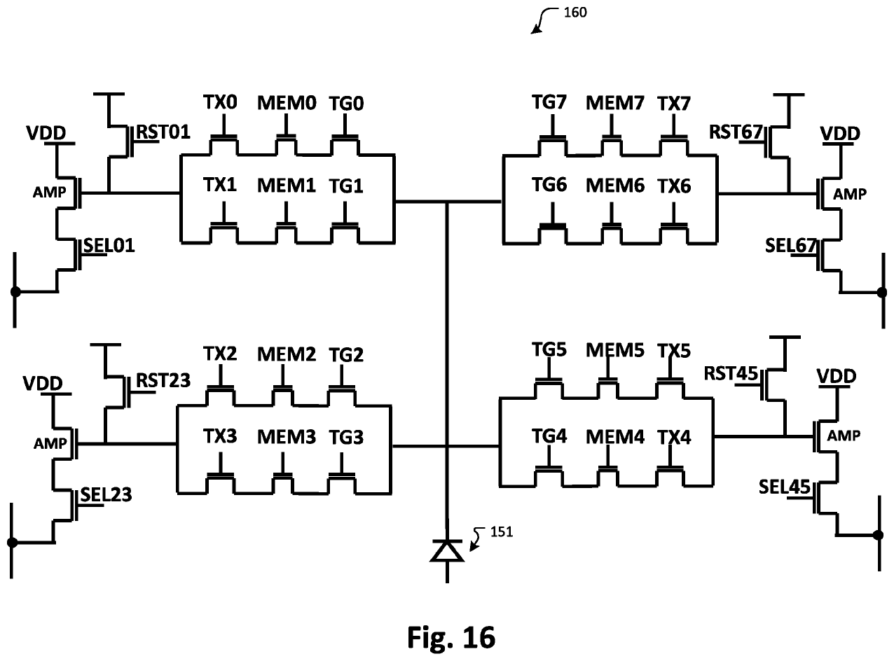

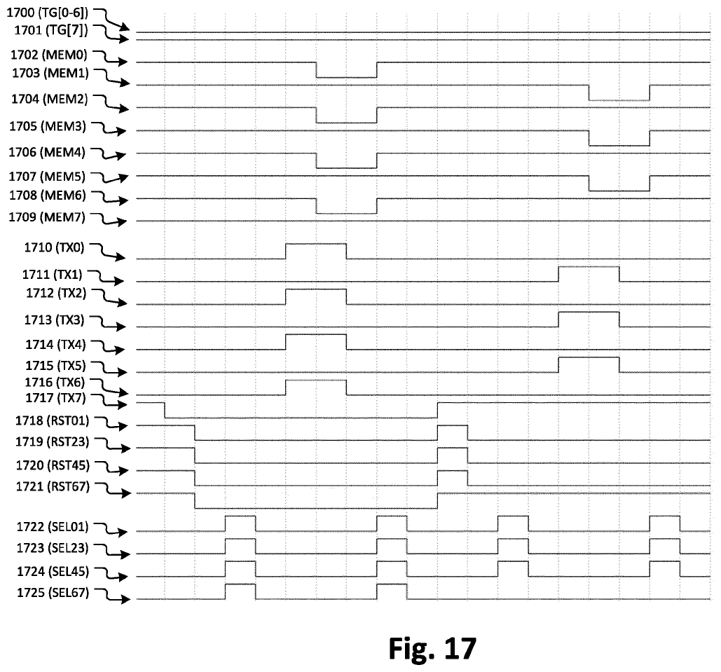

FIG. 16 schematically shows an embodiment of a schematic 160 of the TG-based N-tap pixel with memory nodes of FIG. 15, wherein the number of transfer gates is N=8. The central photocollecting region 151, which is a pinned photodiode PPD, collects incident photons and generates a photocurrent. The central photocollecting region 151 is connected to first transfer gates TG0 to TG7, each first transfer gate TG0 to TG7 being related to a respective tap of the TG-based N-tap pixel. By opening one of the transfer gates TG0 to TG7, the charge produced by central photocollecting region 151 is transferred onto a respective memory MEM0 to MEM7 where it is stored. That is, during integration, all charges are stored in the memory nodes MEM. At this point, second transfer gates TX0 to TX7 are closed. As a first step, the floating diffusion regions FD are reset and their levels read-out. This read-out gives the noise level of the reset transistors RST on the floating diffusion regions FD. As a next step, charges are transferred from R MEM nodes, to floating diffusion regions FD through second transfer gates TX0 to TX7. Then, floating diffusion levels are read-out again. The RST noise levels can then be subtracted from the actual signal levels to get a reset noise-free signal. This process of reading out reset level and signal level is repeated N/R times until all MEM node charges are read-out. The reset transistors RST01, RST23, RST45, RST67 are provided to reset the pixel. The floating diffusion level is reset through reset transistors RST01, RST23, RST45, RST67, preparing the pixel for the next integration period.

In the embodiment of FIG. 16, N=8, R=4, therefore R MEM nodes equal to 4 MEM nodes. For example, the charges which are stored in MEM0, MEM2, MEM4 and MEM6 are transferred to floating diffusion region FD01, FD23, FD45, FD67 respectively through second transfer gates TX0, TX2, TX4 and TX6 respectively. By opening the respective second transfer gate TX0, TX2, TX4 and TX6, the charge collected onto the memory nodes MEM0, MEM2, MEM4 and MEM6 is transferred to amplifier AMP0, AMP2, AMP4 and AMP6. A signal representative of the charges in FD01, FD23, FD45 and FD67 is transferred to select transistor SEL01, SEL23, SEL45, SEL67 to read out the amplified signal on a read-out line. A reset transistor RST01, RST23, RST45, RST67 is provided to reset the pixel.

FIG. 17 shows a readout timing diagram of the TG-based N-tap pixel with memory nodes of FIG. 15, wherein the number of transfer gates is N=8 and the number of readout stages is R=4, with last transfer gate TG7 operating as overflow gate OFG. During read-out, signal 1700 represents the control signal of the first transfer gates TG0 to TG6 and signal 1701 represents the control signal of the first transfer gate TG7 which operates as overflow gate OFG. Similarly, signals 1702 to 1709 represent the control signals of memory nodes MEM0 to MEM7 respectively, signals 1710 to 1716 represent the control signals of second transfer gates TG0 to TG7 respectively, signals 1718 to 1721 represent the control signals of reset transistors RST01 to RST67 respectively and signals 1722 to 1725 represent the control signals of select transistors SEL01 to SEL67 respectively. Alternative timing for signals 1722 to 1725 is to keep the SEL01 to SEL67 signals high during the whole read-out procedure for that pixel, as long as the output lines are still sampled at the correct times (i.e. in the time-frame where SEL is high in the current timing chart).

In the embodiment of FIGS. 15, 16, 17, the operation of a TG-based N-tap pixel with memory nodes is described, wherein each first transfer gate TG0 to TG7 is driven separately, without limiting the present embodiments in that regard. In an alternative embodiment may be driving the N taps in groups of 2, e.g. TG0 and TG1 together, TG2 and TG3 together, etc. Then, MEM0 and MEM1, MEM2 and MEM3, etc. may be binned together on the same to floating diffusion region FD for read-out, for example in a case of low-signal conditions where binning improves SNR or to reduce average mismatch due to different storage channels.

### Cascaded TG-Based N-Tap Pixel

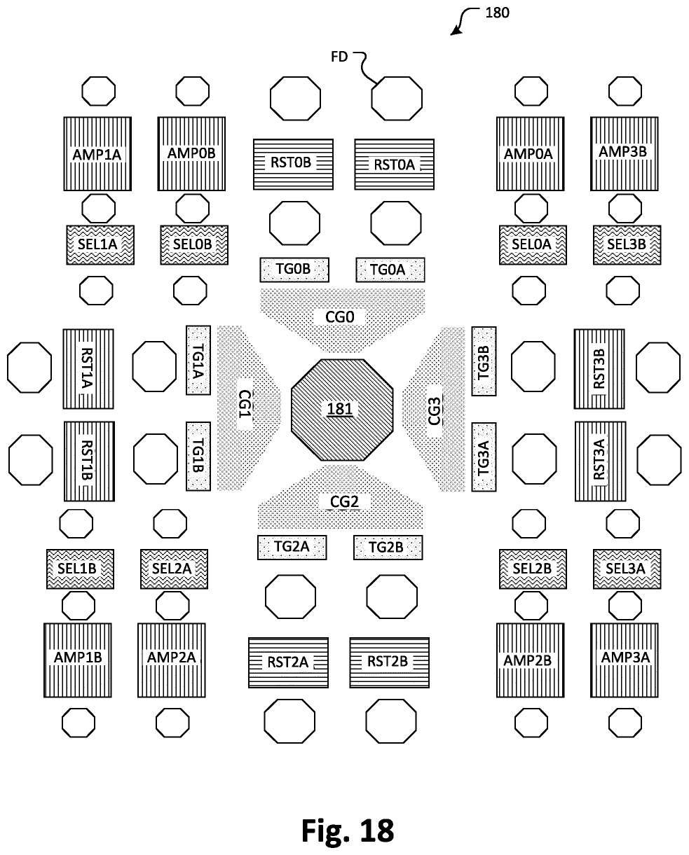

FIG. 18 schematically shows in top view an embodiment of a cascaded TG-based N-tap pixel. In the cascaded TG-based N-tap pixel 180, the number of taps is eight, N=8 taps, the number of read-out stages is eight, R=8 read-out stages and the number of modulation stages is two, S=2 modulation stages with N₁=4, N₂=2, where Nₓ is the number of gates on each stage x input.

The cascaded TG-based N-tap pixel 180 has a central photocollecting region 181 with eight taps, N=8. The 8 taps are connected to the photocollecting region 181 through 12 modulation gates. The modulator gates are separated in 2 stages. Stage 1 consists of N₁=4 modulation gates. Stage 2 consists of N₁*N₂=8 modulation gates, for a total of 12 modulation gates. The cascaded TG-based N-tap pixel 180 has four common gates CG0 to CG3 that connect the central photocollecting region 181 to eight transfer gates TG0A, TG0B, TG1A, TG1B, TG2A, TG2B, TG3A, TG3B. Each transfer gate TG0A, TG0B, TG1A, TG1B, TG2A, TG2B, TG3A, TG3B is related to a respective tap of the pixel. Here, common gate CG0 is directly connected to transfer gates TG0A, TG0B, common gate CG1 is directly connected to transfer gates TG1A, TG1B, common gate CG2 is directly connected to transfer gates TG2A, TG2B, common gate CG3 is directly connected to transfer gates TG3A, TG3B. Each transfer gate TG0A, TG0B, TG1A, TG1B, TG2A, TG2B, TG3A, TG3B is connected through floating diffusion regions FD to a respective reset transistor RST, here RST0A, RST0B, RST1A, RST1B, RST2A, RST2B, RST3A, RST3B. For each floating diffusion region FD, there is a relevant read-out stage, namely an amplifier AMP and a select transistor SEL. A plurality of n+ regions FD represented by white octagonals connect the plurality of select transistors SEL0A, SEL0B, SEL1A, SEL1B, SEL2A, SEL2B, SEL3A, SEL3B to the plurality of amplifiers AMP0A, AMP0B, AMP1A, AMP1B, AMP2A, AMP2B, AMP3A, AMP3B respectively.

In the embodiment of FIG. 18, the common gates CG0 to CG3 and the transfer gates TG0A, TG0B, TG1A, TG1B, TG2A, TG2B, TG3A, TG3B are modulators that are connected to a first modulation area/charge collection region, here central photocollecting region 181, wherein common gates CG0 to CG3 are directly connected to the first modulation area/charge collection region, as described above. The photocollecting region 181 is a pinned photodiode PPD, without limiting the present embodiment in that regard. Alternatively, the photocollecting region 181 may be a photogate or partially pinned photodiode, or the like. The cascaded TG-based N-tap pixel 180 of FIG. 18 has two modulation stages, without limiting the present embodiment in that regard. The skilled person may choose any suitable number of modulation stages. The cascaded TG-based N-tap pixel 180 of FIG. 18 is an 8-tap pixel (N=8), without limiting the present embodiment in that regard. Alternatively, the cascaded TG-based N-tap pixel may be a pixel with any number N, e.g. N=3, 4, 5, 6, 8, 9, 10, 11, 12 or more. The number of modulation stages is two, S=2 modulation stages, in the embodiment of FIG. 18, without limiting the present embodiment in that regard. The number of modulation stages may be any integer value.

In the embodiment of FIG. 18, the cascaded TG-based N-tap pixel 180 with N=8 taps has a photocollecting region 181 that needs to support N₁=4 taps instead of N=8 taps, since the demodulation of the incoming light is performed in multiple modulation stages, here in two modulation stages S=2. Due to the reduced number of modulators connecting to the photocollecting region 181, the collection area may be shrinked, and thus, the modulation electric field created by the modulators CG may be improved.

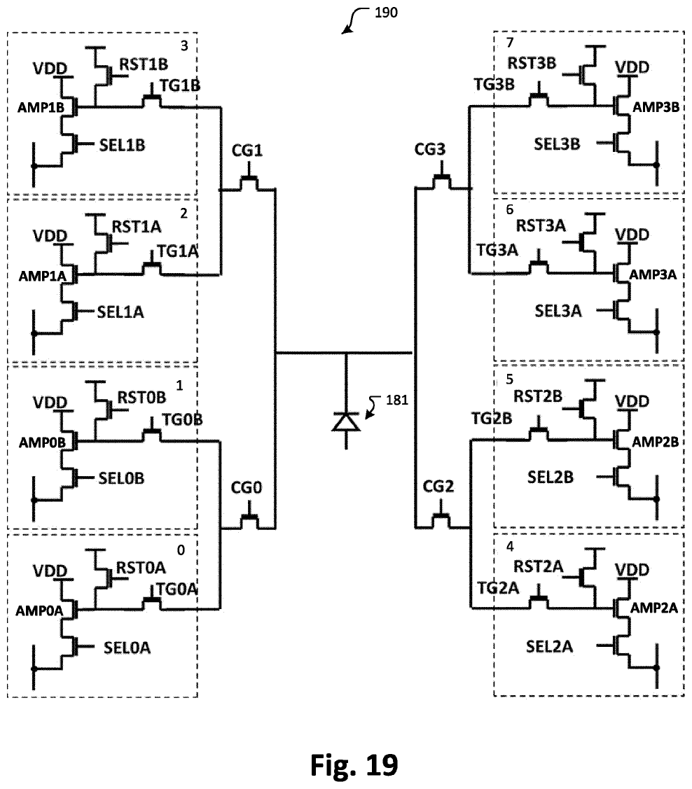

FIG. 19 schematically shows an embodiment of a schematic of the cascaded TG-based N-tap pixel of FIG. 18. The schematic of pixel 180 represents a read-out circuit of the pixel 180. The central photocollecting region 181, which here is a pinned photodiode PPD, collects incident photons and generates a photocurrent. The central photocollecting region 181 is directly connected to common gates CG0 to CG3 which are directly connected to transfer gates TG0A, TG0B, TG1A, TG1B, TG2A, TG2B, TG3A, TG3B, as described above. The generated photocurrent is transferred from the photocollecting region 181 to the common gates CG0 to CG3, and then to the transfer gates TG0A, TG0B, TG1A, TG1B, TG2A, TG2B, TG3A, TG3B. By opening one of the transfer gates TG0A, TG0B, TG1A, TG1B, TG2A, TG2B, TG3A, TG3B, the charge produced by photocollecting region 181 is transferred to floating diffusion regions FD and to a respective amplifier AMP0A, AMP0B, AMP1A, AMP1B, AMP2A, AMP2B, AMP3A, AMP3B. A signal representing these charges is transferred to respective select transistor SEL0A, SEL0B, SEL1A, SEL1B, SEL2A, SEL2B, SEL3A, SEL3B to read-out the amplified signal on a read out line. After integration, the floating diffusion signals are read-out line-by-line by toggling the corresponding SEL clocks and the relevant analog stages. The reset transistors RST0A, RST0B, RST1A, RST1B, RST2A, RST2B, RST3A, RST3B are provided to reset the pixel. The floating diffusion level is reset through reset transistors RST0A, RST0B, RST1A, RST1B, RST2A, RST2B, RST3A, RST3B, preparing the pixel for the next integration period.

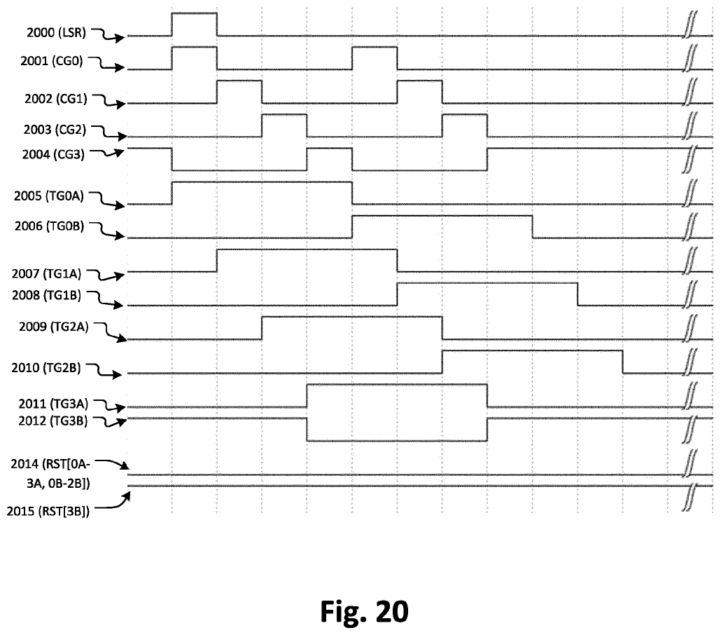

In the embodiment of FIGS. 18 and 19, the generated photocurrent is transferred from the photocollecting region 181 to the common gates CG0 to CG3, and then to the transfer gates TG0A, TG0B, TG1A, TG1B, TG2A, TG2B, TG3A, TG3B, such that the demodulation of the incoming light is split into multiple modulation stages. By implementing multiple modulation stages, the number of taps, i.e. modulators, for example, transfer gates or common gates, which are connected directly to the central photocollecting region, and thus, the size of the central photocollecting region may be reduced. One or more of the transfer gates TG0A, TG0B, TG1A, TG1B, TG2A, TG2B, TG3A, TG3B may operate as overflow gate OFG. The common gates CG0 to CG3 and transfer gates TG0A, TG0B, TG1A, TG1B, TG2A, TG2B, TG3A, TG3B including the overflow gate OFG are controlled according to the timing diagram as shown in FIG. 20.

FIG. 20 shows a timing diagram during integration of the cascaded TG-based N-tap pixel of FIG. 18, wherein transfer gate TG3B operates as overflow gate OFG. A laser pulse, having an LSR signal 2000, for illuminating a scene is activated for a predefined illumination period. Common gates CG0 to CG3 are controlled by respective control signals 2001 to 2004. According to this specific timing diagram of FIG. 20, as shown the control signals 2001 to 2004, each of the common gates CG0 to CG3 of the cascaded TG-based N-tap pixel of FIG. 18 opens one after the other for a predetermined activation time window. As shown the control signals 2005, 2007, 2009, 2011 of transfer gates TG0A, TG1A, TG2A, TG3A respectively, the transfer gates TG0A, TG1A, TG2A, TG3A open one after the other for a predetermined activation time window of a window length that is four times the activation time window for CG0, CG1, CG2, CG3 respectively. Each transfer gate TG0A, TG1A, TG2A, TG3A opens at the same time with the respective common gates CG0 to CG3. The common gates CG0 to CG3 open once more one after the other, wherein common gate CG0 opens again at a time at which the activation period of the common gate CG3 ends. As shown the control signals 2006, 2008, 2010 of transfer gates TG0B, TG1B, TG2B respectively, the transfer gates TG0B, TG1B, TG2B open one after the other for a predetermined activation time window of a window length that is four times the previous stage CG on period. Each transfer gate TG0B, TG1B, TG2B opens at the same time at which the respective common gates CG0 to CG2 open for the second time. Since the transfer gate TG3B operates as an overflow gate OFG, transfer gate TG3B opens at the same time at which common gate CG3 opens for the second time. Both common gate CG3 and transfer gate TG3B remain open as necessary. After the signal charges pass through all stages, they end up in their respective storage nodes.

In the embodiment of FIG. 20, transfer gate TG3B operates as an overflow gate OFG, without limiting the present embodiment in that regard. Alternatively, any other transfer gate may operate as an overflow gate OFG, or one or more transfer gates may operate as overflow gates OFG, or none of the transfer gates may operate as overflow gate OFG, or the like.

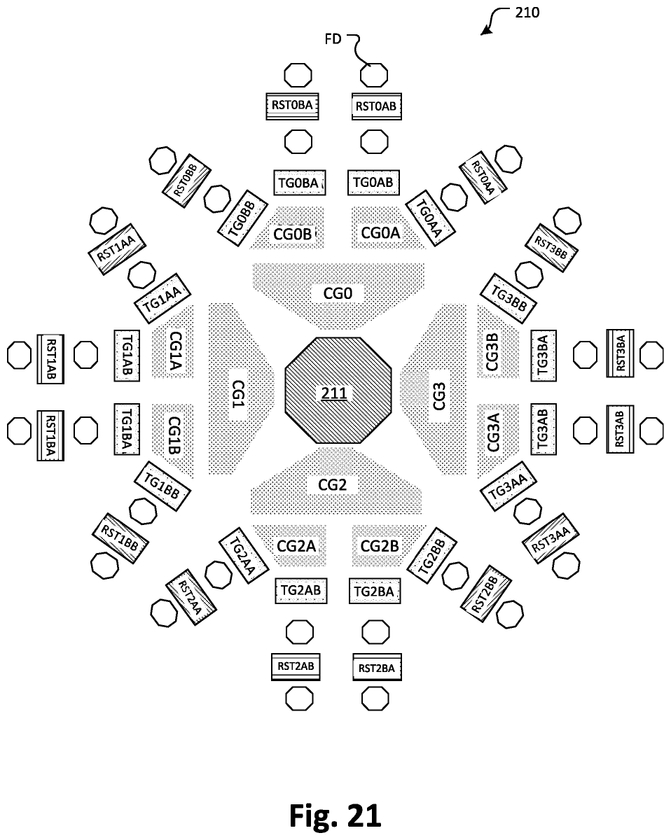

FIG. 21 schematically shows in top view an embodiment of a cascaded TG-based N-tap pixel, wherein N=16, S=3, N₁=4, N₂=2, N₃=2, R=16.

In the cascaded TG-based N-tap pixel 210, the number of taps is sixteen, N=16 taps, the number of read-out stages is sixteen, R=16 read-out stages, the number of modulation stages is three, S=3 modulation stages and the number of gates Nₓ on each stage (x−1)output is N₁=4, N₂=2 and N₃=2.

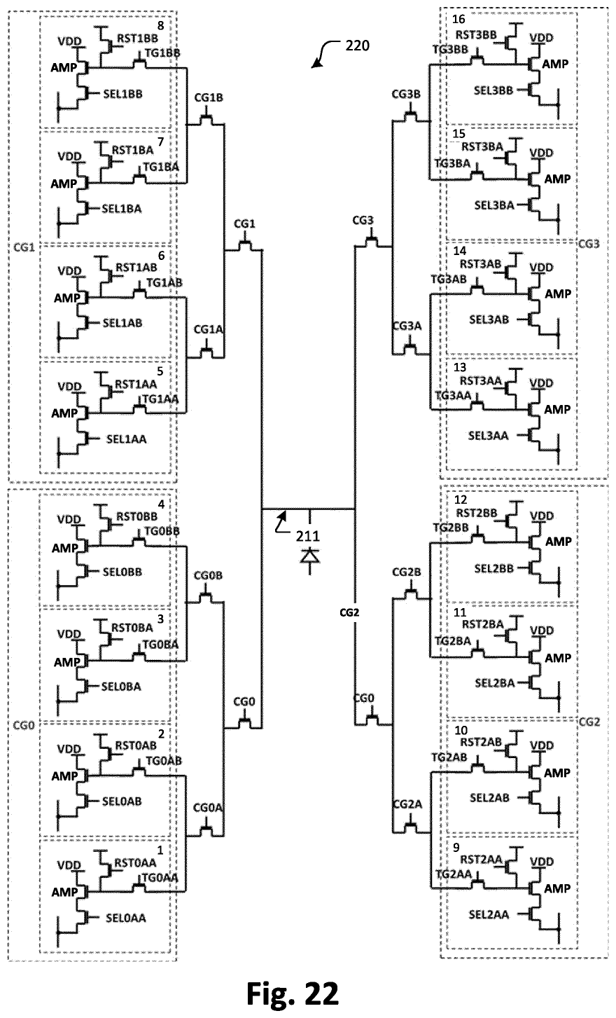

The cascaded TG-based N-tap pixel 210 has a central photocollecting region 211 with sixteen taps, N=16. The 16 taps are separated in three groups, N₁, N₂, and N₃ each group being related to a respective modulation stage x. The first group has 4 taps, N₁=4, the second group has 2 taps at each previous stages output, N₂=2, and the third group has 2 taps at each previous stages output, N₃=2. The cascaded TG-based N-tap pixel 210 has four first common gates CG0 to CG3 that connect the central photocollecting region 211 to eight second common gates CG0A, CG0B, CG1A, CG1B, CG2A, CG2B, CG3A, CG3B, i.e. first group N₁=4. That is, each first common gate CG0 to CG3 is connected to two second common gates, i.e. second group N₂=2. Each second common gate CG0A, CG0B, CG1A, CG1B, CG2A, CG2B, CG3A, CG3B is connected to two transfer gates, i.e. third group N₃=2. That is, each second common gate CG0A, CG0B, CG1A, CG1B, CG2A, CG2B, CG3A, CG3B is connected to two respective transfer gates TG0AA and TG0AB, TG0BA and TG0BB, TG1AA and TG1AB, TG1BA and TG1BB, TG2AA and TG2AB, TG2BA and TG2BB, TG3AA and TG3AB, TG3BA and TG3BB. Each transfer gate TG0AA, TG0AB, TG0BA, TG0BB, TG1AA, TG1AB, TG1BA, TG1BB, TG2AA, TG2AB, TG2BA, TG2BB, TG3AA, TG3AB, TG3BA, TG3BB is related to a respective tap of the pixel. Each transfer gate TG0AA, TG0AB, TG0BA, TG0BB, TG1AA, TG1AB, TG1BA, TG1BB, TG2AA, TG2AB, TG2BA, TG2BB, TG3AA, TG3AB, TG3BA, TG3BB is connected through a floating diffusion region FD to a respective reset transistor RST0AA, RST0AB, RST0BA, RST0BB, RST1AA, RST1AB, RST1BA, RST1BB, RST2AA, RST2AB, RST2BA, RST2BB, RST3AA, RST3AB, RST3BA, RST3BB. Similarly, each transfer gate TG is also connected through a floating diffusion region FD to a respective read-out stage, namely to a respective amplifier AMP. These respective amplifiers AMP are connected through an n_region to respective selection transistor SEL. Here, the read-out stages in the layout are omitted, however, FIG. 22 shows these read-out stages.

In the embodiment of FIG. 21, the photocollecting region 211 is a pinned photodiode PPD, without limiting the present embodiment in that regard. Alternatively, the photocollecting region 211 may be a photogate or partially pinned photodiode, or the like. The cascaded TG-based N-tap pixel 210 of FIG. 21 has three modulation stages, without limiting the present embodiment in that regard. The skilled person may choose any suitable number of modulation stages. The cascaded TG-based N-tap pixel 210 of FIG. 21 is a 16-tap pixel (N=16), without limiting the present embodiment in that regard. Alternatively, the cascaded TG-based N-tap pixel may be a pixel with any number N of taps. The number of modulation stages is three, S=3 modulation stages, in the embodiment of FIG. 21, without limiting the present embodiment in that regard. The number of modulation stages may be any integer value.

FIG. 22 schematically shows an embodiment of a schematic of the cascaded TG-based N-tap pixel of FIG. 21. The schematic of pixel 210 represents a read-out circuit of the pixel 210. The central photocollecting region 211, which here is a pinned photodiode PPD, collects incident photons and generates a photocurrent. The central photocollecting region 211 is directly connected to first common gates CG0 to CG3 which are directly connected to second common gates CG0A, CG0B, CG1A, CG1B, CG2A, CG2B, CG3A, CG3B, as described above. The generated photocurrent is transferred from the photocollecting region 211 to the first common gates CG, which is the first modulation step, then to the second common gates CG, which is the second modulation step, and then to the transfer gates TG, which is the third modulation step. Each of the first common gates CG, second common gates CG and transfer gates TG operates as a modulator of the incoming light. By opening one of the transfer gates TG the charge produced by photocollecting region 211 is transferred to floating diffusion regions FD and to a respective amplifier AMP. A signal representing this charge is transferred to a respective select transistor SEL to read-out the amplified signal on a read out line. The reset transistors RST are provided to reset the pixel. The floating diffusion level is reset through reset transistors RST, preparing the pixel for the next integration period.

In the embodiment of FIGS. 21 and 22, the first modulation step may happen very fast due to the small modulation area. After the first modulation steps by first common gates CG, the signal is modulated further by second common gates CG and transfer gates TG before being transferred to the respective floating diffusion region FD. The operating frequency (or pulse width) of the first modulation step f₁ is determined by the FMOD or pulse width of the light signal. For each subsequent modulation stage Sₓ, the operating frequency fₓ is determined by:

$${f}_{x} = {f}_{( x - 1 )} / {N}_{( x - 1 )}$$

where Nₓ is the number of taps and x is the modulation stage.

Subsequent stages can thus have slower charge transfer than the previous stage.

Cascaded TG-Based NTAP Pixel with Memory Nodes

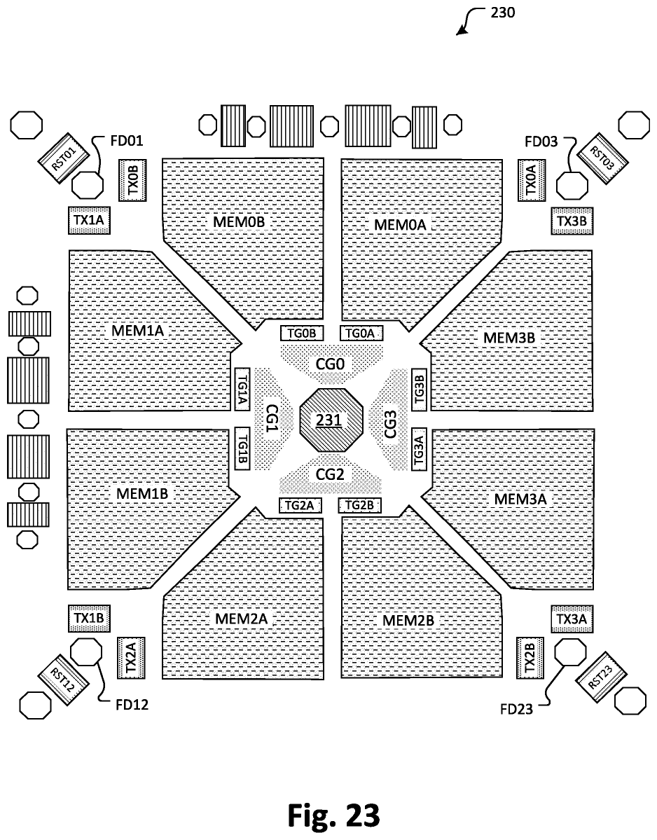

FIG. 23 schematical shows in top view a cascaded TG-based NTAP pixel with memory nodes, wherein S=2, N₁=4, N₂=2, R=4.

In the cascaded TG-based NTAP pixel 230, the number of taps is eight, N=8 taps, the number of read-out stages is four, R=4 read-out stages and the number of modulation stages is two, S=2 modulation stages with N₁=4, N₂=2, where Nₓ is the number of gates on each stage x connected to each output of the previous stage.

The cascaded TG-based N-tap pixel 230 has a central photocollecting region 231 with eight taps, N=8. The 8 taps are separated in two groups, N₁, N₂, each group being related to a respective modulation stage x. The first group has 4 gates, N₁=4 and the second group has two gates, N₂=2. The cascaded TG-based N-tap pixel 230 has four common gates CG0 to CG3 that connect the central photocollecting region 231, which is a pinned photodiode PPD, to eight first transfer gates TG0A, TG0B, TG1A, TG1B, TG2A, TG2B, TG3A, TG3B. Each first transfer gate TG0A, TG0B, TG1A, TG1B, TG2A, TG2B, TG3A, TG3B is related to a respective tap of the pixel. Here, common gate CG0 is directly connected to first transfer gates TG0A and TG0B, common gate CG1 is directly connected to first transfer gates TG1A and TG1B, common gate CG2 is directly connected to first transfer gates TG2An and TG2B, and common gate CG3 is directly connected to first transfer gates TG3A and TG3B. Each first transfer gate TG0A, TG0B, TG1A, TG1B, TG2A, TG2B, TG3A, TG3B is connected to a respective memory node MEM0A, MEM0B, MEM1A, MEM1B, MEM2A, MEM2B, MEM3A, MEM3B. Each memory node MEM is implemented as intermediate storage node. In turn, each memory node MEM is connected, through a respective second transfer gate TX0A, TX0B, TX1A, TX1B, TX2A, TX2B TX3A, TX3B, to a floating diffusion region FD (white octagonal). Therefore, two memory nodes MEM are connected to the same floating diffusion region FD.

In the embodiment of FIG. 23, two second transfer gates TX are connected to the same floating diffusion region FD, namely second transfer gates TX1A and TX0B are connect to the floating diffusion region FD01, second transfer gates TX2B and TX3A are connect to the floating diffusion region FD23, second transfer gates TX0A and TX3B are connect to the floating diffusion region FD03, and second transfer gates TX1B and TX2A are connect to the floating diffusion region FD12. The floating diffusion region FD01 is also connected with a reset transistor RST01. The floating diffusion region FD23 is also connected with a reset transistor RST23. The floating diffusion region FD03 is also connected with a reset transistor RST03. The floating diffusion region FD12 is also connected with a reset transistor RST12. Similarly, each of the floating diffusion regions FD01, FD03, FD12, FD23 is connected to a relevant read-out stage, namely an amplifier AMP and a select transistor SEL. As described above, every two second transfer gates TX, and thus, every two first transfer gates TG are connected to a shared read-out stage, resulting in N/2=4 read-out stages, R=4.

In the embodiment of FIG. 23, the photocollecting region 231 is a pinned photodiode PPD, without limiting the present embodiment in that regard. Alternatively, the photocollecting region 231 may be a photogate or partially pinned photodiode, or the like. In the embodiment of FIG. 23, the cascaded TG-based N-tap pixel with memory nodes is an 8-tap pixel (N=8), without limiting the present embodiment in that regard. Alternatively, the cascaded TG-based N-tap pixel may be a pixel with any number N, e.g. N=3, 4, 5, 6, 8, 9, 10, 11, 12 or more. The number of modulation stages is two, S=2 modulation stages, in the embodiment of FIG. 23, without limiting the present embodiment in that regard. The number of modulation stages may be any integer value.

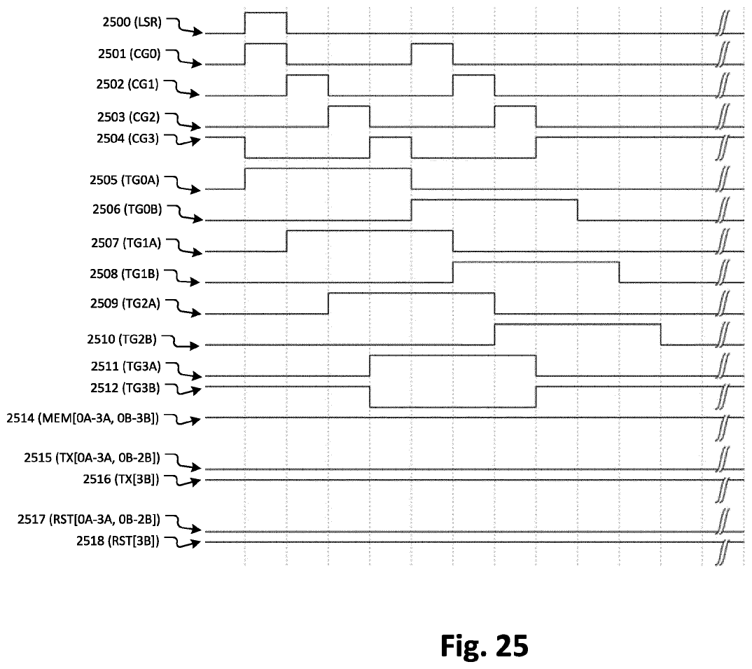

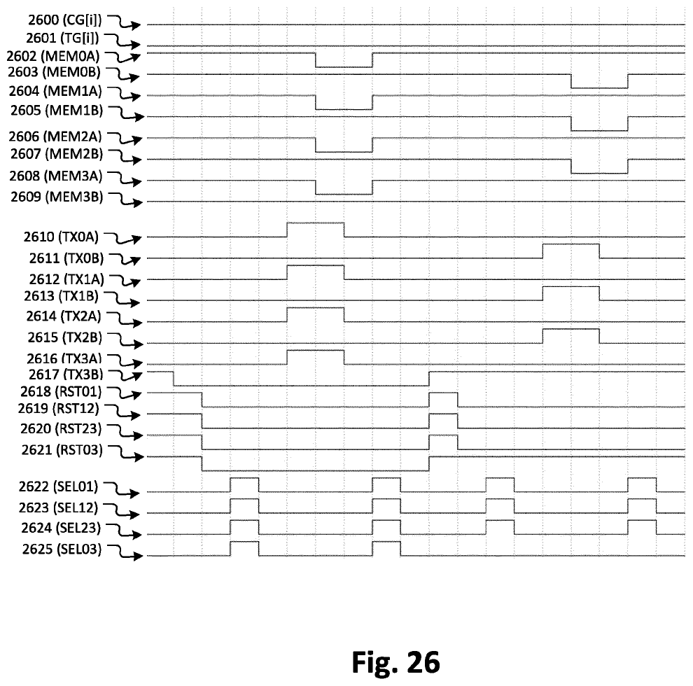

In the embodiment of FIG. 23, one or more first transfer gates TG may operate as overflow gate OFG to drain the ambient light. In a case where one or more first transfer gates TG operate as overflow gate OFG, the number of RST transistors and read-out stages AMP and SEL may be reduced by 1 for each first transfer gates TG that operates permanently as overflow gate OFG. The first transfer gates TG including the overflow gate OFG are controlled according to the timing diagram as shown in FIG. 25 during the integration period, and as shown in FIG. 26 during the read-out period.

In the embodiment of FIG. 23, the first transfer gates TG, the second transfer gates TX and the overflow gate OFG may be implemented e.g. as transistors, and the memories nodes MEM may for example be implemented as capacitors. By operating the first transfer gates TG, depth information from incoming modulated light can be extracted.

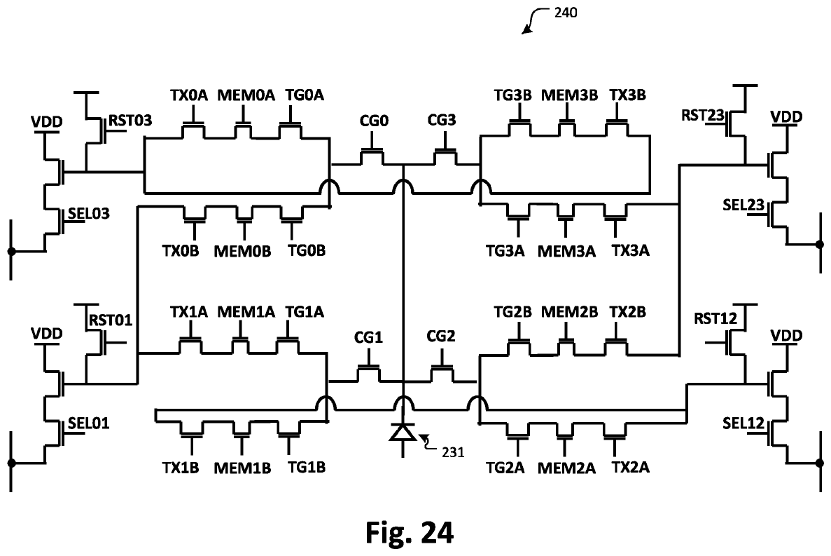

FIG. 24 schematically shows an embodiment of a schematic of the cascaded TG-based N-tap pixel with memory nodes of FIG. 23. The central photocollecting region 231, which here is a pinned photodiode PPD, collects incident photons and generates a photocurrent. The central photocollecting region 231 is directly connected to common gates CG0 to CG3 which are directly connected to first transfer gates TG0A, TG0B, TG1A, TG1B, TG2A, TG2B, TG3A, TG3B, as described above. The generated photocurrent is transferred from the photocollecting region 231 to the common gates CG0 to CG3, and then to the first transfer gates TG0A, TG0B, TG1A, TG1B, TG2A, TG2B, TG3A, TG3B. By opening one of the first transfer gates TG0A, TG0B, TG1A, TG1B, TG2A, TG2B, TG3A, TG3B, the charge produced by photocollecting region 231 is transferred onto a respective memory MEM0A, MEM0B, MEM1A, MEM1B, MEM2A, MEM2B, MEM3A, MEM3B where it is stored. That is, during integration, all charges are stored in the memory nodes MEM. At this point, second transfer gates TX0A, TX0B, TX1A, TX1B, TX2A, TX2B, TX3A, TX3B are closed. As a first step, the floating diffusion regions FD are reset and their levels read-out. This read-out gives the noise level of the reset transistors RST on the floating diffusion regions FD. As a next step, charges are transferred from R MEM nodes, to floating diffusion regions FD through second transfer gates TX. Then, floating diffusion levels are read-out again. The RST noise levels can then be subtracted from the actual signal levels to get a reset noise-free signal. This process of reading out reset level and signal level is repeated N/R times until all MEM node charges are read-out. The reset transistors RST01, RST23, RST03, RST12 are provided to reset the pixel. The floating diffusion level is reset through reset transistors RST01, RST23, RST03, RST12, preparing the pixel for the next integration period.

FIG. 25 shows a timing diagram during integration of the cascaded TG-based N-tap pixel with memory nodes of FIG. 23, wherein transfer gate TX3B operates as overflow gate OFG. A laser pulse, having an LSR signal 2500, for illuminating a scene is activated for a predefined illumination period. Common gates CG0 to CG3 are controlled by respective control signals 2501 to 2504. According to this specific timing diagram of FIG. 23, as shown by the control signals 2501 to 2504, each of the common gates CG0 to CG3 of the cascaded TG-based N-tap pixel with memory nodes of FIG. 23 opens one after the other for a predetermined activation time window. As shown by the control signals 2505, 2507, 2509, 2511 of transfer gates TG0A, TG1A, TG2A, TG3A respectively, the first transfer gates TG0A, TG1A, TG2A, TG3A open one after the other for a predetermined activation time window of a window length that is four times the previous stage CG on period. Each first transfer gate TG0A, TG1A, TG2A, TG3A opens at the same time with the respective common gates CG0 to CG3. The common gates CG0 to CG3 open once more one after the other, wherein common gate CG0 opens again at a time at which the activation period of the common gate CG3 ends. As shown the control signals 2506, 2508, 2510 of first transfer gates TG0B, TG1B, TG2B respectively, the transfer gates TG0B, TG1B, TG2B open one after the other for a predetermined activation time window of a window length that is four times the previous stage CG on period. Each first transfer gate TG0B, TG1B, TG2B opens at the same time at which the respective common gates CG0 to CG2 open for the second time. Since the first transfer gate TG3B operates as an overflow gate OFG, first transfer gate TG3B (see control signal 2512 in FIG. 25) opens at the same time at which common gate CG3 opens for the second time. Both common gate CG3 and first transfer gate TG3B remain open as necessary. After the signal charges pass through all stages, they end up in their respective storage nodes. Signal 2514 represents the control signal of memory nodes MEM[0A-3A, 0B-3B] which are constantly open during integration, signal 2515 represents the control signal of second transfer gates TX[0A-3A, 0B-2B], which are constantly closed during integration, signal 2516 represents the control signal of second transfer gate TX[3B] which is constantly open during integration, signal 2517 represents the control signal of reset transistors RST[0A-3A, 0B-2B] which are constantly closed during integration, signal 2518 represents the control signal of reset transistor RST[3B] which is constantly open during integration.

In the embodiment of FIG. 25, second transfer gate TX3B operates as an overflow gate OFG, without limiting the present embodiment in that regard. Alternatively, any other transfer gate may operate as an overflow gate OFG, or one or more transfer gates may operate as overflow gates OFG, or none of the transfer gates may operate as overflow gate OFG, or the like.

FIG. 26 shows a readout timing diagram of the cascaded TG-based N-tap pixel with memory nodes of FIG. 23, wherein second transfer gate TX3B operating as overflow gate OFG. During read-out, signal 2600 represents the control signal of common gates CG[i] (CG0 to CG3), which during read-out are closed, and signal 2601 represents the control signal of the first transfer gates TG[i], which during read-out are closed. Similarly, signals 2602 to 2608 represent the control signals of memory nodes MEM[0A-3A, 0B-2B] respectively, signal 2609 represent the control signal of memory node MEM[3B], signals 2610 to 2616 represent the control signals of second transfer gates TX[0A-3A, 0B-2B] respectively, signal 2617 represent the control signal of second transfer gate TX[3B] which operates as overflow gate OFG, signals 2618 to 2620 represent the control signals of reset transistors RST01, RST12, RST23, signal 2621 represent the control signals of reset transistor RST03 which corresponds to the overflow gate OFG, signals 2622 to 2624 represent the control signals of select transistors SEL01, SEL12, SEL23 respectively, and signal 2625 represent the control signal of select transistor SEL03 which corresponds to the overflow gate OFG. Optionally, SEL03 can be clocked in a similar fashion to the other control lines to improve on the symmetry of the operation.

TG-Based N-Tap Pixel with Cycling Memory Nodes

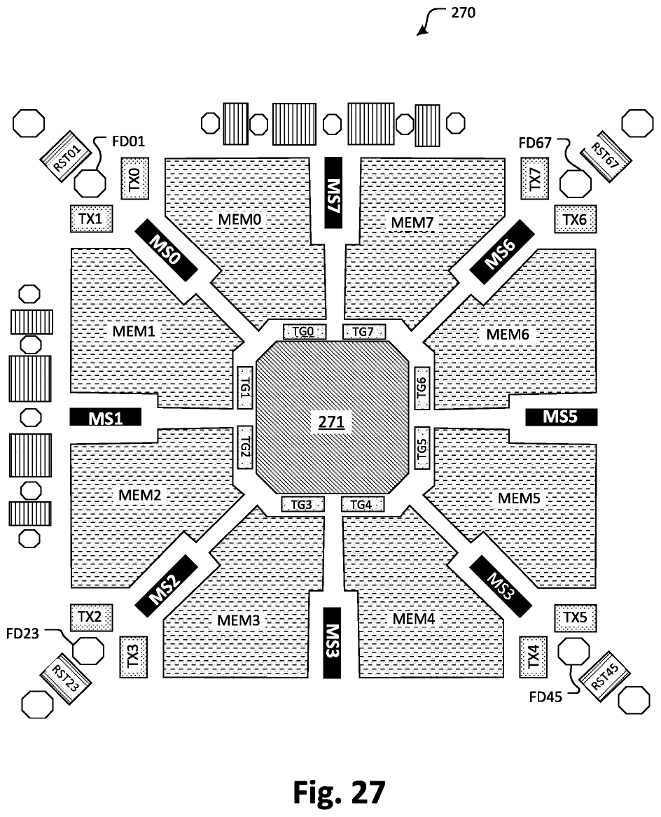

FIG. 27 schematically shows in top view an embodiment of a TG-based N-tap pixel with cycling memory nodes.

The TG-based N-tap pixel 270 with cycling memory nodes has a central photocollecting region 271, N=8 first transfer gates TG0 to TG7 that connect the central photocollecting region 271 to a plurality of memory nodes MEM, namely MEM0 to MEM7. Each of the first transfer gates TG0 to TG7 connects the photocollecting region 271, which is a pinned photodiode PPD, to a respective memory node MEM0 to MEM7. Each memory node MEM0 to MEM7 is implemented as intermediate storage node. In turn, each memory node MEM0 to MEM7 is connected, through a respective second transfer gate TX0 to TX7, to a floating diffusion region FD (white octagonal). Therefore, multiple memory nodes MEM are connected to the same floating diffusion region FD. For example, here, two memory nodes MEM are connect to the same floating diffusion region FD, namely memory nodes MEM0 and MEM1 are connect to the floating diffusion region FD01, memory nodes MEM2 and MEM3 are connect to the floating diffusion region FD23, memory nodes MEM4 and MEM5 are connect to the floating diffusion region FD45, and memory nodes MEM6 and MEM7 are connect to the floating diffusion region FD67. The floating diffusion region FD01 is connected on one side with two second transfer gates TX0 and TX1 and on another side with a reset transistor RST01. The floating diffusion region FD23 is connected on one side with two second transfer gates TX2 and TX3 and on another side with a reset transistor RST23. The floating diffusion region FD45 is connected on one side with two second transfer gates TX4 and TX5 and on another side with a reset transistor RST45. The floating diffusion region FD67 is connected on one side with two second transfer gates TX6 and TX7 and on another side with a reset transistor RST67. Similarly, each of the floating diffusion regions FD01, FD23, FD45, FD67 is connected to a relevant read-out stage, namely an amplifier AMP which is connected to a select transistor SEL. As described above, every two memory nodes MEM are connected to a shared read-out stage, resulting in N/2=4 read-out stages, R=4.

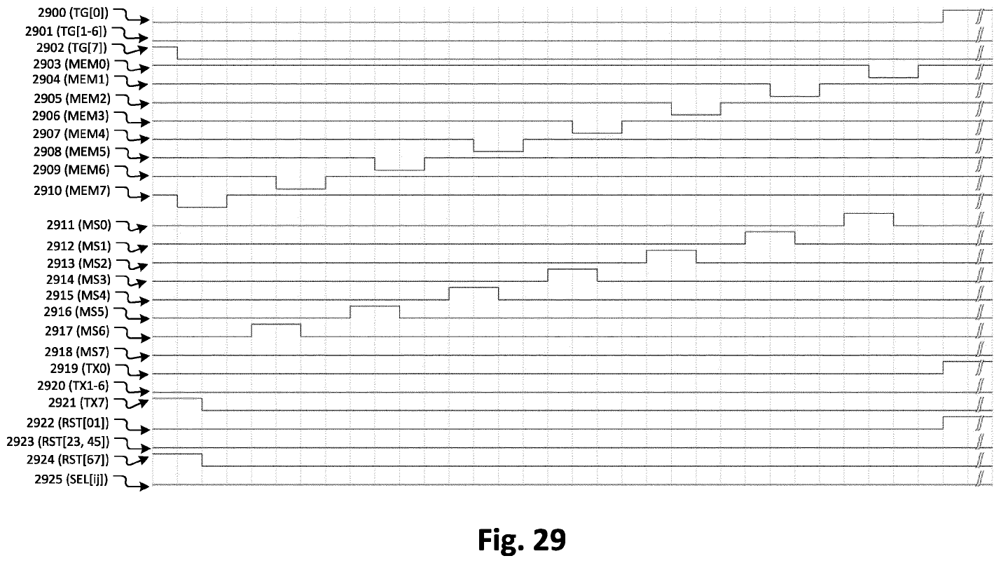

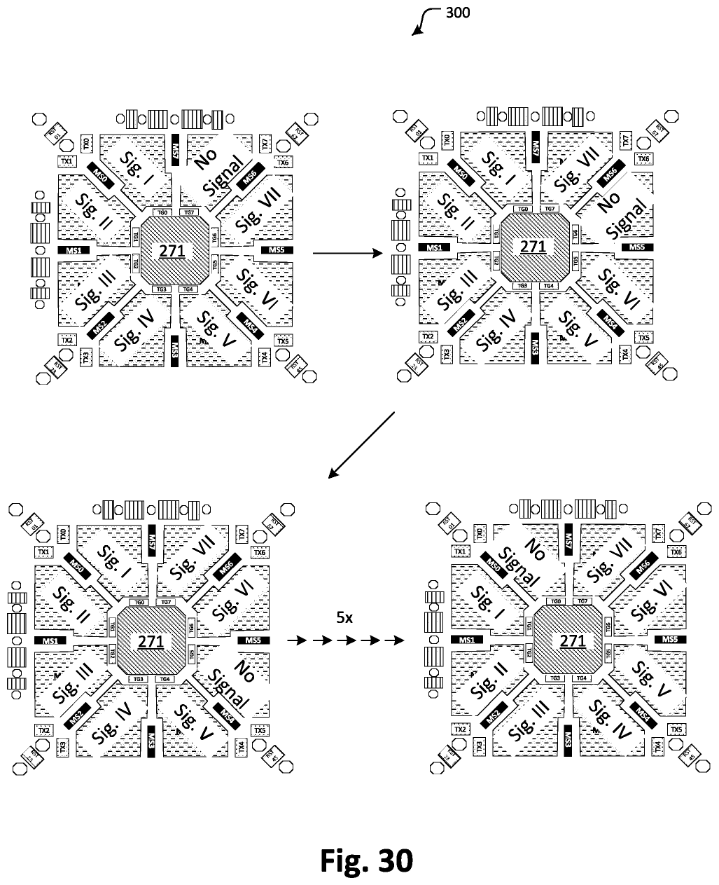

In the embodiment of FIG. 27, the TG-based N-tap pixel 270 is a TG-based N-tap pixel with cycling memory nodes MEM. The function to transfer charges from one memory node MEM to the next is realized by inserting memory shift gates MS in between adjacent memory nodes MEM. For example, here, memory shift gate MS0 is inserted between memory node MEM0 and memory node MEM1, such as charges to be transferred from MEM0 to MEM1 and vice versa. Similarly, memory shift gate MS1 is inserted between memory node MEM1 and memory node MEM2, such as charges to be transferred from MEM1 to MEM2 and vice versa. Memory shift gate MS2 is inserted between memory node MEM2 and memory node MEM3, such as charges to be transferred from MEM2 to MEM3 and vice versa. Memory shift gate MS3 is inserted between memory node MEM3 and memory node MEM4, such as charges to be transferred from MEM3 to MEM4 and vice versa. Memory shift gate MS4 is inserted between memory node MEM4 and memory node MEM5, such as charges to be transferred from MEM4 to MEM5 and vice versa. Memory shift gate MS5 is inserted between memory node MEM5 and memory node MEM6, such as charges to be transferred from MEM5 to MEM6 and vice versa. Memory shift gate MS6 is inserted between memory node MEM6 and memory node MEM7, such as charges to be transferred from MEM6 to MEM7 and vice versa. Memory shift gate MS7 is inserted between memory node MEM7 and memory node MEM0, such as charges to be transferred from MEM7 to MEM0 and vice versa. The representation of the above described rotating charges in the TG-based N-tap pixel 270 of FIG. 27, with one memory node counterclockwise, is shown with regard to FIG. 30 following timing diagram for memory cycle operation of FIG. 29.

In the embodiment of FIG. 27, the photocollecting region 271 is a pinned photodiode PPD, without limiting the present embodiment in that regard. Alternatively, the photocollecting region 271 may be a photogate or partially pinned photodiode, or the like. In the embodiment of FIG. 27, the TG-based N-tap pixel with cycling memory nodes is an 8-tap pixel (N=8), without limiting the present embodiment in that regard. Alternatively, the TG-based N-tap pixel may be a pixel with any number N, e.g. N=3, 4, 5, 6, 8, 9, 10, 11, 12 or more. One or more transfer gates among the transfer gates TG0 to TG7 may operate as overflow gate OFG to drain the ambient light. In a case where one or more transfer gates among the transfer gates TG0 to TG7 operate as only and permanently overflow gate OFG, the number of RST transistors and read-out stages AMP and SEL may be reduced by 1 for each transfer gate TG that operates permanently as overflow gate OFG in the case that no other taps are sharing the same read-out circuit. The transfer gates TG0 to TG7 including the overflow gate OFG are controlled according to the timing diagram as shown in FIG. 29 during memory cycling, wherein readout timing is not shown as it is similar to the timing in FIG. 17, and wherein integration timing is not shown as it is similar to FIG. 14.

In the embodiment of FIG. 27, the first transfer gates TG0 to TG7, the second transfer gates TX0 to TX7 and the overflow gate OFG may be implemented e.g. as transistors, and the memories MEM0 to MEM7 may for example be implemented as capacitors. By operating the transfer gates TG0 to TG7, depth information from incoming modulated light can be extracted.

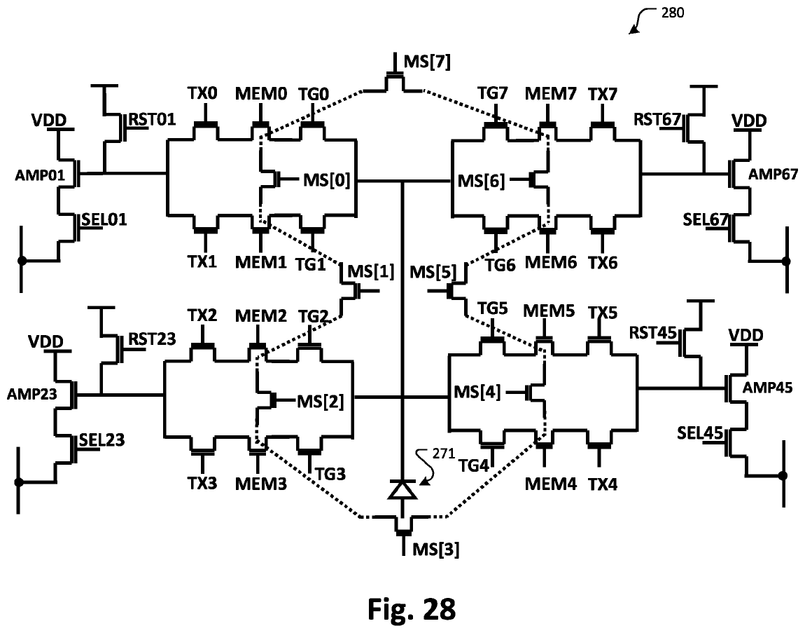

FIG. 28 schematically shows an embodiment of a schematic 280 of the TG-based N-tap pixel with cycling memory nodes of FIG. 27, wherein the number of taps is N=8, and the number of read-out stages is R=4. The central photocollecting region 271, which is a pinned photodiode PPD, collects incident photons and generates a photocurrent. The central photocollecting region 271 is connected to first transfer gates TG0 to TG7, each first transfer gate TG0 to TG7 being related to a respective tap of the TG-based N-tap pixel. By opening one of the transfer gates TG0 to TG7, the charge produced by central photocollecting region 271 is transferred onto a respective memory MEM0 to MEM7 where it is stored. The charges are transferred from one memory node MEM to the next through memory shift gates MS which are located in between adjacent memory nodes MEM. The function of charge transferring between the memory nodes MEM through the memory shift gates MS is represented by the diagonal dashed lines that connect memory nodes MEM to the memory shift gates MS. During integration, all charges are stored in the memory nodes MEM. During readout, second transfer gates TX0 to TX7 are closed. As a first step, the floating diffusion regions FD are reset and their levels read-out. This read-out gives the noise level of the reset transistors RST on the floating diffusion regions FD. As a next step, charges are transferred from R MEM nodes, to floating diffusion regions FD through second transfer gates TX0 to TX7. Then, floating diffusion levels are read-out again. The RST noise levels can then be subtracted from the actual signal levels to get a reset noise-free signal. This process of reading out reset level and signal level is repeated N/R times until all MEM node charges are read-out. The reset transistors RST01, RST23, RST45, RST67 are provided to reset the pixel. The floating diffusion level is reset through reset transistors RST01, RST23, RST45, RST67, preparing the pixel for the next integration period.

In the embodiment of FIG. 28, N=8, R=4, therefore R MEM nodes equal to 4 MEM nodes. For example, the charges which are stored in MEM0, MEM2, MEM4 and MEM6 are transferred to floating diffusion region FD01, FD23, FD45, FD67 respectively through second transfer gates TX0, TX2, TX4 and TX6 respectively. By opening the respective second transfer gate TX0, TX2, TX4 and TX6, the charge collected onto the memory nodes MEM0, MEM2, MEM4 and MEM6 is transferred to amplifier AMP0, AMP2, AMP4 and AMP6. A signal representative of the charges in FD01, FD23, FD45 and FD67 is transferred to select transistor SEL01, SEL23, SEL45, SEL67 to read out the amplified signal on a read-out line. A reset transistor RST01, RST23, RST45, RST67 is provided to reset the pixel. As described above, the charges are transferred from one memory node MEM to the next through memory shift gates MS being located in between adjacent memory nodes MEM, which may result to mismatch between taps reduction.

FIG. 29 shows a timing diagram for memory cycle operation of the TG-based N-tap pixel with cycling memory nodes of FIG. 27, wherein transfer gate TG7 operates as overflow gate OFG. In this embodiment, the timing diagram shows the function of cycling the charges from one memory node MEM to the next one. Signal 2900 represent the control signal of first transfer gate TG0, signal 2901 represent the control signal of first transfer gates TG[0-6] and signal 2902 represent the control signal of first transfer gate TG7, which operates as overflow gate OFG in the embodiment of FIG. 29. As control signals 2903 to 2910 show, memory nodes MEM6 to MEM0 close one after the other for a predetermined period. The charges are transfer through memory shifts MS7 to MS0, which open one after the other as shown their respective control signals 2911 to 2917. After shifting all seven signals i.e. TG[0-6] one MEM node counter clockwise, e.g. TG0 takes over the role of overflow gate OFG function and it no longer contains a signal.

In the embodiment of FIG. 29, first transfer gate TG7 operates as an overflow gate OFG, without limiting the present embodiment in that regard. Alternatively, any other transfer gate TG may operate as an overflow gate OFG, or none of the transfer gates TG of the pixel 270 may operate as an overflow gate OFG.

FIG. 30 schematically shows an embodiment of a conceptual representation 300 for rotating charges in the TG-based N-tap pixel with cycling memory nodes of FIG. 27, wherein one node counterclockwise, following the timing diagram of FIG. 29 above.

During the integration period, as a first step, all memory nodes MEM and central photocollecting region 271 are reset. As a second step, tap7, which is related to first and second transfer gates TG7 and TX7 and respective reset transistor RST, is assigned to operate as overflow gate OFG. As a third step, the first and second transfer gates TG7 and TX7 and respective reset transistor RST open (turns-on) to drain ambient light until the next sub-integration. As a fourth step, the overflow gate OFG closes (turns-off) and sequentially toggle each other first transfer gate TG to capture the depth information. As a fifth step, all transfer gates including the overflow gate are turned-off and as a sixth step, all charges are rotated counter-clockwise as shown in FIG. 29 above. As a seventh step, the tap, being related to respective first and second transfer gates TG, TX and reset transistor RST, that is adjacent counter clockwise to current overflow gate OFG is assigned to operate as overflow gate OFG, and thus, it no longer contains a signal. As an eighth step, the timing control for each first and second transfer gate TG and TX and respective reset transistor RST is updated, so that the accumulated signal on each MEM, on each tap, has consistent delay with respect to laser pulse. As a ninth step, steps three to eight are repeated seven times to have a total amount of eight sub-exposures. Optionally, steps two to nine may be repeated any integer amount of times.

In the embodiment of FIG. 27 to 30, each signal's exposure time is divided equally over each tap such that mismatch related to the pixel's collection and storage nodes may be reduced. Read-out timing is identical to read-out timing of pixel 150 with regard to FIG. 15. Optionally, mismatch related to the read-out portion may be reduced by sequentially transferring the signals from each intermediate storage node to a common read-out node. This may trade mismatch and accuracy with read-out speed (fps).

It should be noted that other implementations for realizing the memory cycling are also possible, such as CCD-like MEM (1.5 phase/2phase/ . . . ), and the like. For example, CCD-like MEM structures may allow to utilize all taps as signal integrators, but due to larger area requirements for CCD-memory compared to MS gate, the QSAT of each tap may decrease i.e. less space available for each MEM node.

Cascaded TG-Based NTAP Pixel with Cycling Memory Nodes

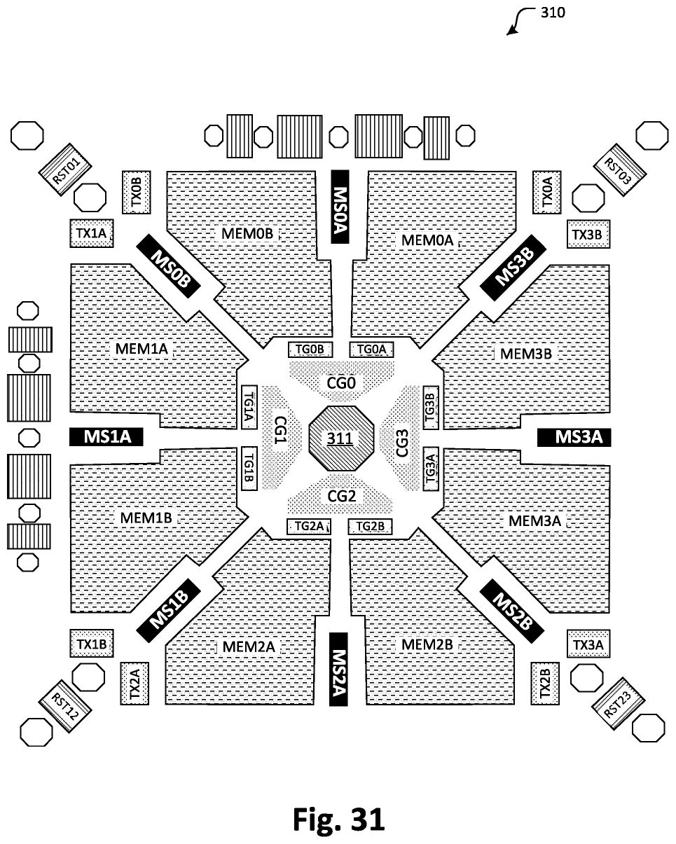

FIG. 31 schematically shows in top view an embodiment of a cascaded TG-based N-tap pixel with cycling memory nodes, wherein S=2, N₁=4, N₂=2, R=4.

In the cascaded TG-based N-tap pixel 310, the number of taps is eight, N=8 taps, the number of read-out stages is four, R=4 read-out stages and the number of modulation stages is two, S=2 modulation stages with N₁=4, N₂=2, where Nₓ is the number of taps on each stage x connected to each previous stage's output.

The cascaded TG-based N-tap pixel 310 has a central photocollecting region 311 with eight taps, N=8. The 8 taps are separated in two groups, N₁, N₂, each group being related to a respective modulation stage x. The first group has 4 taps, N₁=4 and the second group has two taps, N₂=2 connected to each output of the first stage. The cascaded TG-based N-tap pixel 310 has four common gates CG0 to CG3 that connect the central photocollecting region 311, which is a pinned photodiode PPD, to eight first transfer gates TG0A, TG0B, TG1A, TG1B, TG2A, TG2B, TG3A, TG3B. Each first transfer gate TG0A, TG0B, TG1A, TG1B, TG2A, TG2B, TG3A, TG3B is related to a respective tap of the pixel. Here, common gate CG0 is directly connected to first transfer gates TG0A and TG0B, common gate CG1 is directly connected to first transfer gates TG1A and TG1B, common gate CG2 is directly connected to first transfer gates TG2A and TG2B, and common gate CG3 is directly connected to first transfer gates TG3A and TG3B. Each first transfer gate TG0A, TG0B, TG1A, TG1B, TG2A, TG2B, TG3A, TG3B is connected to a respective memory node MEM0A, MEM0B, MEM1A, MEM1B, MEM2A, MEM2B, MEM3A, MEM3B. Each memory node MEM is implemented as intermediate storage node. In the embodiment of FIG. 31, the N-tap pixel 310 is a cascaded TG-based N-tap pixel with cycling memory nodes MEM. The function to transfer charges from one memory node MEM to the next is realized by inserting memory shift gates MS in between adjacent memory nodes MEM, as described with regard to FIG. 27 above. In turn, each memory node MEM is connected, through a respective second transfer gate TX0A, TX0B, TX1A, TX1B, TX2A, TX2B, TX3A, TX3B, to a floating diffusion region FD (white octagonal). Therefore, two memory nodes MEM are connected to the same floating diffusion region FD.

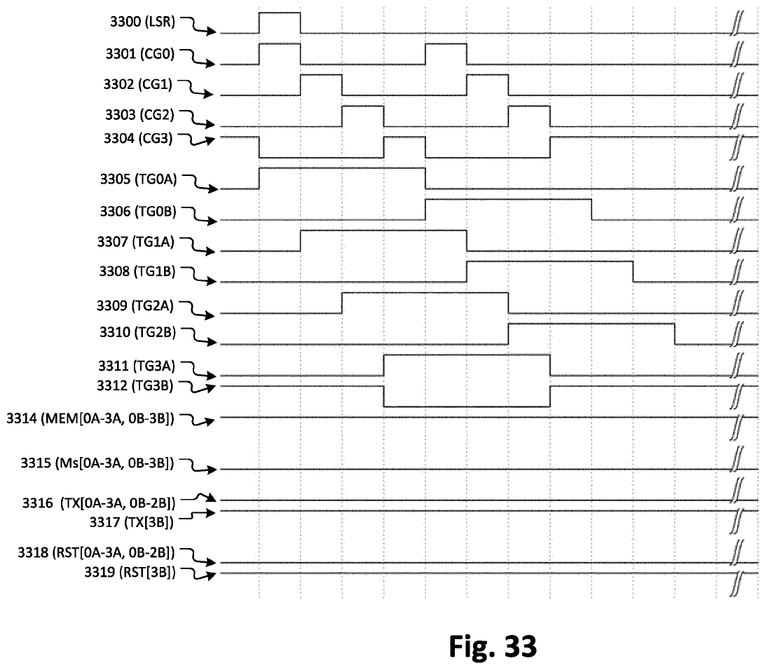

In the embodiment of FIG. 31, two second transfer gates TX are connected to the same floating diffusion region FD, as also described with reference to FIG. 23 above. Each floating diffusion region FD01, FD03, FD12, FD23 is also connected with a respective reset transistor RST01, RST03, RST12, RST23, as also described with reference to FIG. 23 above. Similarly, each of the floating diffusion regions FD01, FD03, FD12, FD23 is connected to a relevant read-out stage, namely an amplifier AMP which is connected to a select transistor SEL. Every two second transfer gates TX, and thus, every two first transfer gates TG are connected to a shared read-out stage, resulting in N/2=4 read-out stages, R=4. The timing diagram for memory cycle operation of the N-tap pixel 310 is shown in FIG. 33.

In the embodiment of FIG. 31, the photocollecting region 311 is a pinned photodiode PPD, without limiting the present embodiment in that regard. Alternatively, the photocollecting region 311 may be a photogate or partially pinned photodiode, or the like. In the embodiment of FIG. 31, the cascaded TG-based N-tap pixel with memory nodes is an 8-tap pixel (N=8), without limiting the present embodiment in that regard. Alternatively, the cascaded TG-based N-tap pixel may be a pixel with any number N, e.g. N=3, 4, 5, 6, 8, 9, 10, 11, 12 or more. The number of modulation stages is two, S=2 modulation stages, in the embodiment of FIG. 31, without limiting the present embodiment in that regard. The number of modulation stages may be any integer value.

In the embodiment of FIG. 31, one or more first transfer gates TG may operate as overflow gate OFG to drain the ambient light. In a case where one or more first transfer gates TG operate as overflow gate OFG, the number of RST transistors and read-out stages AMP and SEL may be reduced by 1 for each first transfer gates TG that operates permanently as overflow gate OFG, in the case that no other tap is sharing that read-out stage.

In the embodiment of FIG. 31, the first transfer gates TG, the second transfer gates TX and the overflow gate OFG may be implemented e.g. as transistors, and the memories nodes MEM may for example be implemented as capacitors. By operating the first transfer gates TG, depth information from incoming modulated light can be extracted.

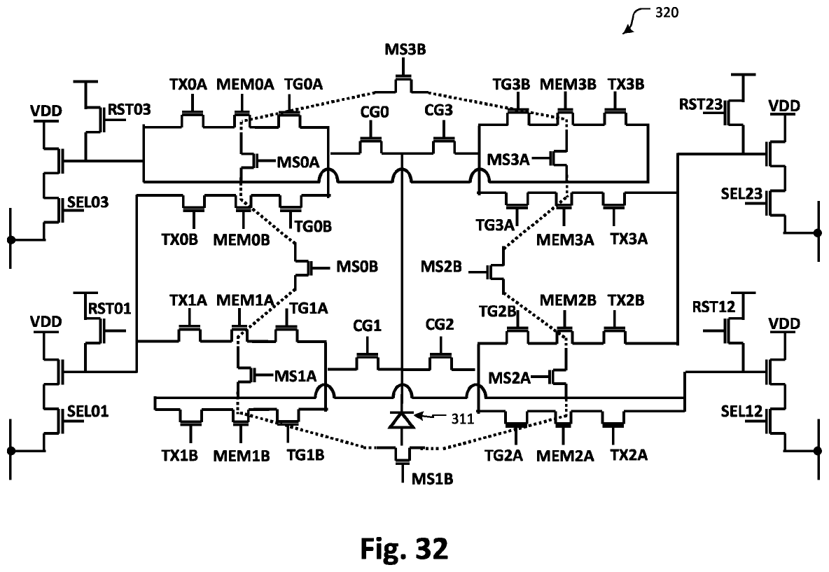

FIG. 32 schematically shows an embodiment of a schematic 320 of the TG-based N-tap pixel with cycling memory nodes of FIG. 31, wherein the number of taps is N=8, and the number of read-out stages is R=4. The schematic of pixel 310 represents a read-out circuit of the pixel 310. The central photocollecting region 231, which here is a pinned photodiode PPD, collects incident photons and generates a photocurrent. The central photocollecting region 231 is directly connected to common gates CG0 to CG3 which are directly connected to first transfer gates TG0A, TG0B, TG1A, TG1B, TG2A, TG2B, TG3A, TG3B, as described above. The generated photocurrent is transferred from the photocollecting region 231 to the common gates CG0 to CG3, and then to the first transfer gates TG0A, TG0B, TG1A, TG1B, TG2A, TG2B, TG3A, TG3B. By opening one of the first transfer gates TG0A, TG0B, TG1A, TG1B, TG2A, TG2B, TG3A, TG3B, the charge produced by photocollecting region 231 is transferred onto a respective memory MEM0A, MEM0B, MEM1A, MEM1B, MEM2A, MEM2B, MEM3A, MEM3B where it is stored. That is, during integration, all charges are stored in the memory nodes MEM. The charges are transferred from one memory node MEM to the next through memory shift gates MS which are located in between adjacent memory nodes MEM. The function of charge transferring between the memory nodes MEM through the memory shift gates MS is represented by the diagonal dashed lines that connect memory nodes MEM to the memory shift gates MS. During memory cycling operation, second transfer gates TX0A, TX0B, TX1A, TX1B, TX2A, TX2B, TX3A, TX3B are closed. The integration process of this embodiment is the same as the integration process described in the embodiments with regard to FIGS. 24 and 28 above.

In the embodiment of FIG. 28, N=8, R=4, therefore R MEM nodes equal to 4 MEM nodes. For example, the charges which are stored in MEM0, MEM2, MEM4 and MEM6 are transferred to floating diffusion region FD01, FD23, FD45, FD67 respectively through second transfer gates TX0, TX2, TX4 and TX6 respectively. By opening the respective second transfer gate TX0, TX2, TX4 and TX6, the charge collected onto the memory nodes MEM0, MEM2, MEM4 and MEM6 is transferred to amplifier AMP0, AMP2, AMP4 and AMP6. A signal representative of the charges in FD01, FD23, FD45 and FD67 is transferred to select transistor SEL01, SEL23, SEL45, SEL67 to read out the amplified signal on a read-out line. A reset transistor RST01, RST23, RST45, RST67 is provided to reset the pixel. As described above, the charges are transferred from one memory node MEM to the next through memory shift gates MS being located in between adjacent memory nodes MEM, which may result to mismatch between taps reduction.

FIG. 33 shows a timing diagram during integration of the cascaded TG-based N-tap pixel with memory nodes of FIG. 31, wherein transfer gate TX3B operates as overflow gate OFG. A laser pulse, having an LSR signal 3300, for illuminating a scene is activated for a predefined illumination period. Common gates CG0 to CG3 are controlled by respective control signals 3301 to 3304. According to this specific timing diagram of FIG. 33, as shown the control signals 3301 to 3304, each of the common gates CG0 to CG3 of the cascaded TG-based N-tap pixel 310 with cycling memory nodes of FIG. 33 opens one after the other for a predetermined activation time window. As shown the control signals 3305, 3307, 3309, 3311 of transfer gates TG0A, TG1A, TG2A, TG3A respectively, the first transfer gates TG0A, TG1A, TG2A, TG3A open one after the other for a predetermined activation time window of a window length that is four times the previous stage CG on period. Each first transfer gate TG0A, TG1A, TG2A, TG3A opens at the same time with the respective common gates CG0 to CG3. The common gates CG0 to CG3 open once more one after the other, wherein common gate CG0 opens again at a time at which the activation period of the common gate CG3 ends. As shown the control signals 3306, 3308, 3310 of first transfer gates TG0B, TG1B, TG2B respectively, the transfer gates TG0B, TG1B, TG2B open one after the other for a predetermined activation time window of a window length that is four times the previous stage CG on period. Each first transfer gate TG0B, TG1B, TG2B opens at the same time at which the respective common gates CG0 to CG2 open for the second time. Since the first transfer gate TG3B operates as an overflow gate OFG, first transfer gate TG3B (see control signal 3312 in FIG. 33) opens at the same time at which common gate CG3 opens for the second time. Both common gate CG3 and first transfer gate TG3B remain open as necessary. After the signal charges pass through all stages, they end up in their respective storage nodes. Signal 3314 represents the control signal of memory nodes MEM[0A-3A, 0B-3B] which are constantly open during integration, signal 3315 represents the control signal of memory shifts MS[0A-3A, 0B-3B], signal 3316 represents the control signal of second transfer gates TX[0A-3A, 0B-2B], which are constantly closed during integration, signal 3317 represents the control signal of second transfer gate TX[3B] which is constantly closed during integration, signal 3318 represents the control signal of reset transistors RST[0A-3A, 0B-2B] which are constantly closed during integration, and signal 3319 represents the control signal of reset transistor RST[3B] which is constantly open during integration.

In the embodiment of FIG. 33, second transfer gate TX3B operates as an overflow gate OFG, without limiting the present embodiment in that regard. Alternatively, any other transfer gate may operate as an overflow gate OFG, or one or more transfer gates may operate as overflow gates OFG, or none of the transfer gates may operate as overflow gate OFG, or the like.

Is should be noted that in the embodiment of FIG. 33, multiple sub-exposures may be used, and shifting the accumulated charges to an adjacent MEM node before starting the next sub-exposure may be performed. Read-out timing diagram of cascaded TG-based N-tap pixel with cycling memory nodes of FIG. 31 is identical to read-out timing diagram of pixel 150 (see FIG. 15).

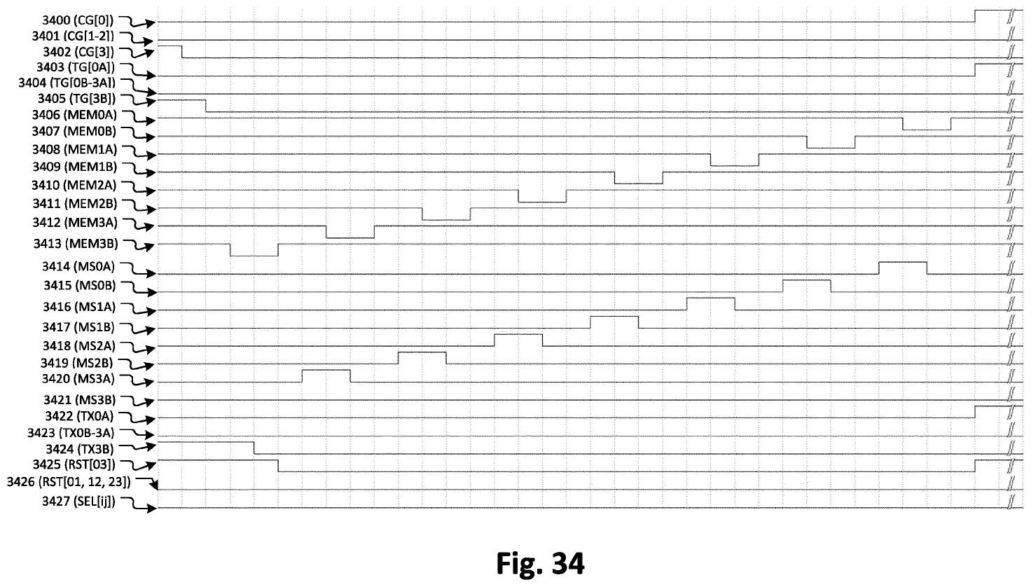

FIG. 34 shows a timing diagram for memory cycle operation of the cascaded TG-based N-tap pixel with cycling memory nodes of FIG. 31, wherein transfer gate TX3B operates as overflow gate OFG. This timing diagram is an example of memory cycle described with regard to FIGS. 33 and 34 above. In this embodiment, the timing diagram shows the function of cycling the charges from one memory node MEM to the next one. Signal 3400 represent the control signal of common gate CG0, signal 3401 represent the control signal of common gates CG[1-2], signal 3402 represent the control signal of common gate CG3. Signal 3403 represent the control signal of first transfer gate TG0A, signal 3404 represent the control signal of first transfer gates TG[0B-3A] and signal 3405 represent the control signal of first transfer gate TG3B, which operates as overflow gate OFG in the embodiment of FIG. 31. As control signals 3406 to 3413 show, memory nodes MEM3B to MEM0A open one after the other for a predetermined period. The charges are transfer through memory shifts MS3B to MS0A, which open one after the other as shown their respective control signals 3414 to 3421. Signal 3422 represent the control signal of second transfer gate TX0A, signal 3423 represent the control signal of second transfer gates TX[0B-3A] and signal 3424 represent the control signal of second transfer gate TX3B. Signal 3425 represent the control signal of reset transistor RST03, signal 3426 represent the control signal of reset transistors RST[01, 12, 23] and signal 3427 represent the control signal of select transistors SEL[0A-3A]. In the timing diagram of FIG. 34 for memory cycle operation for the pixel 310 of FIG. 31, tap 3B is operated as overflow gate OFG before the cycle. After shifting all seven signals i.e. TG[0A-3A] one MEM node counter clockwise, e.g. TG0A takes over the role of overflow gate OFG function and it no longer contains a signal.

TG-Based N-Tap Pixel without Central Photocollecting Region

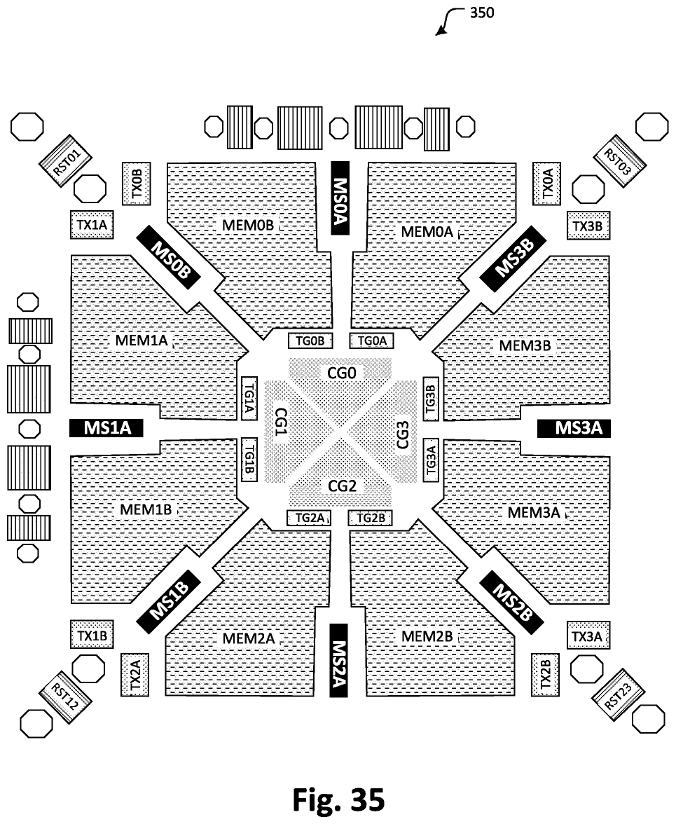

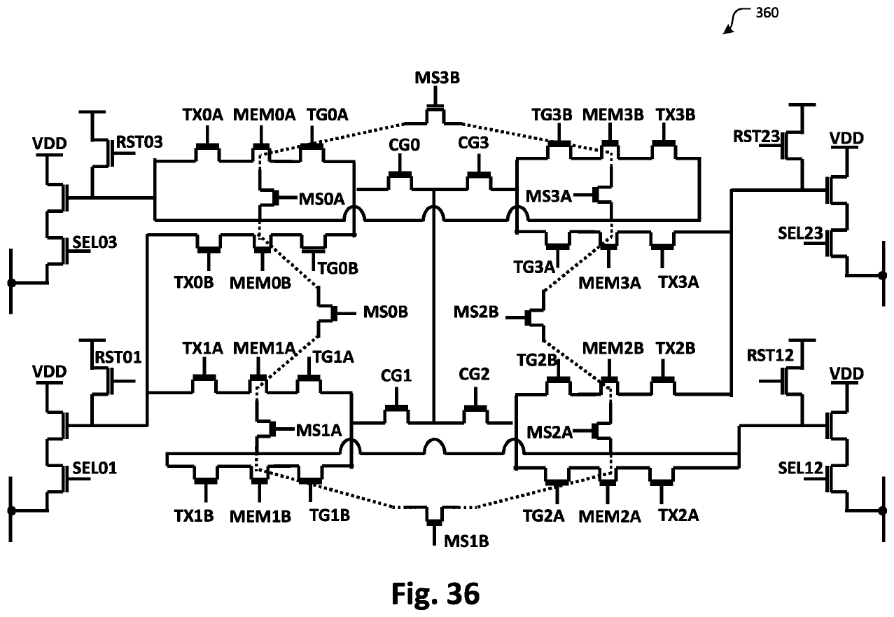

FIG. 35 schematically shows in top view an embodiment of a cascaded TG-based N-tap pixel without central photocollecting region, wherein S=2, N₁=4, N₂=2, R=4.

The cascaded TG-based N-tap pixel 350 of FIG. 35 is formed such as the cascaded TG-based N-tap pixel with cycling memory nodes (see 310 in FIG. 31), wherein the central photocollecting region is excluded. In the cascaded TG-based N-tap pixel 350, the number of taps is eight, N=8 taps, the number of read-out stages is four, R=4 read-out stages and the number of modulation stages is two, S=2 modulation stages with N₁=4, N₂=2, where Nₓ is the number of taps on each stage x which are connected to each previous stage's output. The 8 taps are separated in two groups, N₁, N₂, each group being related to a respective modulation stage x. The first group has 4 gates, N₁=4 and the second group has two gates, N₂=2.

The cascaded TG-based N-tap pixel 350 of FIG. 35 has four common gates CG0 to CG3 that are directly connected to first transfer gates TG[0A-3B], as described in more detail in FIG. 31 above. The cascaded TG-based N-tap pixel 350 of FIG. 35 does not have a central photocollecting region to collect the charges. In this manner, the charges are directly directed to first modulation step via auxiliary electrodes, namely common gates CG0 to CG3. Each first transfer gate TG[0A-3B] is connected to a respective memory node MEM[0A-3B] and each memory node MEM is implemented as intermediate storage node, as described in more detail in FIG. 31 above. The function of transferring charges from one memory node MEM to the next is realized by inserting memory shift gates MS in between adjacent memory nodes MEM, as described in more detail in FIG. 31 above. In turn, each memory node MEM is connected, through a respective second transfer gate TX[0A-3B], to a floating diffusion region FD (white octagonal). Therefore, two memory nodes MEM are connected to the same floating diffusion region FD.

In the embodiment of FIG. 35, the auxiliary gates are realized by surface or buried gate elements, such as the common gates CG0 to CG3. The four auxiliary gates are used as first-stage modulator technology, replacing the central photocollector region, which may result to a reduced pixel area and to a reduced total electron path length.

FIG. 36 schematically shows an embodiment of a schematic 360 of the TG-based N-tap pixel with cycling memory nodes and without central photocollecting region, wherein the number of taps is N=8, and the number of read-out stages is R=4. The schematic 360 of FIG. 36 and its function is the same as the schematic 320 of FIG. 32 without having the central photocollecting region.

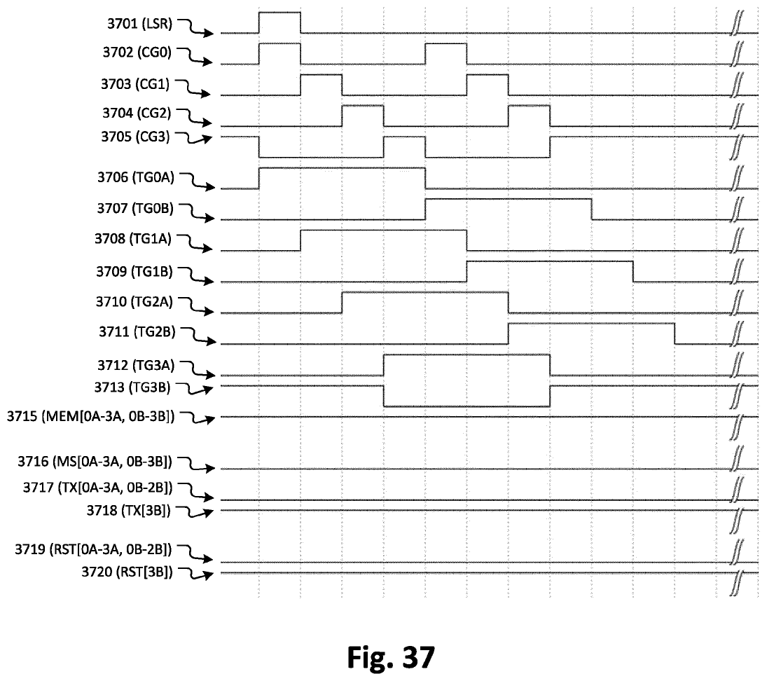

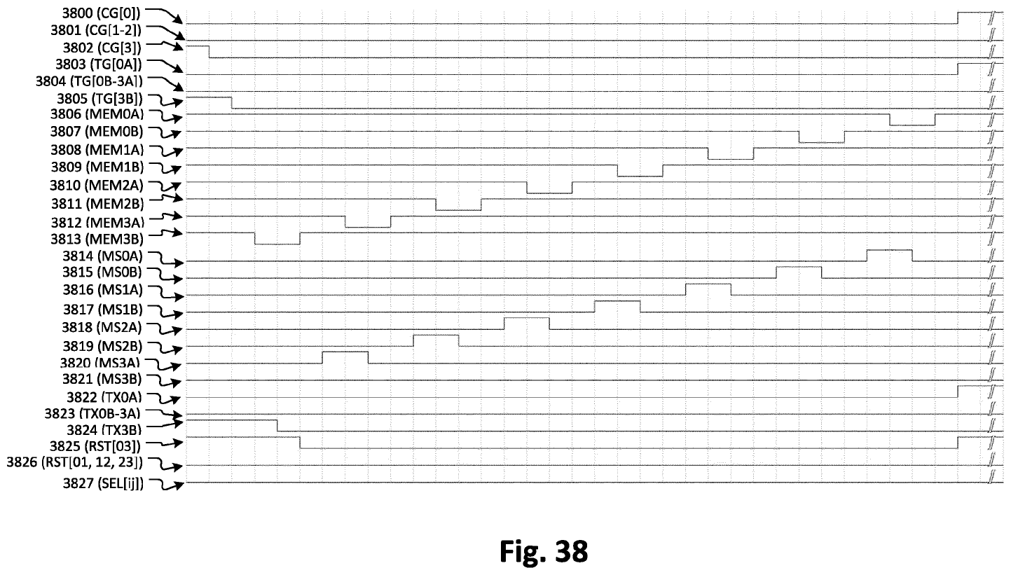

FIG. 37 shows a timing diagram during integration of the cascaded TG-based N-tap pixel with cycling memory nodes and without central photocollecting region of FIG. 35, wherein transfer gate TX3B operates as overflow gate OFG, and FIG. 38 shows a timing diagram for memory cycle operation of the cascaded TG-based N-tap pixel with cycling memory nodes and without central photocollecting region of FIG. 35, wherein transfer gate TX3B operates as overflow gate OFG. Operation, schematics and timing diagrams for the cascaded TG-based N-tap pixel with memory nodes and without central photocollecting region of FIG. 35 is the same as for the cascaded TG-based N-tap pixel with cycling memory nodes of FIG. 31 (see FIGS. 32, 33 and 34). The timings and levels of the signals described with regard to FIGS. 32, 33 and 34 and thus, to FIGS. 36, 37 and 38, respectively, are not limiting the present disclosure in that regard. The timings may be updated to optimize the charge collection. For example, the use of intermediate bias levels may be implemented for charge collection improvement.

Cascaded TG-Based N-Tap Pixel with First-Stage CAPD Modulators

FIG. 39 schematically shows in top view an embodiment of a cascaded TG-based N-tap pixel with cycling memory nodes and with first-stage CAPD modulators, wherein S=2, N₁=4, N₂=2, R=4. With the first stage CAPD modulators being located at the pixel boundary, mirrored pixel placement can be used to avoid conflicts on first stage modulator bias between neighbouring pixels.

In the cascaded TG-based N-tap pixel 390, the number of taps is eight, N=8 taps, the number of read-out stages is four, R=4 read-out stages and the number of modulation stages is two, S=2 modulation stages with N₁=4, N₂=2, where Nₓ is the number of taps on each stage x. The 8 taps are separated in two groups, N₁, N₂, each group being related to a respective modulation stage x. The first modulation stage has 4 mixing elements, N₁=4 and the second modulation stage has two mixing elements, N₂=2.

The cascaded TG-based N-tap pixel 390 has N₁=4 CAPD modulators in the first modulation stage, namely MIX0 to MIX3. Each CAPD modulator of the MIX0 to MIX3 direct the charges to their related N₁=4 initial collector regions, namely CC0 to CC3. Each of the initial collector regions CC0 to CC3 can be a pinned photodiode (PPD), a p-type pinned photodiode (PPPD), a photogate (PG), etc. The central collector regions CC0 to CC3 serve as intermediate nodes where the charges pass through onwards to the next modulation stage, namely the second modulation stage. The second modulation stage has N₂=2 modulators related to each CAPD modulator of the first modulation stage. The second modulation stage modulators are first transfer gates TG0A to TG3B, wherein MIX0 and CC0 are directly connected to first transfer gates TG0A and TG0B, MIX1 and CC1 are directly connected to first transfer gates TG1A and TG1B, MIX2 and CC2 are directly connected to first transfer gates TG2A and TG2B, and MIX3 and CC3 are directly connected to first transfer gates TG3A and TG3B. Once the charges have passed through the second stage modulators TG0A to TG3B, operations on the charges are similar to pixel structures with cycling memory nodes of FIGS. 27, 31 and 35 described in detail above.

Each first transfer gate TG[0A-3B] is connected to a respective memory node MEM[0A-3B] and each memory node MEM is implemented as intermediate storage node, as described in more detail in FIG. 31 above. The function of transferring charges from one memory node MEM to the next is realized by inserting memory shift gates MS in between adjacent memory nodes MEM, as described in more detail in FIG. 31 above. In turn, each memory node MEM is connected, through a respective second transfer gate TX[0A-3B], to a floating diffusion region FD (white octagonal). Therefore, two memory nodes MEM are connected to the same floating diffusion region FD.

In the embodiment of FIG. 39, the modulation stages are two, S=2, without limiting the present embodiment in that regard. Alternatively, more than two modulation stages may be formed, wherein second and higher stage modulators include for example, TG, vertical gate (VG), and the like.

FIG. 40 schematically shows an embodiment of a schematic 400 of the TG-based N-tap pixel with cycling memory nodes and with first-stage CAPD modulators of FIG. 39. As described in FIG. 39, the initial collector regions CC0 to CC3 pass the charges from the first stage modulators to the second stage modulators, namely form CAPD modulators MIX0 to MIX3 to the transfer gates TG0A to TG3B.

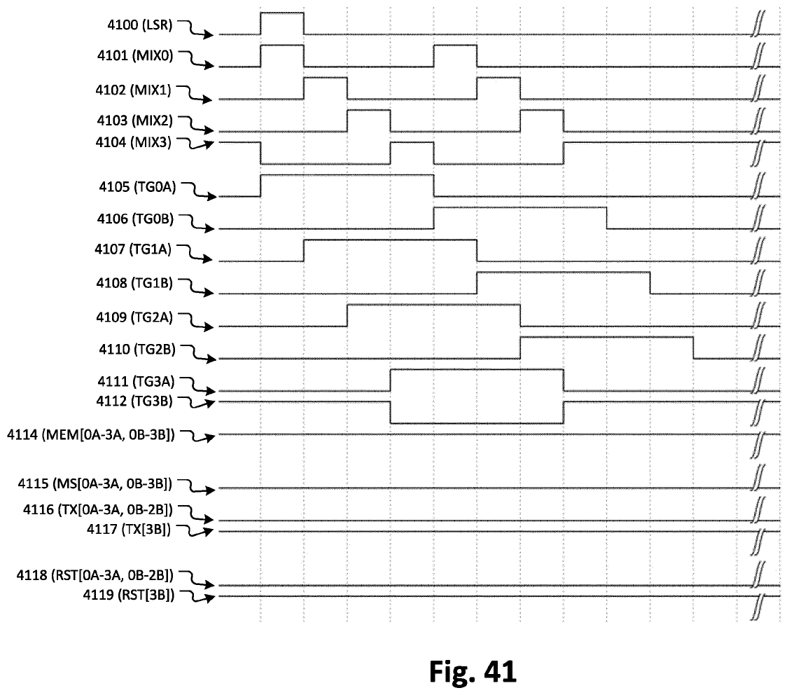

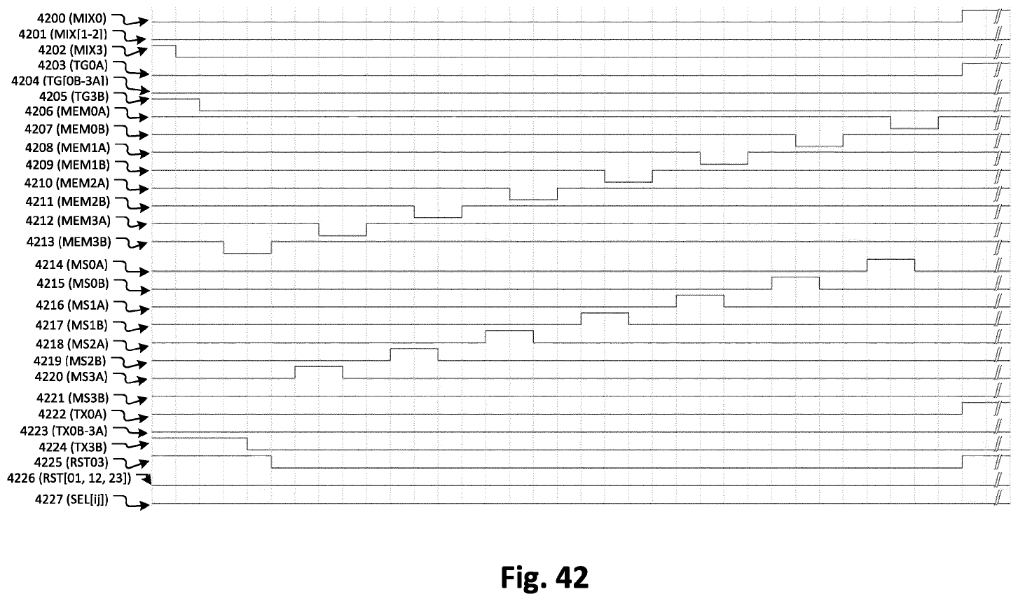

FIG. 41 shows a timing diagram during integration of the cascaded TG-based N-tap pixel with cycling memory nodes and with first-stage CAPD modulators of FIG. 39, wherein transfer gate TX3B operates as overflow gate OFG, and FIG. 42 shows a timing diagram for memory cycle operation of the cascaded TG-based N-tap pixel with cycling memory nodes and with first-stage CAPD modulators of FIG. 39, wherein transfer gate TX3B operates as overflow gate OFG. Operation, schematics and timing diagrams for the cascaded TG-based N-tap pixel with memory nodes and with first-stage CAPD modulators of FIG. 39 is the same as for the cascaded TG-based N-tap pixel with cycling memory nodes of FIG. 31 (see FIGS. 32, 33 and 34), wherein common gates CG0 to CG3 of FIGS. 31, 32, 33 and 34 are replaced in the embodiment of FIGS. 39, 40, 41 and 42 by CAPD modulators MIX0 to MIX3. The timings and levels of the signals described with regard to FIGS. 32, 33 and 34 and thus, to FIGS. 40, 41 and 42, respectively, are not limiting the present disclosure in that regard. The timings may be updated to optimize the charge collection. For example, the use of intermediate bias levels may be implemented for charge collection improvement.

Cascaded TG-Based NTAP Pixel with First-Stage CAPD and Photogates

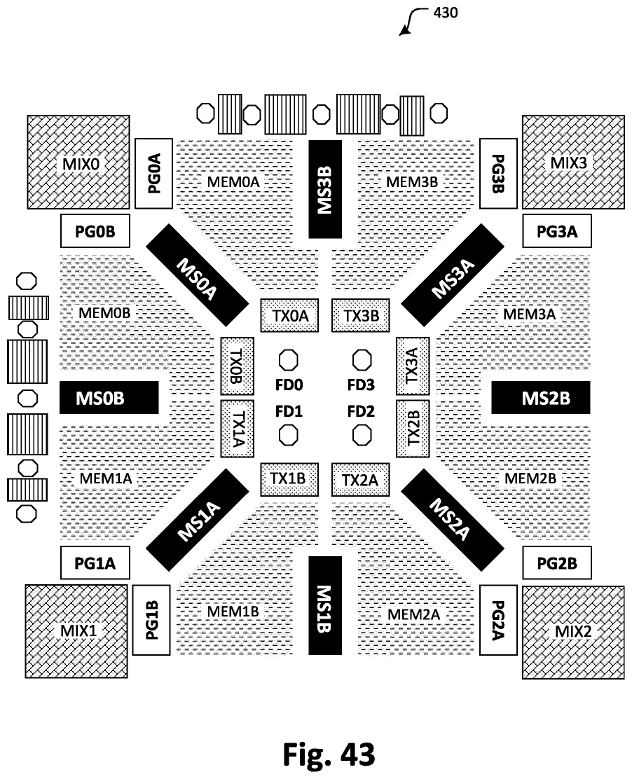

FIG. 43 schematically shows in top view an embodiment of a cascaded TG-based N-tap pixel with cycling memory nodes and with first-stage CAPD modulators and photogates, wherein S=2, N₁=4, N₂=2, R=4. With the first stage CAPD modulators being located at the pixel boundary, mirrored pixel placement may be used to avoid conflicts on first stage modulator bias between neighbouring pixels.

In the cascaded TG-based N-tap pixel 430, the number of taps is eight, N=8 taps, the number of read-out stages is four, R=4 read-out stages and the number of modulation stages is two, S=2 modulation stages with N₁=4, N₂=2, where Nₓ is the number of taps on each stage x connected to each output of the previous stage. The 8 taps are separated in two groups, N₁, N₂, each group being related to a respective modulation stage x. The first modulation stage has 4 mixing elements, N₁=4 and the second modulation stage has two gates, N₂=2 connected to each output of the previous stage.

The cascaded TG-based N-tap pixel 430 has N₁=4 CAPD modulators in the first modulation stage, namely MIX0 to MIX3, which do not require central collector to operate as the CAPD modulators MIX0 to MIX3 of FIG. 39. CAPD modulators MIX0 to MIX3 direct the charges to photogates PG0A to PG3B. Each CAPD modulator MIX directs the charges to two respective photogates PG. For example, CAPD modulator MIX0 directs the charges to photogates PG0A and PG0B, CAPD modulator MIX1 directs the charges to photogates PG1A and PG1B, CAPD modulator MIX2 directs the charges to photogates PG2A and PG2B, and CAPD modulator MIX3 directs the charges to photogates PG3A and PG3B.

In the embodiment of FIG. 43, the initial collector regions CCs and the CAPD modulators MIXs of FIG. 39 are replaced by CAPD modulators MIX0 to MIX3, and the photogates PG0A to PG3B which do not require central collector to operate of FIG. 43 function as the pinned photodiodes (PPDs) and the first transfer gates TG0A to TG3B of FIG. 39, which may result to an improved speed of the second modulation stage, namely the modulation stage of photogates PG0A to PG3B.

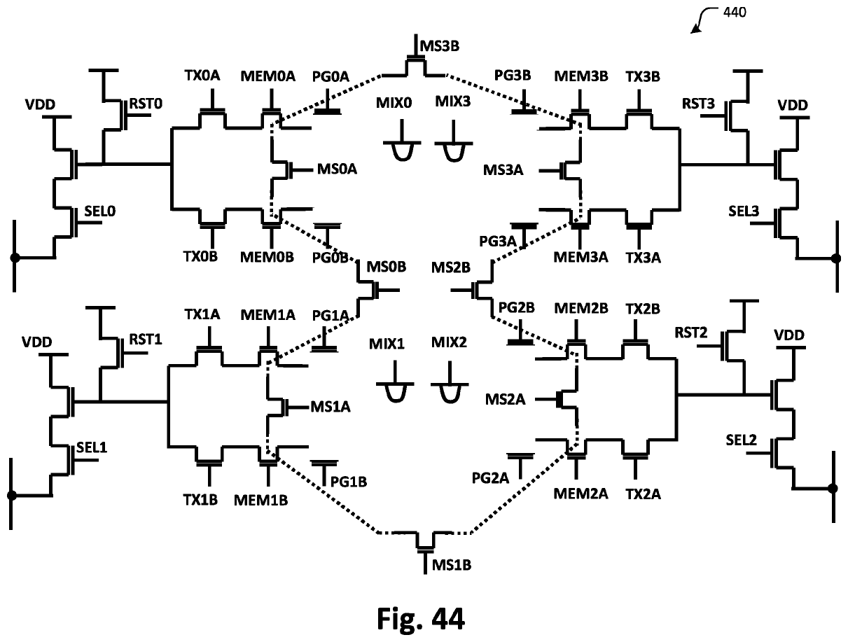

FIG. 44 schematically shows an embodiment of a schematic 440 of the TG-based N-tap pixel with cycling memory nodes and with first-stage CAPD modulators and photogates of FIG. 43. As described in FIG. 43, the charges pass from the first stage modulators to the second stage modulators, namely form CAPD modulators MIX0 to MIX3 to photogates PG0A to PG3B.

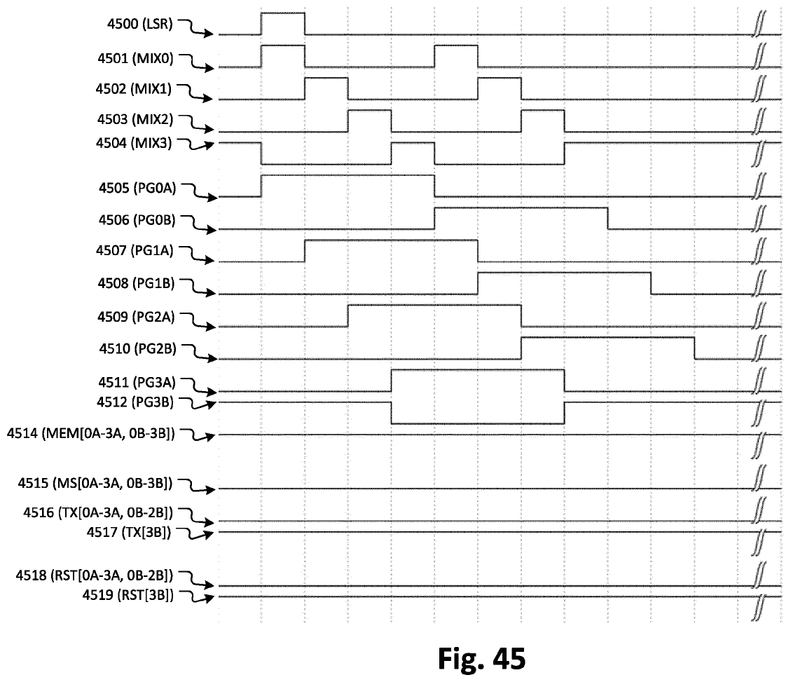

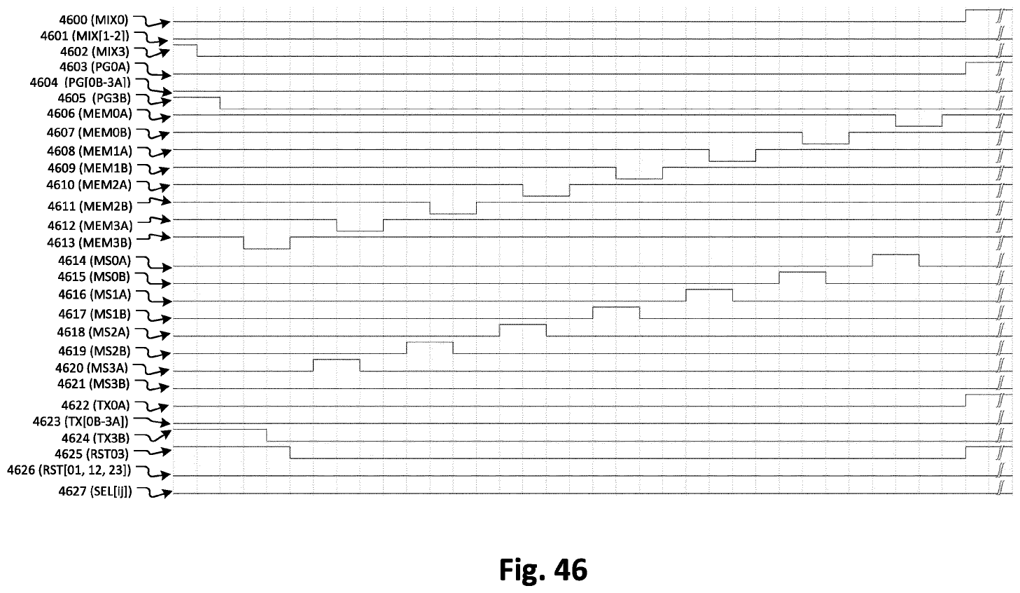

FIG. 45 shows a timing diagram during integration of the cascaded TG-based N-tap pixel with cycling memory nodes and with first-stage CAPD modulators and photogates of FIG. 43, wherein transfer gate TX3B operates as overflow gate OFG, and FIG. 46 shows a timing diagram for memory cycle operation of the cascaded TG-based N-tap pixel with cycling memory nodes and with first-stage CAPD modulators and photogates of FIG. 43, wherein transfer gate TX3B operates as overflow gate OFG. Operation, schematics and timing diagrams for the cascaded TG-based N-tap pixel with memory nodes and with first-stage CAPD modulators and photogates of FIG. 43 is the same as for the cascaded TG-based N-tap pixel with cycling memory nodes and with first-stage CAPD modulators of FIG. 39 (see FIGS. 40, 41 and 42), wherein initial collector regions CC and transfer gates TG0A to TG3B of FIGS. 39, 40, 41 and 42 are replaced in the embodiment of FIGS. 43, 44, 45 and 46 by photogates PG0A to PG3B. The timings and levels of the signals described with regard to FIGS. 40, 41 and 42 and thus, to FIGS. 44, 45 and 46, respectively, are not limiting the present disclosure in that regard. The timings may be updated to optimize the charge collection. For example, the use of intermediate bias levels may be implemented for charge collection improvement.

### Implementation

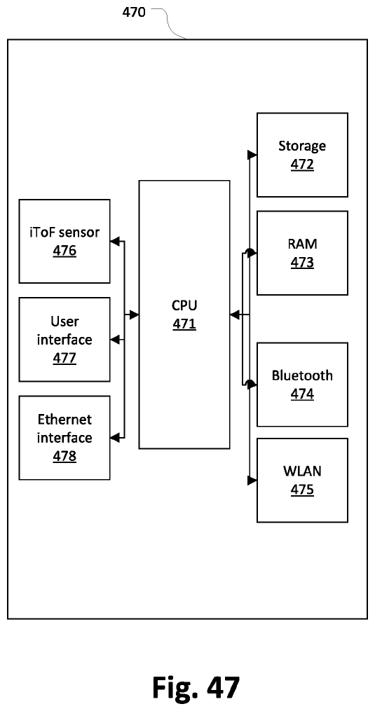

FIG. 47 schematically describes an embodiment of an iToF device that can implement the processes performing depth measurement with an N-tap pixel. The electronic device 470 may further implement all other processes of a standard iToF/spot ToF system. The electronic device 470 comprises a CPU 471 as processor. The electronic device 470 further comprises an iToF sensor 476 connected to the processor 471. The processor 471 may for example implement performing a depth measurement of a N-tap pixel. The electronic device 470 further comprises a user interface 477 that is connected to the processor 471. This user interface 477 acts as a man-machine interface and enables a dialogue between an administrator and the electronic system. For example, an administrator may make configurations to the system using this user interface 477. The electronic device 470 further comprises a Bluetooth interface 474, a WLAN interface 475, and an Ethernet interface 478. These units 474, 475 and 478 act as I/O interfaces for data communication with external devices. For example, video cameras with Ethernet, WLAN or Bluetooth connection may be coupled to the processor 471 via these interfaces 474, 475, and 478. The electronic device 470 further comprises a data storage 472, and a data memory 473 (here a RAM). The data storage 472 is arranged as a long-term storage, e.g. for storing parameters for one or more use-cases, for recording iToF sensor data obtained from the iToF sensor 476 the like. The data memory 473 is arranged to temporarily store or cache data or computer instructions for processing by the processor 471.

It should be noted that the description above is only an example configuration. Alternative configurations may be implemented with additional or other sensors, storage devices, interfaces, or the like.

It should be recognized that the embodiments describe methods with an exemplary ordering of method steps. The specific ordering of method steps is, however, given for illustrative purposes only and should not be construed as binding.

It should also be noted that the division of the electronic device of FIG. 47 into units is only made for illustration purposes and that the present disclosure is not limited to any specific division of functions in specific units. For instance, at least parts of the circuitry could be implemented by a respectively programmed processor, field programmable gate array (FPGA), dedicated circuits, and the like.

All units and entities described in this specification and claimed in the appended claims can, if not stated otherwise, be implemented as integrated circuit logic, for example, on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An indirect Time-of-Flight sensor (20) comprising:
a pixel array (21) including a plurality of pixels (30; 70; 80; 90; 120; 150; 180; 210; 230; 270; 310; 350; 390; 430), each pixel having three or more taps (GD1-9; GD1-16; TG0-7; TG0A-3B; TG0AA-3BB); and
a read-out circuit (22, 24, 25) configured to read-out charges collected at the respective three or more taps.

(2) The indirect Time-of-Flight sensor (20) of (1), wherein the taps of a respective pixel are configured to collect the charges generated by a photocollecting region (77; 87; 121; 151; 181; 211; 231; 271; 311; 351).

(3) The indirect Time-of-Flight sensor (20) of (1) or (2), wherein each pixel (30; 70; 80) comprises mixing elements (GD1-9), each mixing element corresponding to one of the taps.

(4) The indirect Time-of-Flight sensor (20) of (3), wherein each pixel (30; 70; 80) is a current assisted photonic demodulator, CAPD, based pixel.

(5) The indirect Time-of-Flight sensor (20) of (4), wherein one of the mixing elements (GD1-9) operates as an overflow collector (OFC) having a pulse duration larger than a pulse duration of remaining mixing gates of the mixing gates (GD1-9).

(6) The indirect Time-of-Flight sensor (20) of (4), wherein each pixel (70) is formed by CAPD elements.

(7) The indirect Time-of-Flight sensor (20) of (4), wherein each pixel (80) is formed by separated CAPD elements (86), the separated CAPD elements (86) being separated by p-wells (85).

(8) The indirect Time-of-Flight sensor (20) of (7), wherein each of the separated CAPD elements (86) is configured to operate as either a 16-tap pixel (91) or as four 4-tap pixels (92).

(9) The indirect Time-of-Flight sensor (20) of (2), wherein the photocollecting region is a central photocollecting region (121; 151; 181; 211; 231; 271; 311).

(10) The indirect Time-of-Flight sensor (20) of (9), wherein each pixel (120; 150; 180; 210; 230; 270; 310) comprises transfer gates (TG0-7; TG0A-3B; TG0AA-3BB), each transfer gate corresponding to a respective tap.

(11) The indirect Time-of-Flight sensor (20) of (10), wherein each pixel is a TG-based pixel (120; 150; 270).

(12) The indirect Time-of-Flight sensor (20) of (10), wherein each pixel is a cascaded TG-based pixel (180; 210; 230; 310).

(13) The indirect Time-of-Flight sensor (20) of (10), wherein the read-out circuit (22, 23, 24, 25) is configured to open the transfer gates (TG1-8; TG0-7; TG0A-3B) of the respective taps of the pixel (120; 150; 180; 210; 230; 270; 310) one after the other for a predetermine period to obtain depth measurements.

(14) The indirect Time-of-Flight sensor (20) of (10), wherein one of the transfer gates (TG1-8; TG0-7; TG1A-3B) operates as an overflow gate (OFG) having a pulse duration larger than a pulse duration of remaining transfer gates of the transfer gates (TG1-8; TG0-7; TG0A-3B).

(15) The indirect Time-of-Flight sensor (20) of (11), wherein each of the transfer gates (TG0-7) of the TG-based pixel (120; 150; 270) connects the central photocollecting region (121) to a respective floating diffusion region (FD).

(16) The indirect Time-of-Flight sensor (20) of (11), wherein the TG-based pixel (150; 270) further comprises a memory node (MEM0-7) for intermediate charge storage.

(17) The indirect Time-of-Flight sensor (20) of (11), wherein the transfer gates are first transfer gates (TG0-3) and the TG-based pixel (150; 270) further comprises a floating diffusion region (FD01), multiple memory nodes (MEM0, MEM1) connected with, and respective multiple second transfer gates (TX0, TX1), the memory nodes (MEM0, MEM1) being connected through the multiple second transfer gates (TX0, TX1) to the floating diffusion region (FD01).

(18) The indirect Time-of-Flight sensor (20) of (17), wherein the transfer gates are first transfer gates (TG0-3) and the TG-based pixel (150; 270) further comprises a floating diffusion region (FD01), two or more memory nodes (MEM0, MEM1), and two or more respective second transfer gates (TX0, TX1), the two or more memory nodes (MEM0, MEM1) being connected through the two or more second transfer gates (TX0, TX1) to the floating diffusion region (FD01).

(19) The indirect Time-of-Flight sensor (20) of (18), wherein the TG-based pixel (270) further comprises a memory shift gate (MS0) configured to transfer the charges from one memory node (MEM0) of two memory nodes (MEM0, MEM1) to another memory node (MEM1) of the memory nodes (MEM0, MEM1), the two memory nodes (MEM0, MEM1) being adjacent to each other.

(20) The indirect Time-of-Flight sensor (20) of (19), wherein the memory shift gate (MS0-7) is located between the two memory nodes (MEM0, MEM1).

(21) The indirect Time-of-Flight sensor (20) of (12), wherein the cascaded TG-based pixel (180; 230; 310; 350) further comprises a common gate (CG0-3) representing a first modulation stage.

(22) The indirect Time-of-Flight sensor (20) of (21), wherein the common gate (CG0-3) connects the central photocollecting region (181) to a respective floating diffusion region (FD) through a respective transfer gate (TG0A-3B), the respective transfer gate (TG0A-3B) representing a second modulation stage.

(23) The indirect Time-of-Flight sensor (20) of (12), wherein the cascaded TG-based pixel (210) further comprises a first common gate (CG0-3) representing a first modulation stage.

(24) The indirect Time-of-Flight sensor (20) of (23), wherein the cascaded TG-based pixel (210) further comprises a second common gate (CG0A) representing a second modulation stage, the second common gate (CG0A) connecting the first common gate (CG0) to two respective transfer gates (TG0AA, TG0AB).

(25) The indirect Time-of-Flight sensor (20) of (21), wherein the cascaded TG-based pixel (230) further comprises a memory node (MEM0A-1A) for intermediate charge storage.

(26) The indirect Time-of-Flight sensor (20) of (22), wherein the transfer gates are first transfer gates (TG0A-3B) and the TG-based pixel (230) further comprises a floating diffusion region (FD01), multiple memory nodes (MEM0B, MEM1A), and multiple respective second transfer gates (TX0B, TX1A), the multiple memory nodes (MEM0B, MEM1A) being connected through the respective multiple second transfer gates (TX0B, TX1A) to the floating diffusion region (FD01).

(27) The indirect Time-of-Flight sensor (20) of (22), wherein the transfer gates are first transfer gates (TG0A-3B) and the TG-based pixel (230) further comprises a floating diffusion region (FD01), two or more memory nodes (MEM0B, MEM1A), and two or more respective second transfer gates (TX0B, TX1A), the two or more memory nodes (MEM0B, MEM1A) being connected through the two or more second transfer gates (TX0B, TX1A) to the floating diffusion region (FD01).

(28) The indirect Time-of-Flight sensor (20) of (27), wherein the cascaded TG-based pixel (310) further comprises a memory shift gate (MS0B) configured to transfer the charges from one memory node (MEM0B) of two memory nodes (MEM0B, MEM1A) to another memory node (MEM1A) of the memory nodes (MEM0B, MEM1A), the two memory nodes (MEM0B, MEM1A) being adjacent to each other.

(29) The indirect Time-of-Flight sensor (20) of (2), wherein the photocollecting region is an intermediate collecting region including a plurality of central photocollecting regions (CC0-3), each of the central photocollecting regions (CC0-3) being connected to a respective CAPD modulator (MIX0-3).

(30) The indirect Time-of-Flight sensor (20) of anyone of (1) to (29), wherein each pixel is a cascaded TG-based pixel (350) comprises common gates (CG0-3) configured to generate charges and direct the charges directly to first transfer gates (TG0A-3B).

(31) The indirect Time-of-Flight sensor (20) of anyone of (1) to (30), wherein each pixel is a cascaded TG-based pixel (350) without a central photocollecting region.

(32) The indirect Time-of-Flight sensor (20) of anyone of (1) to (31), wherein each pixel is a cascaded TG-based pixel (430) comprising a CAPD modulator (MIX0) and two respective photogates (PG0A, PG0B) representing a first modulation stage.

(33) An electronic device comprising an indirect Time-of-Flight sensor in accordance with (1).

1. An indirect Time-of-Flight sensor comprising:
a pixel array including a plurality of pixels, each pixel having three or more taps; and
a read-out circuit configured to read-out charges collected at the respective three or more taps.

2. The indirect Time-of-Flight sensor of claim 1, wherein the taps of a respective pixel are configured to collect the charges generated by a photocollecting region.

3. The indirect Time-of-Flight sensor of claim 1, wherein each pixel comprises mixing elements, each mixing element corresponding to one of the taps.

4. The indirect Time-of-Flight sensor of claim 3, wherein each pixel is a current assisted photonic demodulator, CAPD, based pixel.

5.-8. (canceled)

9. The indirect Time-of-Flight sensor of claim 2, wherein the photocollecting region is a central photocollecting region and wherein each pixel comprises transfer gates, each transfer gate corresponding to a respective tap.

10. (canceled)

11. The indirect Time-of-Flight sensor of claim 9, wherein each pixel is a TG-based pixel.

12. The indirect Time-of-Flight sensor of claim 9, wherein each pixel is a cascaded TG-based pixel.

13. The indirect Time-of-Flight sensor of claim 9, wherein the read-out circuit is configured to open the transfer gates of the respective taps of the pixel one after the other for a predetermine period to obtain depth measurements.

14. (canceled)

15. The indirect Time-of-Flight sensor of claim 11, wherein each of the transfer gates of the TG-based pixel connects the central photocollecting region to a respective floating diffusion region.

16. The indirect Time-of-Flight sensor of claim 11, wherein the TG-based pixel further comprises a memory node for intermediate charge storage.

17. The indirect Time-of-Flight sensor of claim 11, wherein the transfer gates are first transfer gates and the TG-based pixel further comprises a floating diffusion region, multiple memory nodes connected with, and respective multiple second transfer gates, the memory nodes being connected through the multiple second transfer gates to the floating diffusion region.

18.-20. (canceled)

21. The indirect Time-of-Flight sensor of claim 12, wherein the cascaded TG-based pixel further comprises a common gate representing a first modulation stage.

22. The indirect Time-of-Flight sensor of claim 21, wherein the common gate connects the central photocollecting region to a respective floating diffusion region through a respective transfer gate, the respective transfer gate representing a second modulation stage.

23. The indirect Time-of-Flight sensor of claim 12, wherein the cascaded TG-based pixel further comprises a first common gate representing a first modulation stage and a second common gate representing a second modulation stage, the second common gate connecting the first common gate to two respective transfer gates.

24. (canceled)

25. The indirect Time-of-Flight sensor of claim 21, wherein the cascaded TG-based pixel further comprises a memory node for intermediate charge storage.

26. The indirect Time-of-Flight sensor of claim 22, wherein the transfer gates are first transfer gates and the TG-based pixel further comprises a floating diffusion region, multiple memory nodes, and multiple respective second transfer gates, the multiple memory nodes being connected through the respective multiple second transfer gates to the floating diffusion region.

27. The indirect Time-of-Flight sensor of claim 22, wherein the transfer gates are first transfer gates and the TG-based pixel further comprises a floating diffusion region, two or more memory nodes, and two or more respective second transfer gates, the two or more memory nodes being connected through the two or more second transfer gates to the floating diffusion region.

28. (canceled)

29. The indirect Time-of-Flight sensor of claim 2, wherein the photocollecting region is an intermediate collecting region including a plurality of central photocollecting regions, each of the central photocollecting regions being connected to a respective CAPD modulator.

30. The indirect Time-of-Flight sensor of claim 1, wherein each pixel is a cascaded TG-based pixel comprises common gates configured to generate charges and direct the charges directly to first transfer gates.

31.-32. (canceled)

33. An electronic device comprising an indirect Time-of-Flight sensor in accordance with claim 1.
